(19) United States
(12) Patent Application Publication
(10) Pub. No.: US 2006/0223602 A1
(43) Pub. Date: Oct. 5, 2006

(54) Game program, gaming apparatus, and recording medium

(75) Inventor: Izumi Hamamoto, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/391,483

(22) Filed: Mar. 29, 2006

(30) Foreign Application Priority Data
Apr. 1, 2005 (JP) 2005-106340

(51) Int. Cl. A63F 13/00

(52) U.S. Cl. 463/1

(57) ABSTRACT

To provide a game program, gaming apparatus, recording medium in which it is possible to optionally and easily change a player character's state while executing an action against an enemy character. A gaming apparatus stores specific data for each enemy character and player character state data relating to a player character's state. The gaming apparatus, on condition that a player character action mode against an enemy character has been selected based on an operational signal, adds specific data, which corresponds to the enemy character, to the player character state data. The gaming apparatus changes the player character's state based on the result of the addition.

### RELATED APPLICATION

This application claims the priority of Japanese Patent Application No. 2005-106340 filed on Apr. 1, 2005 which is incorporated herein by reference.

### BACKGROUND OF THE INVENTION

1. Field of the Invention

The present invention relates to a game program, a gaming apparatus, and a recording medium, and more particularly to a game program, a gaming apparatus, and a recording apparatus in which a player character's state is changed based on a predetermined change condition.

2. Background Art

Various game programs have been provided in which, in a virtual world at a game on the screen of a computer and a display device, a command input and the like are performed in response to a player's operation, a character action mode during the game is selected in accordance with a predetermined action order, and a preset story is thus progressed, thereby leading a player to play a role such a character. Such a game is generally called a “RPG” (Role Playing Game).

As this kind of game program, a game program is generally known, which includes a battle scene in which a battle is fought between a character (hereafter called a “player character”), who is manipulated in response to a player's operation, and an enemy character, which is controlled by the computer, wherein an experience value, a virtual coin, and the like are obtained by defeating the enemy character in this battle, thus progressing a story while increasing a character level.

Also, in such a battle scene, the action control will be exerted based on character data relating to a player character, enemy character data relating an enemy character, and the like.

As this kind of game program, generally, as described in Japanese Unexamined Patent Publication No. 2005-6988, a game program is disclosed in which the state of a character (e.g., the power, appearance, and the like of a character) is changed when a predetermined change condition, such as a condition to repeat a battle or to use an item, has been established. This also diversifies the change of a player character, thus increasing player's interest in the game.

However, in the aforementioned game program, when battles are repeatedly performed, a player character's state is changed accordingly, so that it is not easy to maintain the player character's state. Also, mainly a battle will be avoided in order to maintain the player character's state, which is likely to result in the reduction of player's interest in the game.

### SUMMARY OF THE INVENTION

The invention has been made in view of a problem such as described above, and an object thereof is to provide a game program, gaming apparatus, recording medium in which it is possible to optionally and easily change a player character's state while executing an action against an enemy character.

To achieve an object such as aforementioned, the invention provides the following.

(1) A game program product for use in a computer including a player-operable operating device comprising: a player character data storage module which stores player character data relating to a player character; an enemy character data storage module which stores enemy character data relating to an enemy character; a player character state determination module which determines a player character's state based on the player character data stored by the player character data storage module; a player character action mode selection module which selects a player character action mode based on an operational signal from the operating device and the player character's state determined by the player character state determination module; a character action control section which exerts player character action control based on the player character action mode selected by the character action mode selection module; and a player character state change module which, based on a predetermined change condition, changes the player character's state determined by the player character state determination module, wherein the enemy character data storage module stores specific data for each enemy character; and the player character data storage module stores player character state data relating to a player character's state; the game program product comprising: a player character state data addition module which, on condition that a player character action mode against an enemy character has been selected by the character action mode selection module based on an operational signal from the operating device, adds specific data, which corresponds to the enemy character, to player character state data; wherein the player character state change module, changes a player character's state based on the result of the addition by the player character state data addition module.

(2) A game program product according to (1), further comprising: an initial value change module which changes the player character state data to an initial value on condition that the player character state data has reached a predetermined value; wherein the player character state change module, changes a player character's state to a relatively favorable specific state on condition that the player character state data has reached a predetermined value.

(3) A gaming apparatus comprises: a player-operable operating device; a player character data storage module which stores player character data relating to a player character; an enemy character data storage module which stores enemy character data relating to an enemy character; a player character state determination module which determines a player character's state based on the player character data stored by the player character data storage module; a player character action mode selection module which selects a player character action mode based on an operational signal from the operating device and the player character's state determined by the player character state determination module; a character action control section which exerts player character action control based on the player character action mode selected by the character action mode selection module; and a player character state change module which, based on a predetermined change condition, changes the player character's state determined by the player character state determination module, wherein the enemy character data storage module stores specific data for each enemy character, and the player character data storage module stores player character state data relating to a player character's state, the gaming apparatus including a player character state data addition module which, on condition that a player character action mode against an enemy character has been selected by the character action mode selection module based on an operational signal from the operating device, adds specific data, which corresponds to the enemy character, to player character state data, wherein the player character state change module changes a player character's state based on the result of the addition by the player character state data addition module.

According to the invention of (1) or (3), on condition that a player character action mode against an enemy character has been selected based on an operational signal from the operating device, specific data, which corresponds to the enemy character, is added to player character state data, wherein a player character's state is changed based on the result of the addition by the player character state data addition module. Accordingly, by making it a condition that a player character action mode against an enemy character has been selected based on an operational signal from the operating device, the player can purposefully perform the addition of player character state data in response to the action mode against the enemy character. Furthermore, since specific data corresponding to an enemy character targeted for the action mode is added, for example, specific data which differs according to the type of the enemy character will be added. Consequently, it is possible to arbitrarily and easily change a player character's state while executing an action against an enemy character.

According to the invention of (2), on condition that player character state data has reached a predetermined value, the player character state data is changed to the initial value, and a player character's state is changed to a relatively favorable specific state. Accordingly, the player purposefully changes player character state data to a relatively favorable specific state by setting it to the initial value, and player character state data is changed to the initial value. This can therefore harmonize a change to a specific state with a limitation on a specific state, thus making it possible to provide a strategic game.

According to the invention, it is possible to optionally and easily change a player character's state while executing an action against an enemy character.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

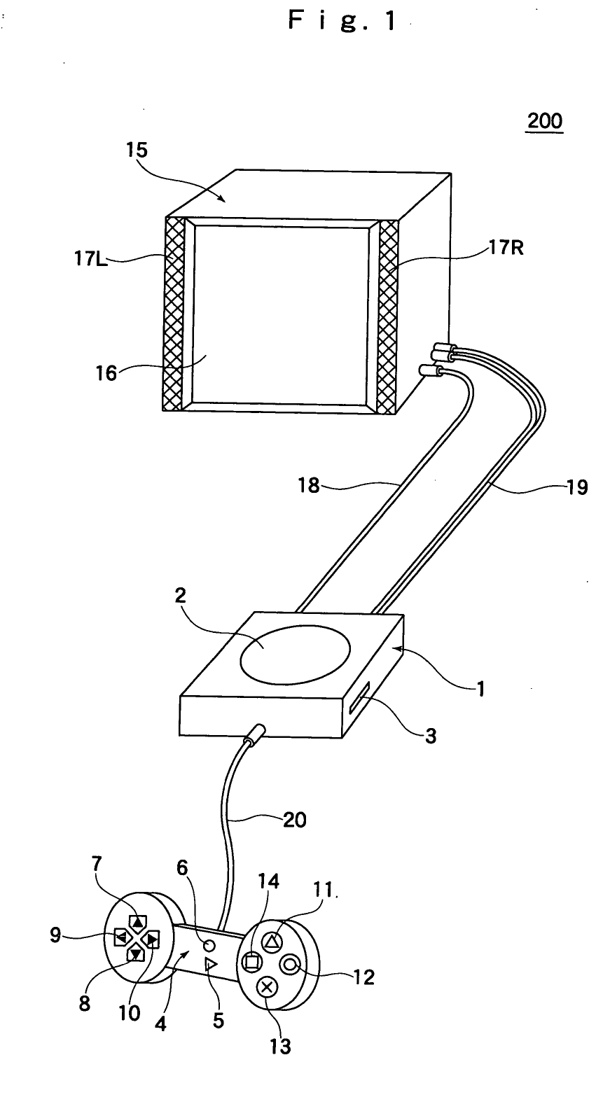

FIG. 1 is a view showing the overall configuration of a gaming apparatus to which the invention is applied;

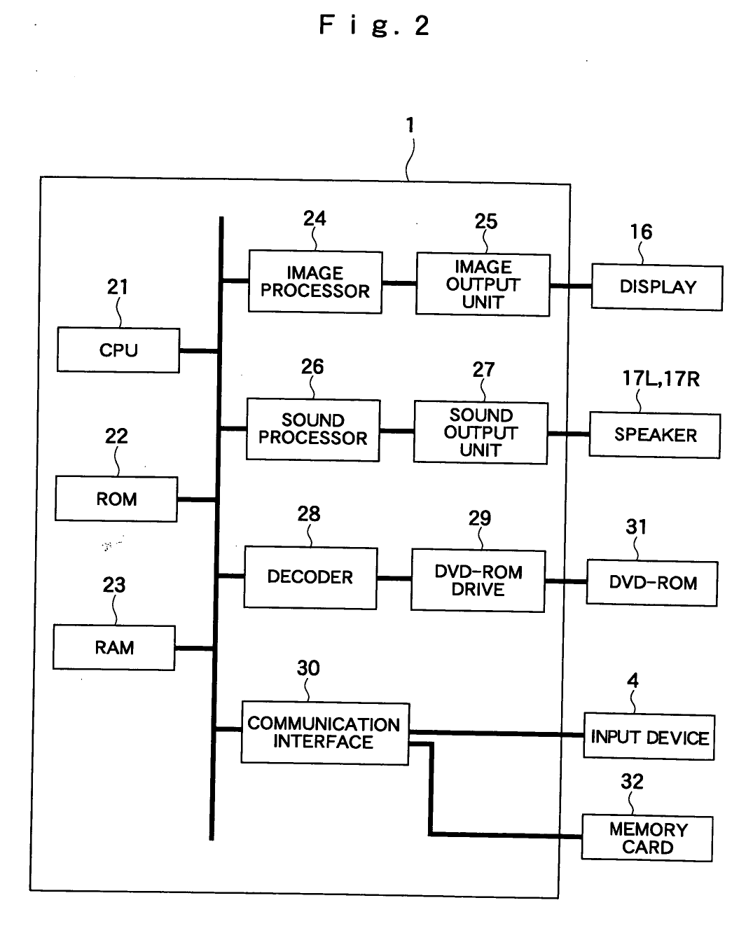

FIG. 2 is a block diagram showing the system configuration of the gaming apparatus in FIG. 1;

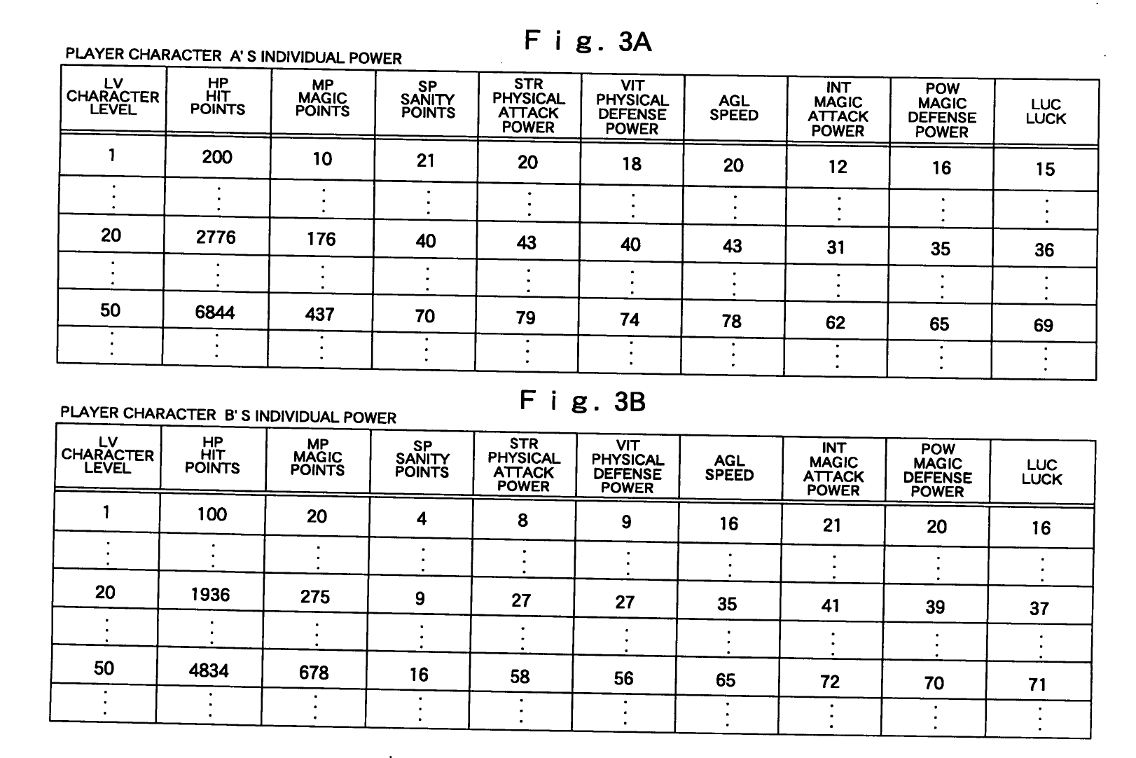

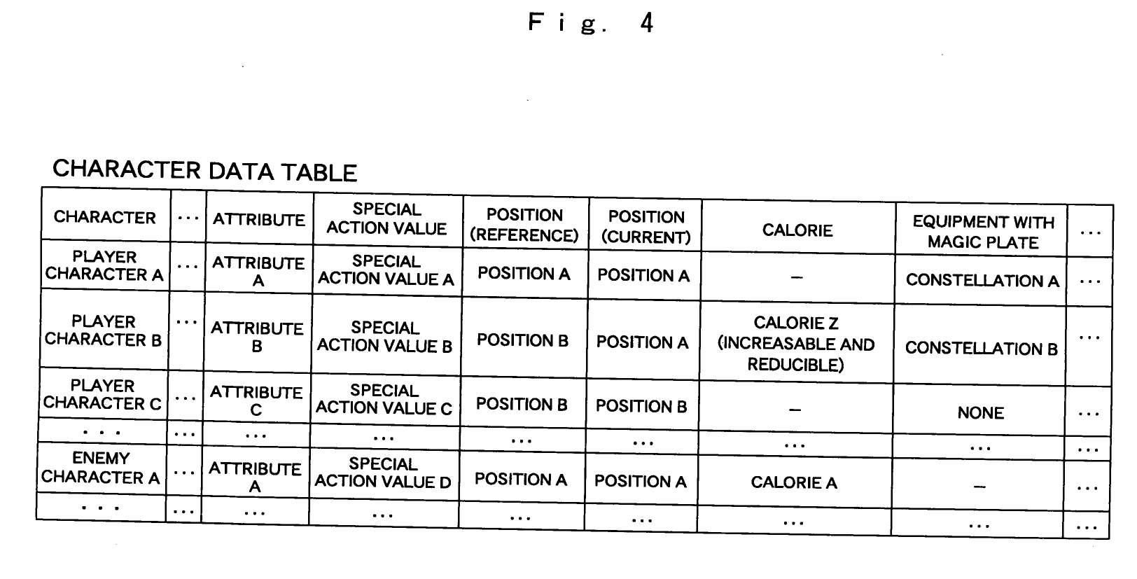

FIGS. 3A and 3B are illustrations showing character's individual power of player character A and player character B, respectively;

FIG. 4 is an illustration showing a character data table relating to characters: player character A, player character B, player character C, and enemy character A;

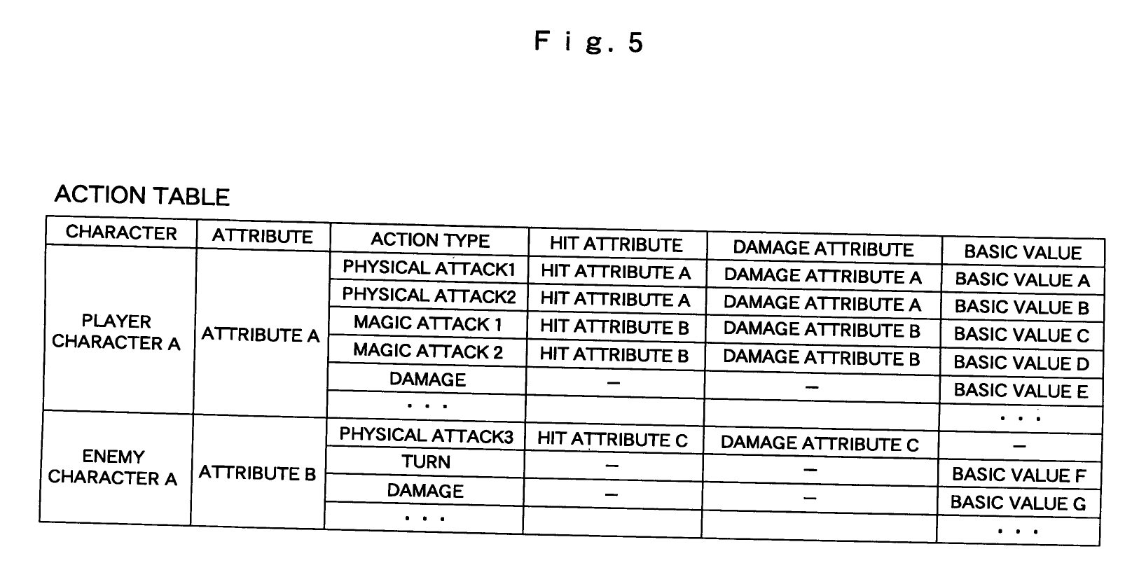

FIG. 5 is an illustration showing an action table relating to characters: player character A and enemy character A;

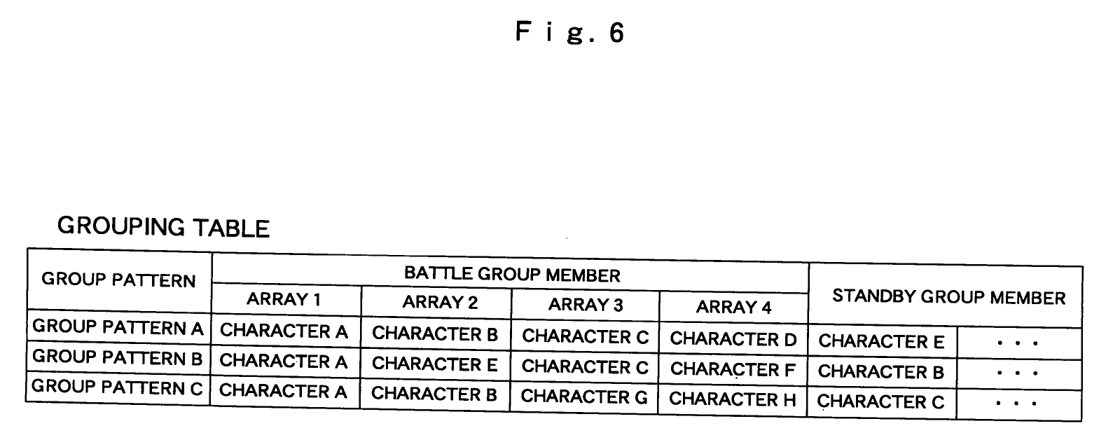

FIG. 6 is an illustration showing a grouping table for player characters;

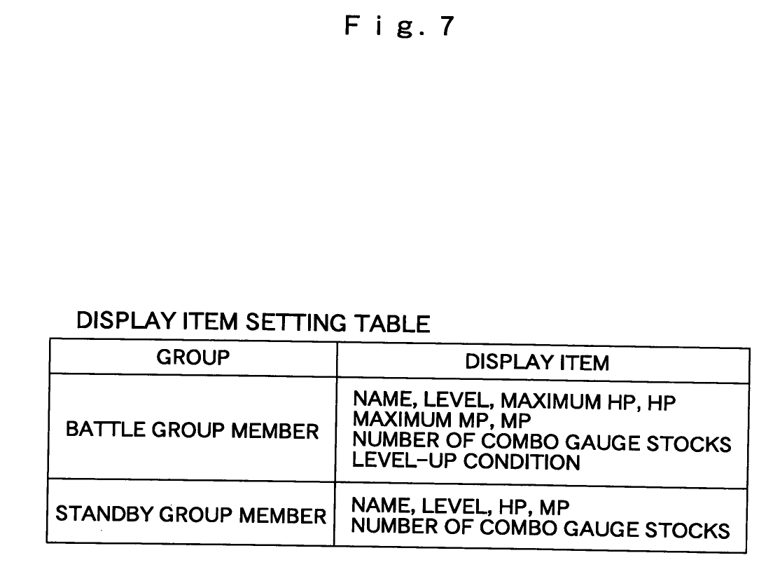

FIG. 7 is an illustration showing a display item setting table;

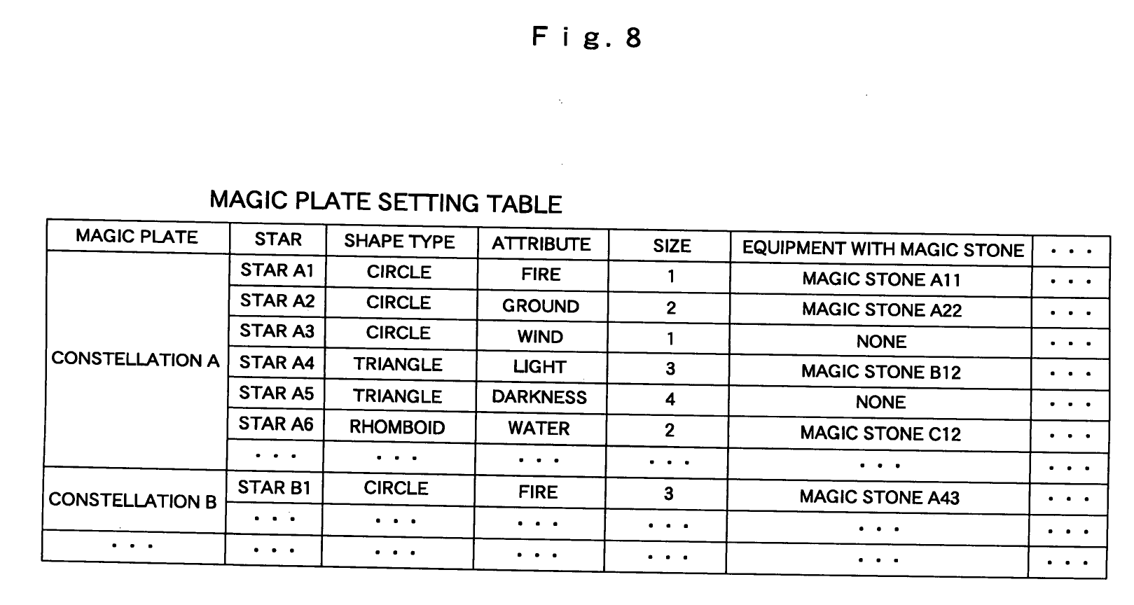

FIG. 8 is an illustration showing a magic plate setting table;

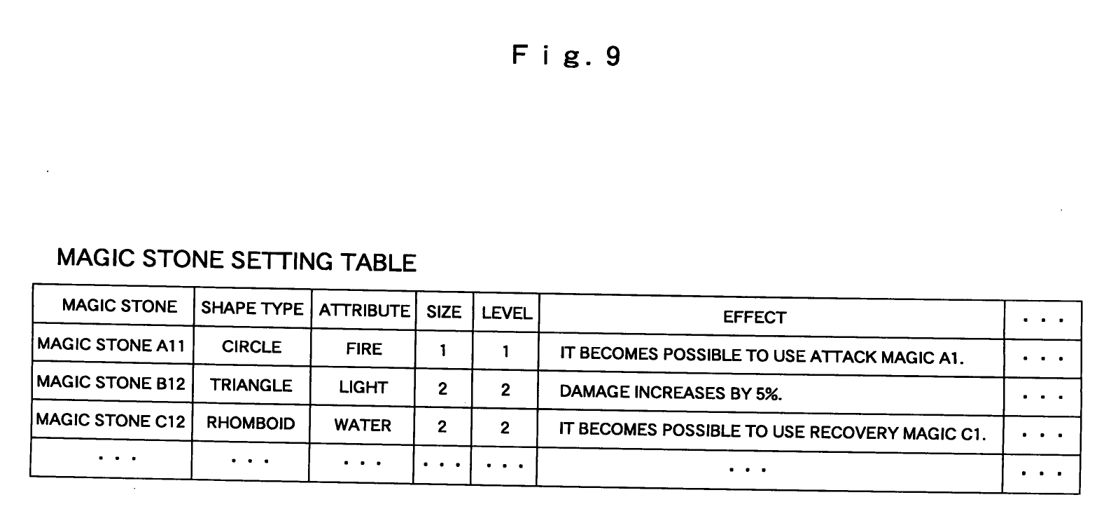

FIG. 9 is an illustration showing a magic stone setting table;

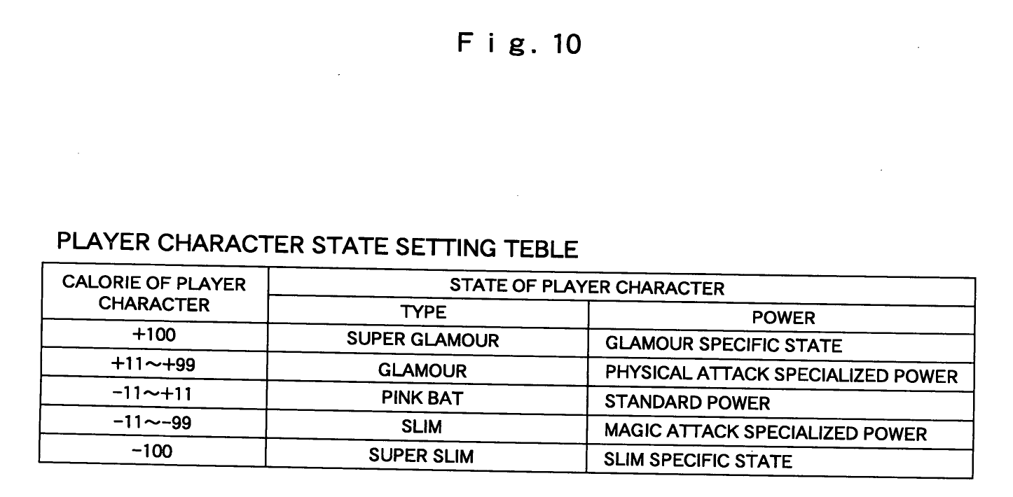

FIG. 10 is an illustration showing a player character state setting table;

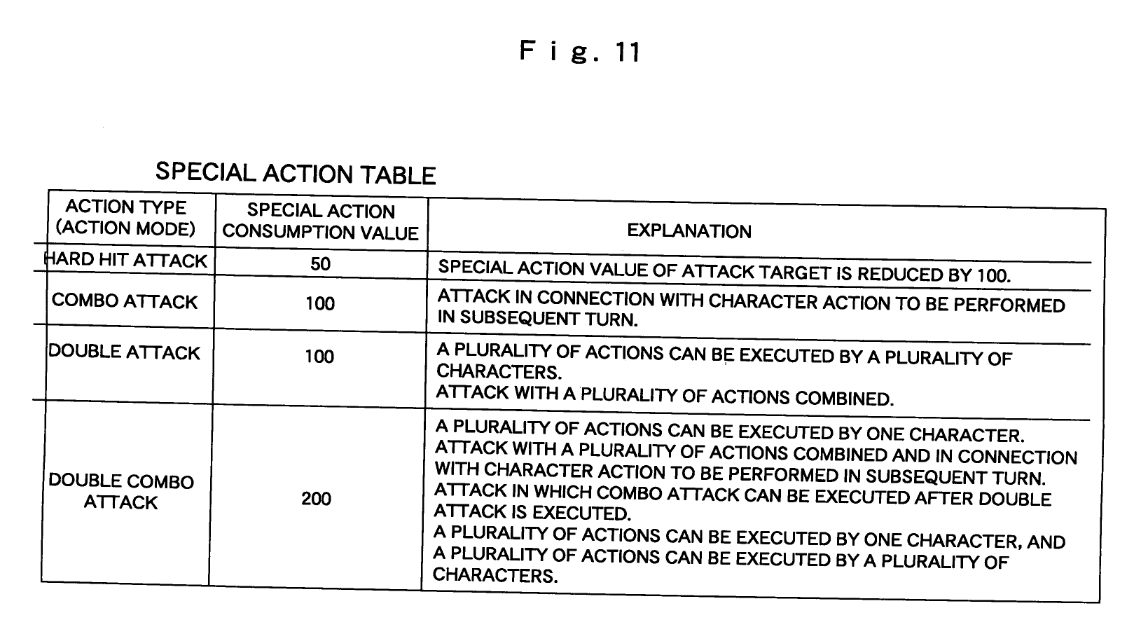

FIG. 11 is an illustration showing a special action table;

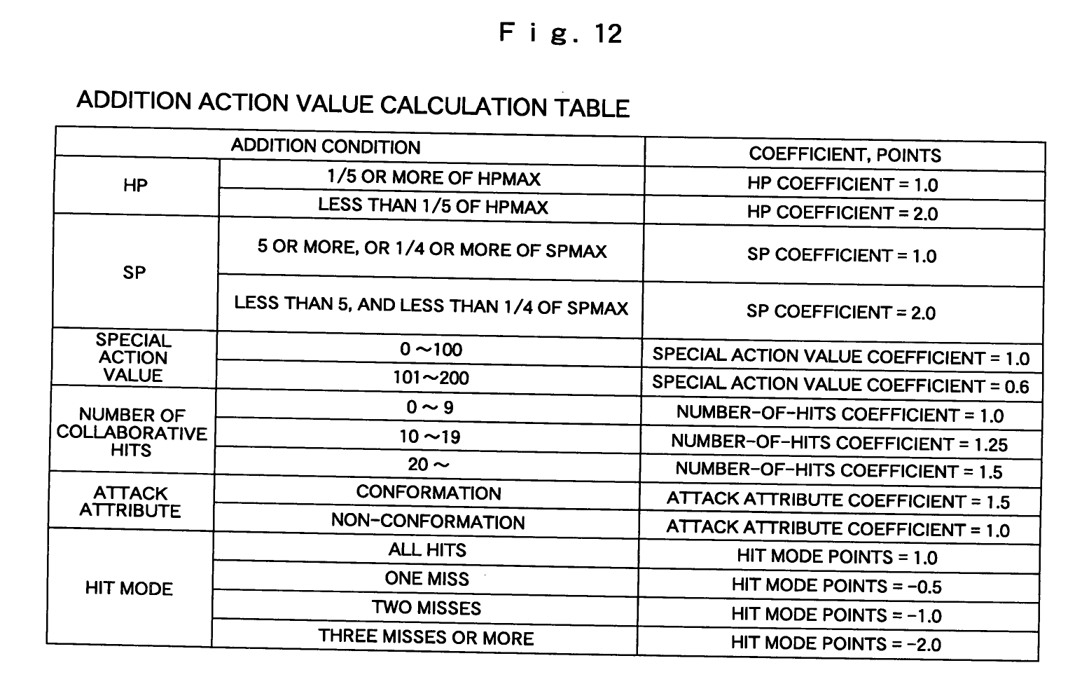

FIG. 12 is an illustration showing an addition action value calculation table;

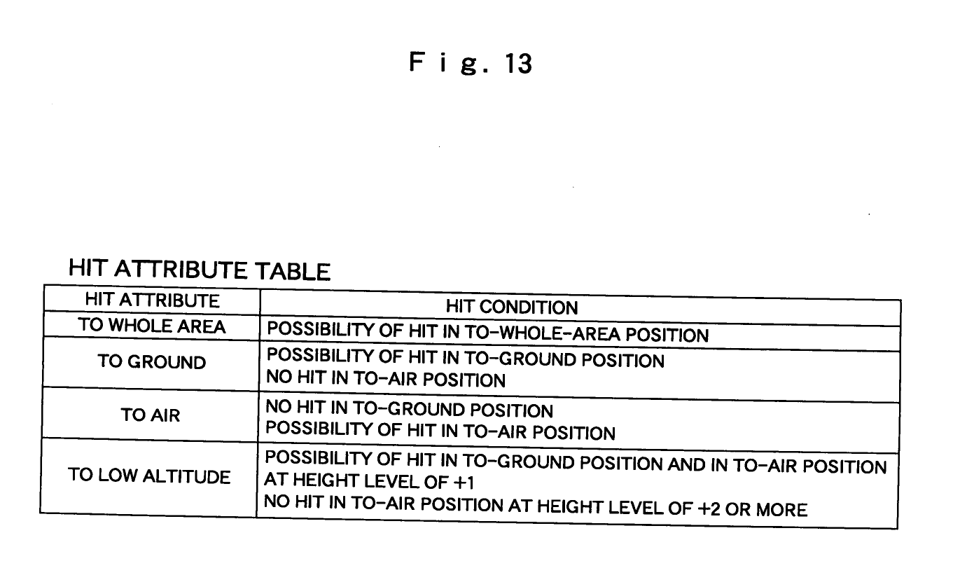

FIG. 13 is an illustration showing a hit attribute table;

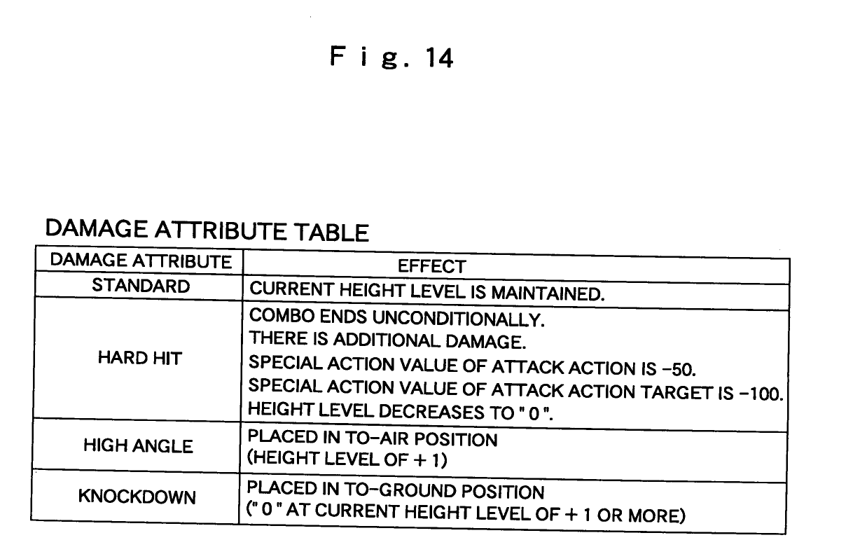

FIG. 14 is an illustration showing a damage attribute table;

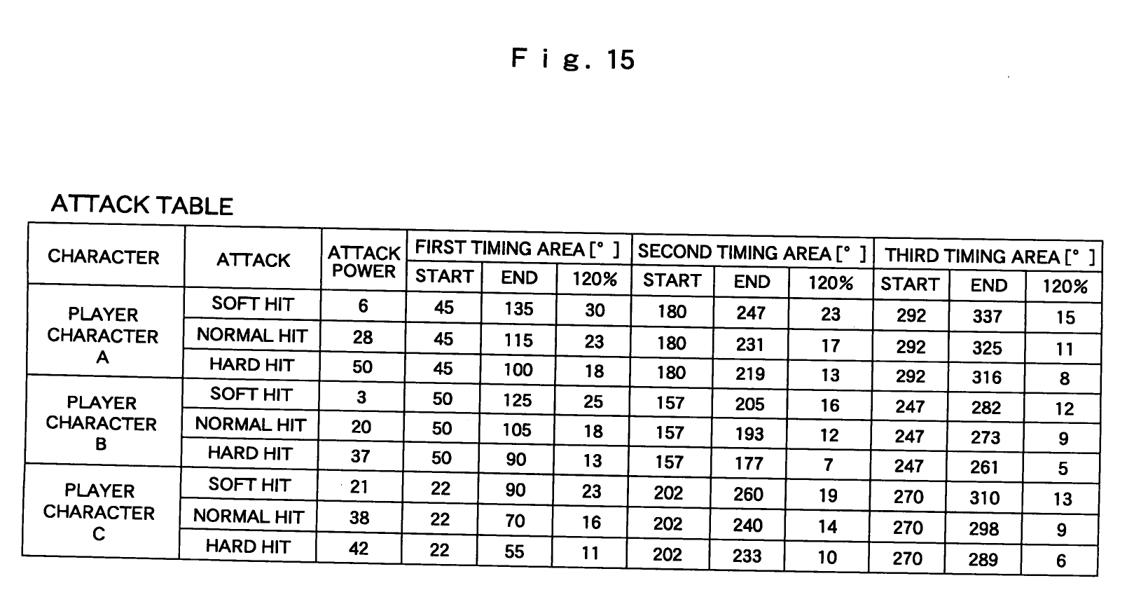

FIG. 15 is a diagram showing an attack table;

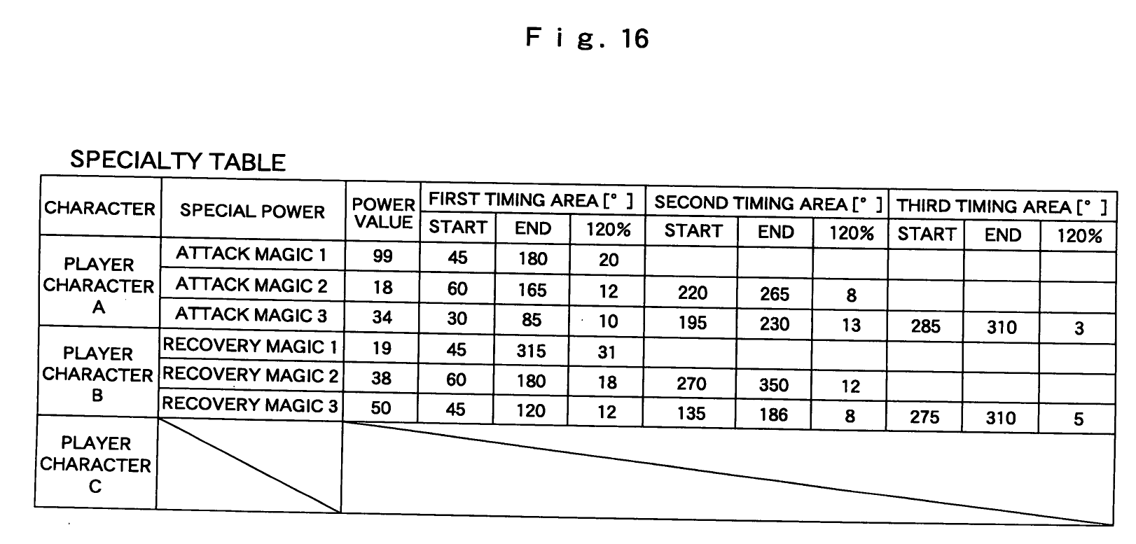

FIG. 16 is a diagram showing a specialty table;

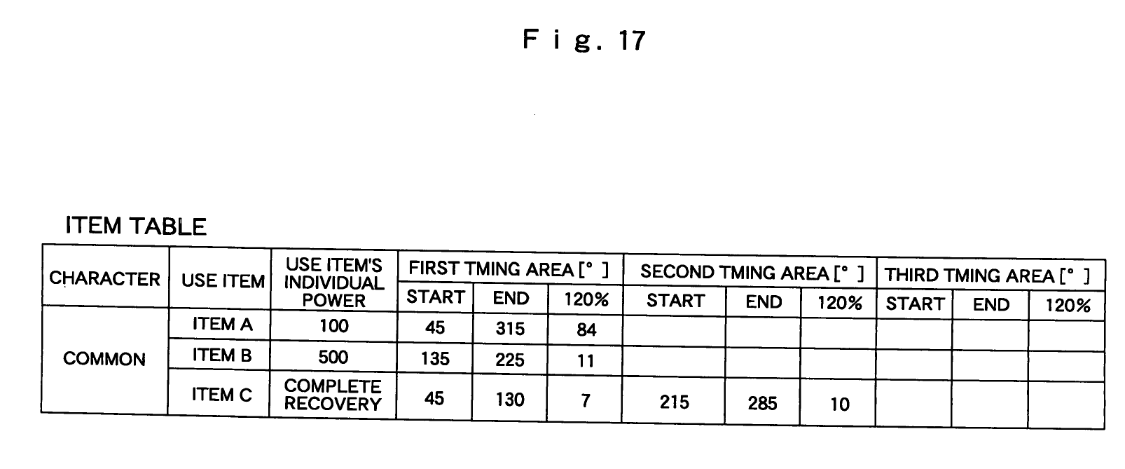

FIG. 17 is a diagram showing an item table;

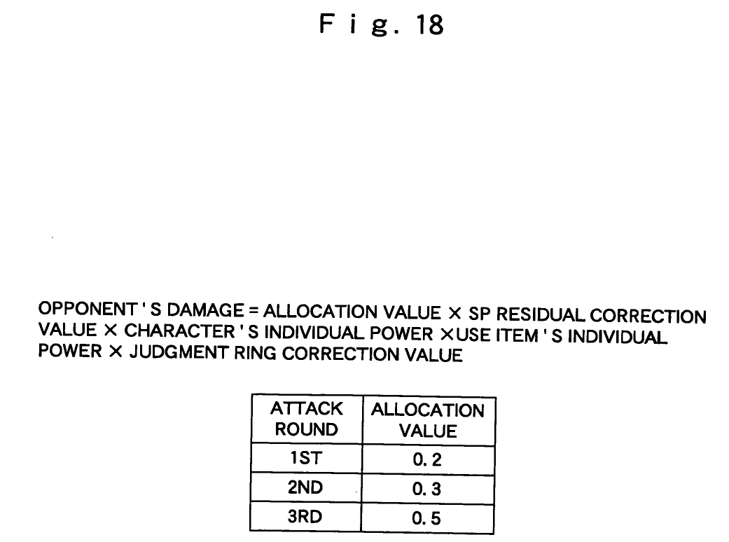

FIG. 18 is a diagram showing a calculating formula to be used to calculate the amount of opponent 's damage done to an enemy character;

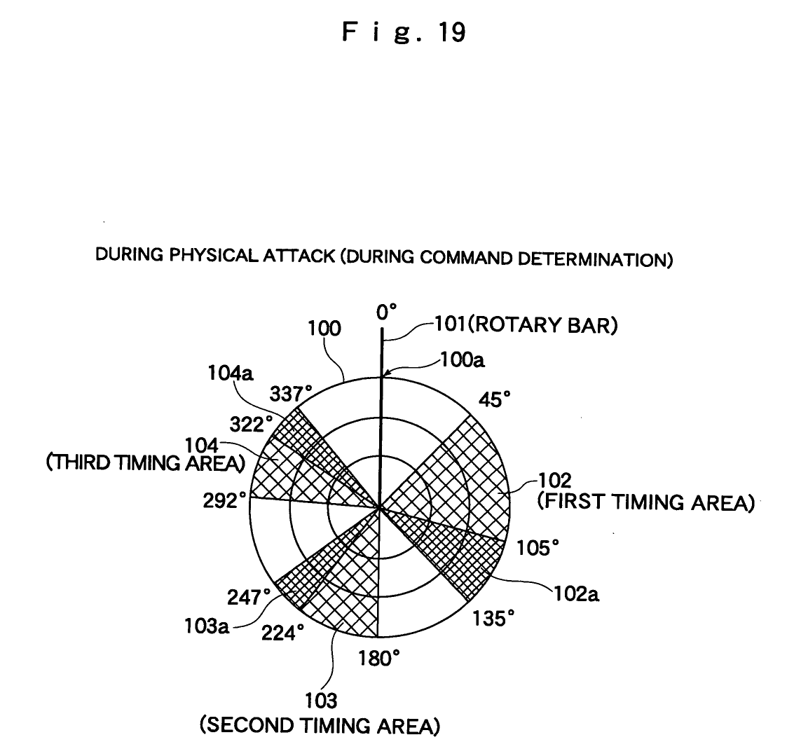

FIG. 19 is a diagram showing a display mode of a judgment ring displayed during a command determination;

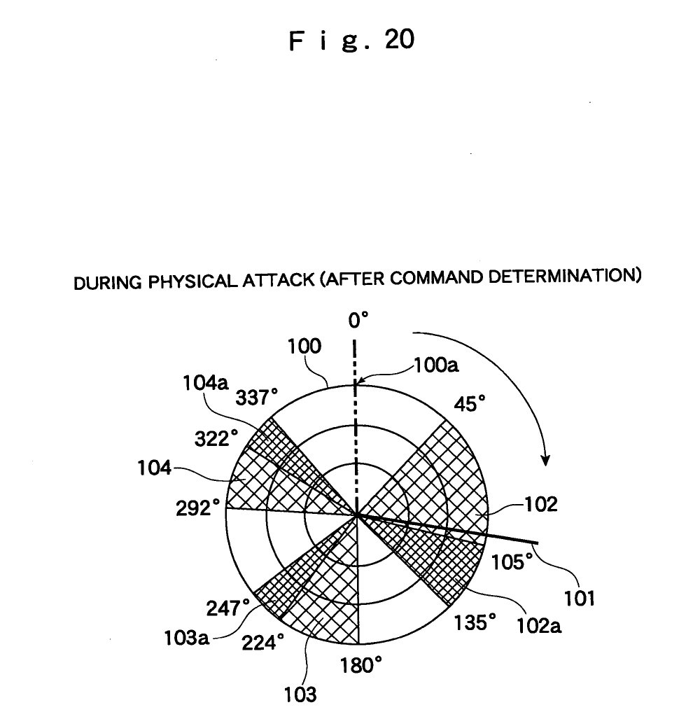

FIG. 20 is a diagram showing a display mode of a judgment ring displayed after the command determination;

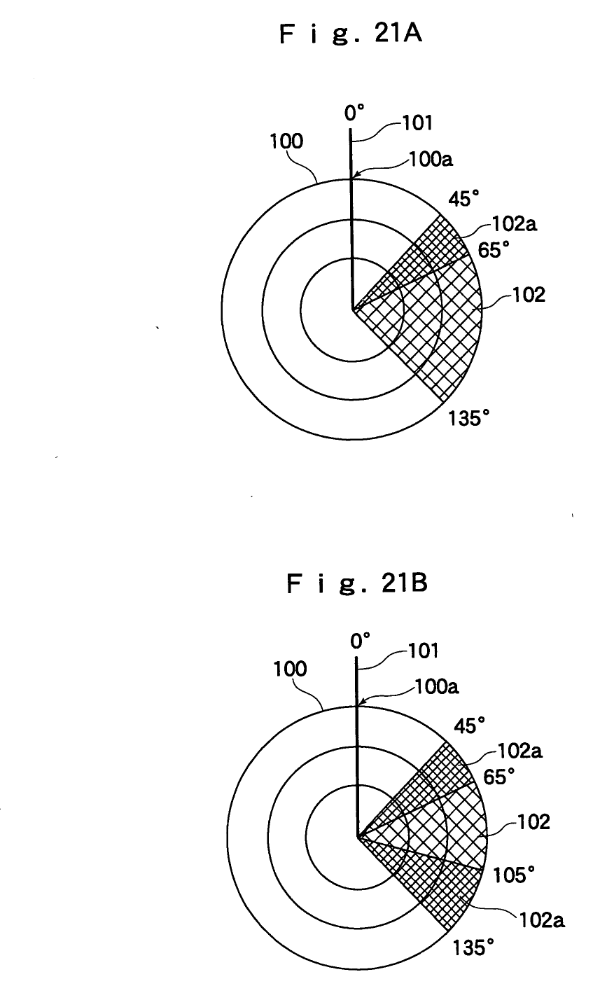

FIGS. 21A and 21B are diagrams showing another example of a 120% region;

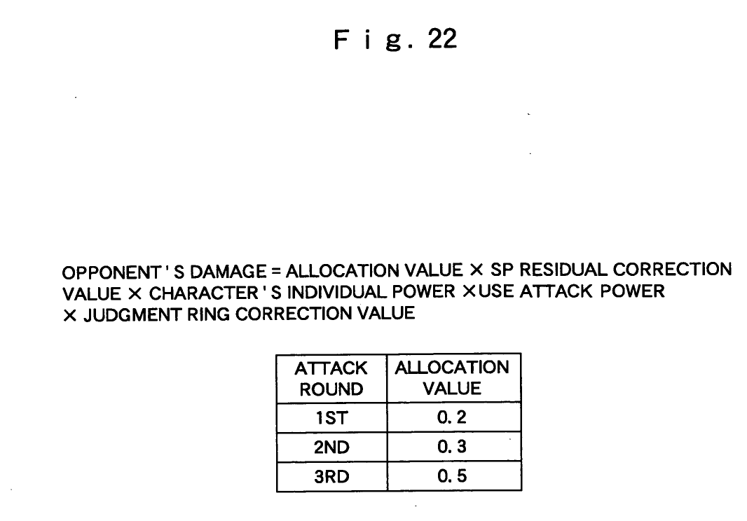

FIG. 22 is a diagram showing a calculating formula to be used to calculate the amount of opponent's damage done when attack magic is used and a calculating formula to be used to calculate a recovery value obtained when recovery magic is used;

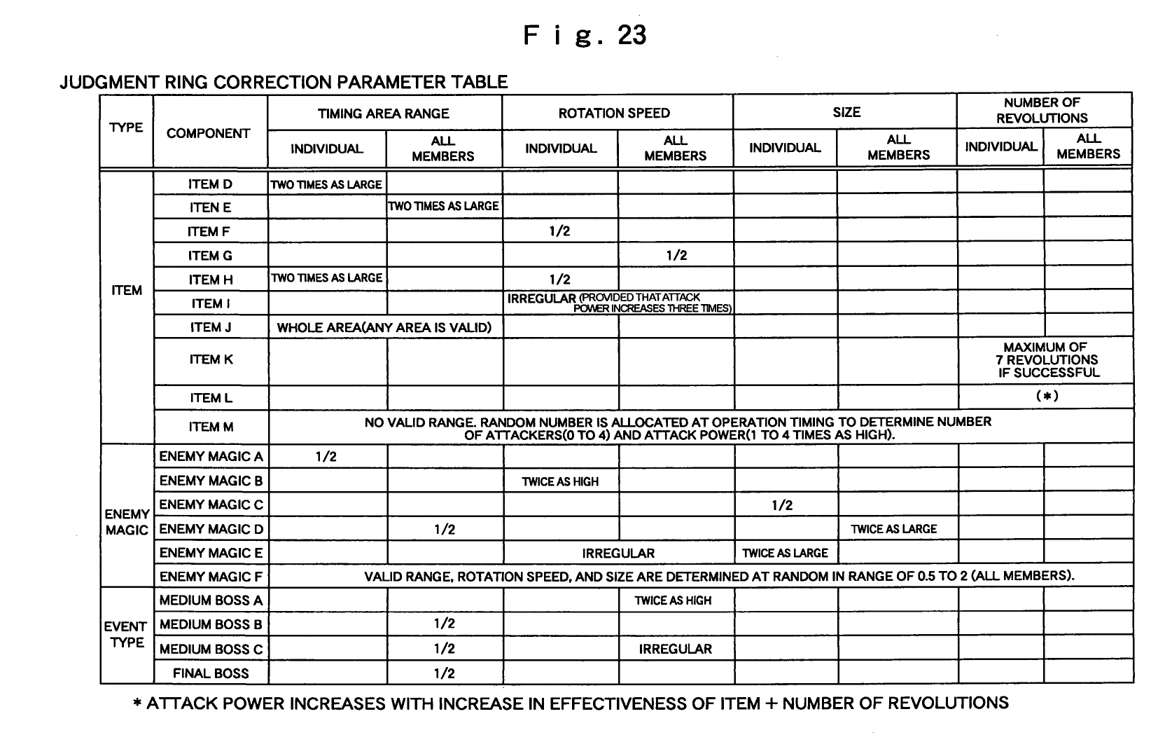

FIG. 23 is a diagram showing a judgment ring correction parameter table;

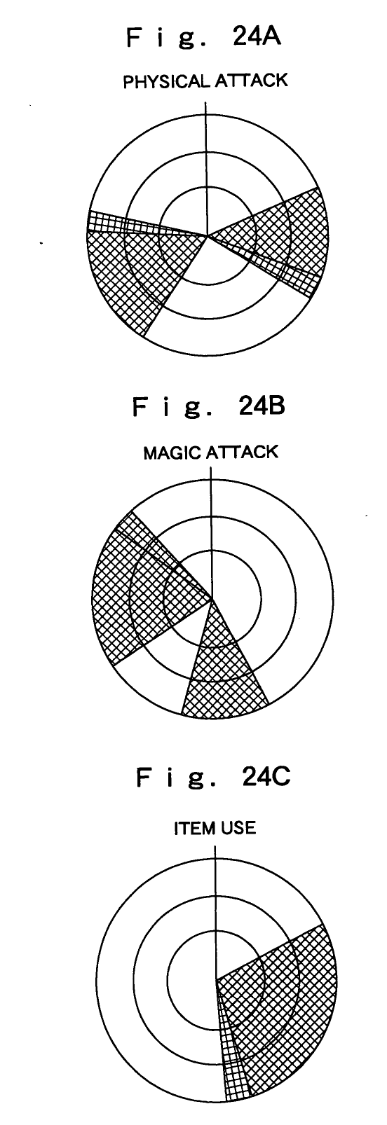

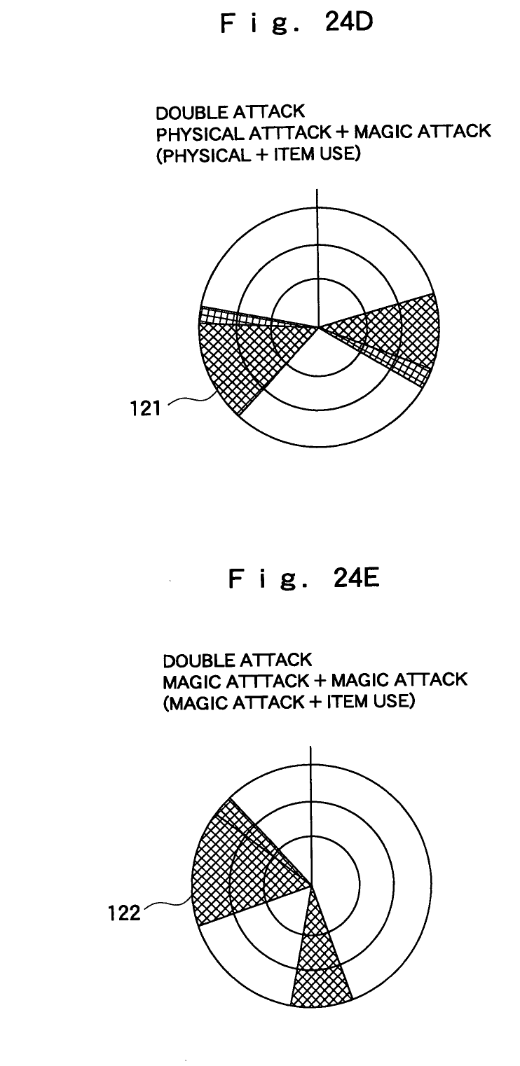

FIGS. 24A to 24E are diagrams showing display modes of a judgment ring displayed during a double attack or double combo attack determination;

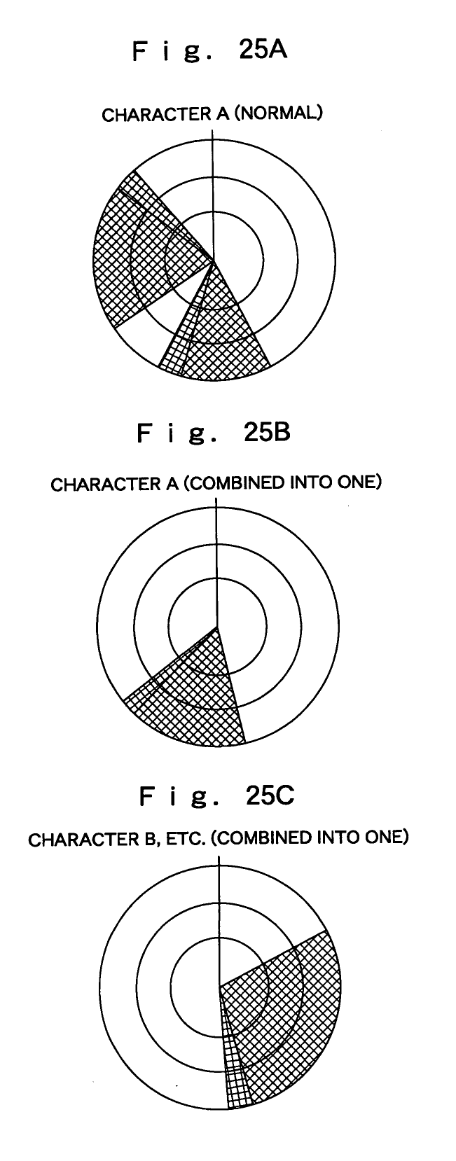

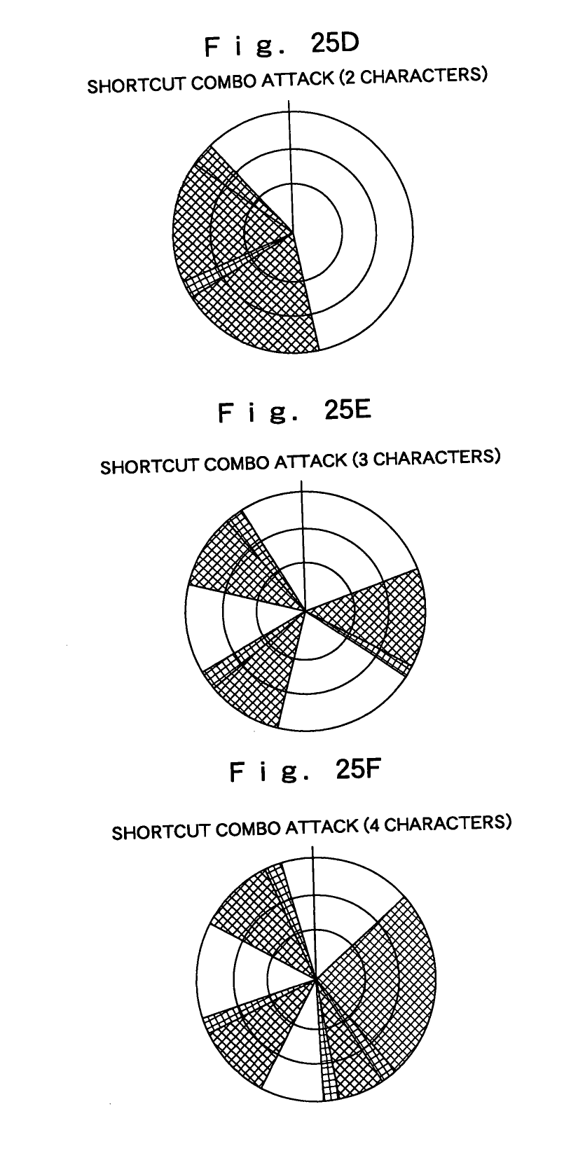

FIGS. 25A to 25F are diagrams showing display modes of a judgment ring displayed during a combo attack (shortcut) determination;

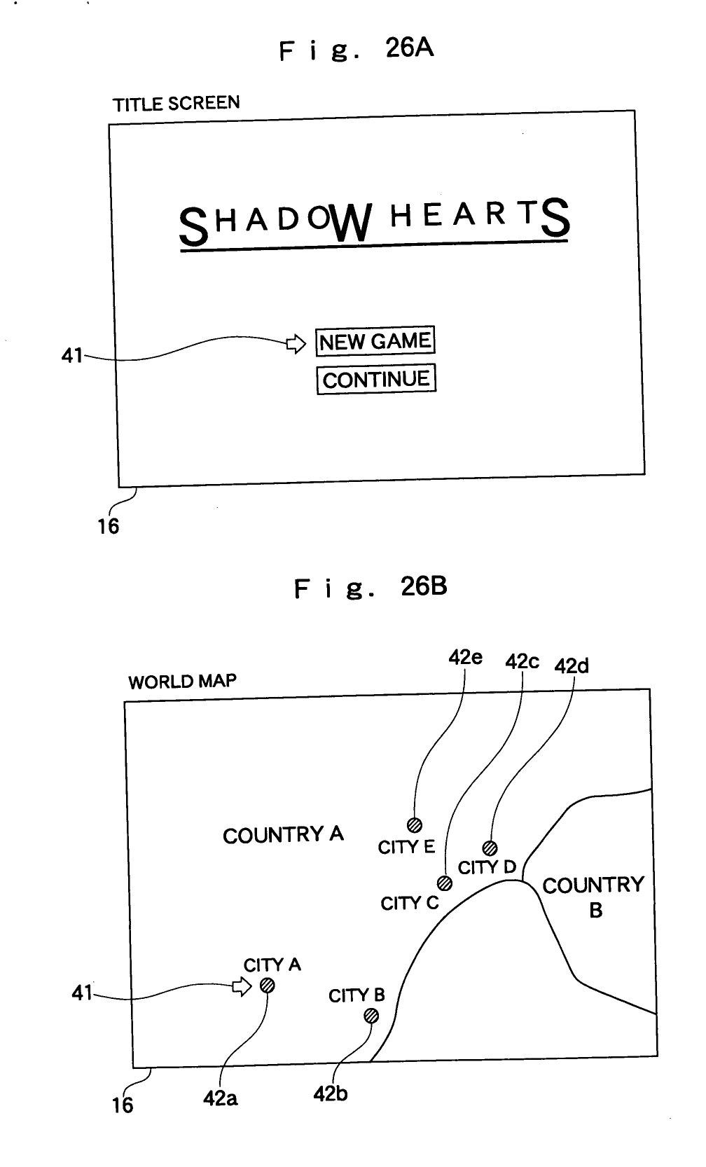

FIGS. 26A and 26B are display examples of a title screen and a world map;

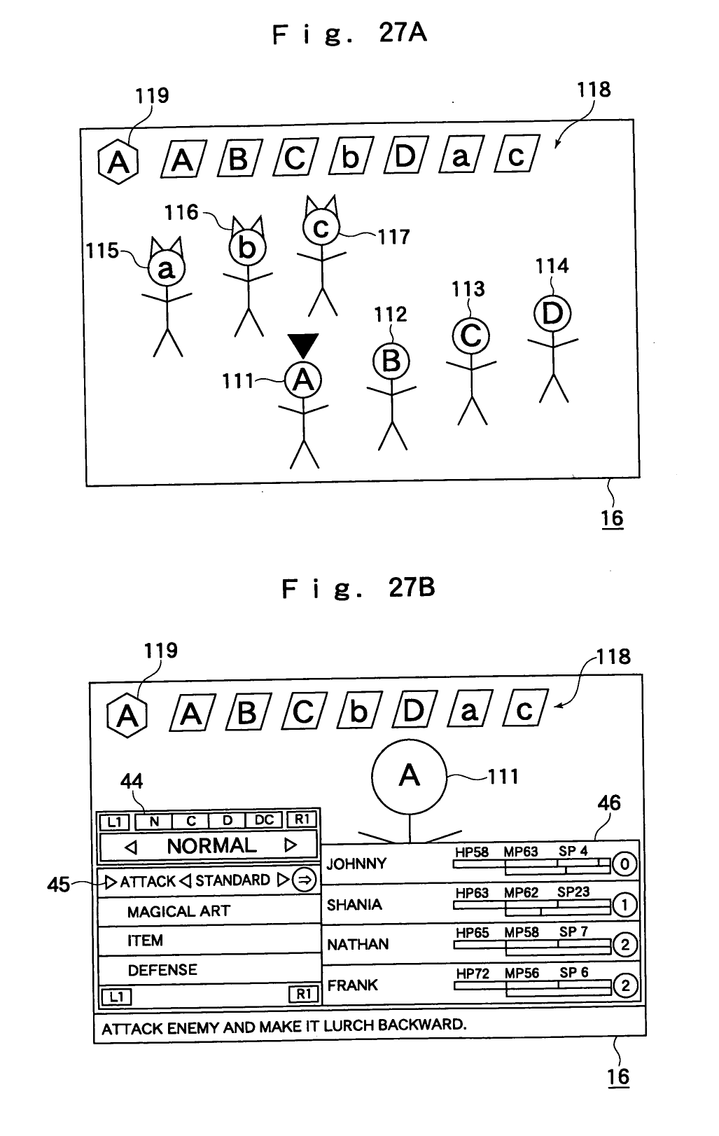

FIGS. 27A and 27B are illustrations showing a battle scene;

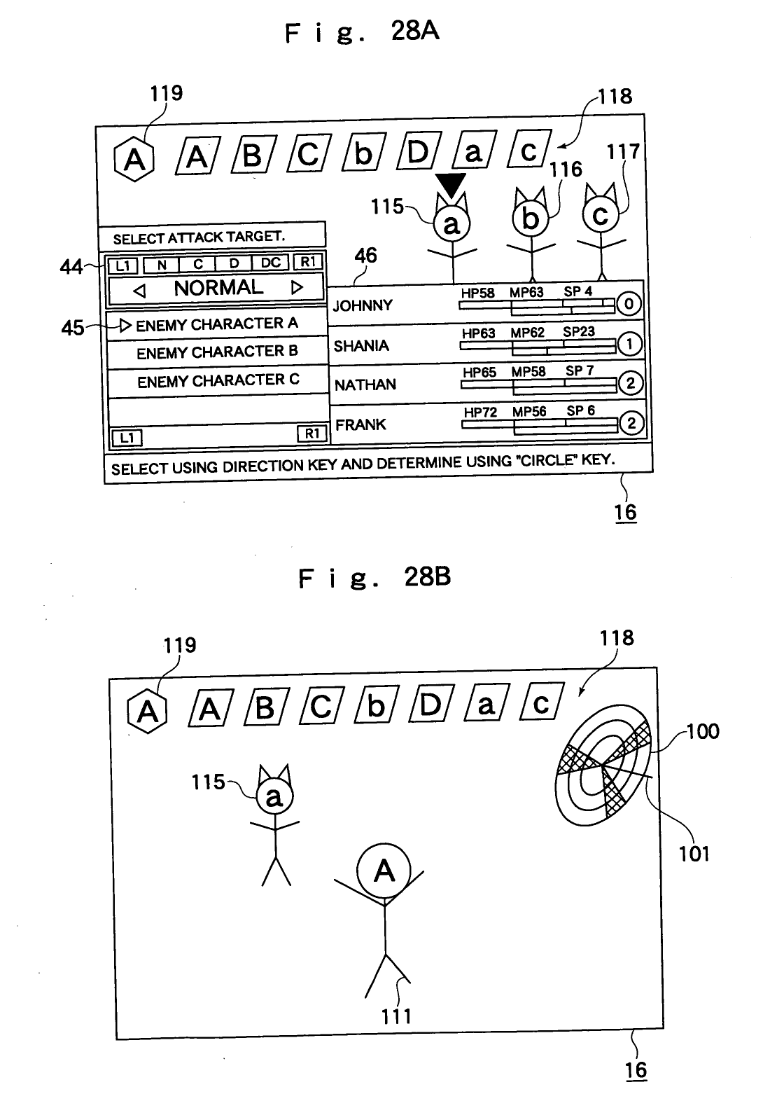

FIGS. 28A and 28B are illustrations showing a battle scene;

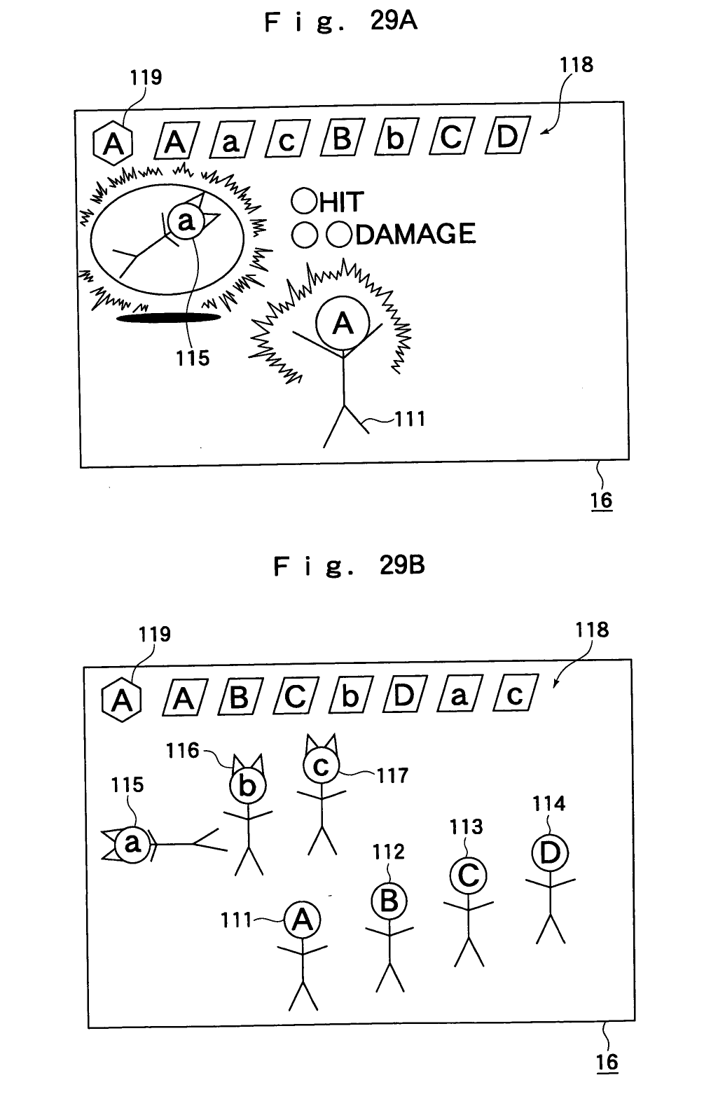

FIGS. 29A and 29B are illustrations showing a battle scene;

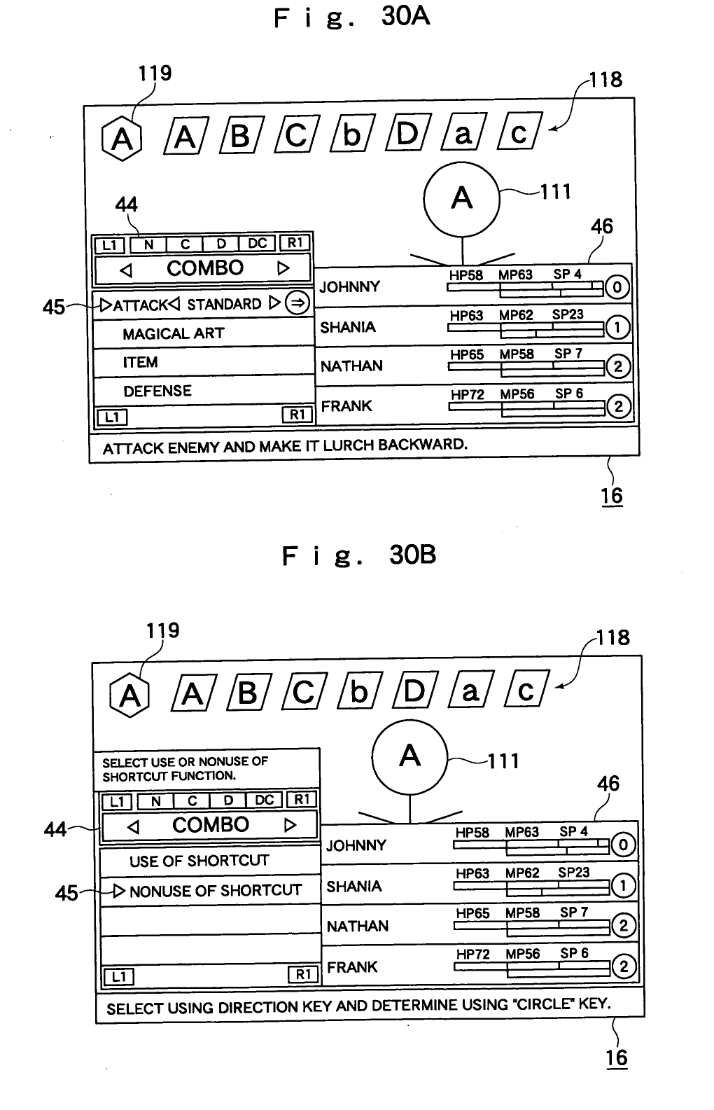

FIGS. 30A and 30B are illustrations showing a battle scene;

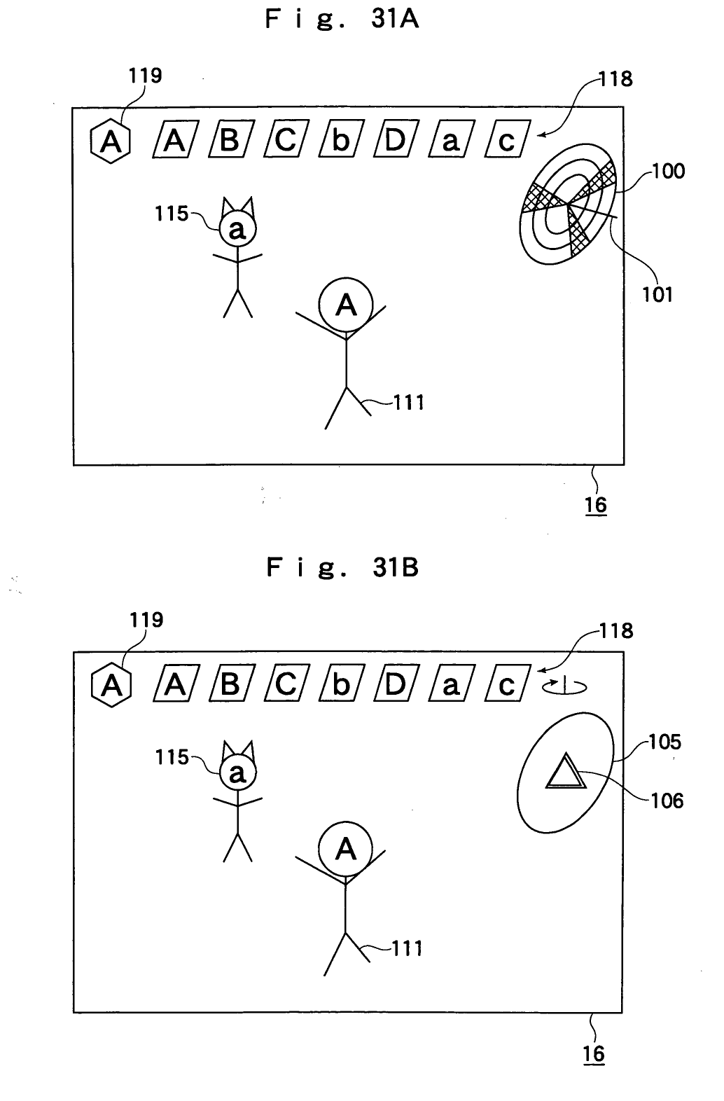

FIGS. 31A and 31B are illustrations showing a battle scene;

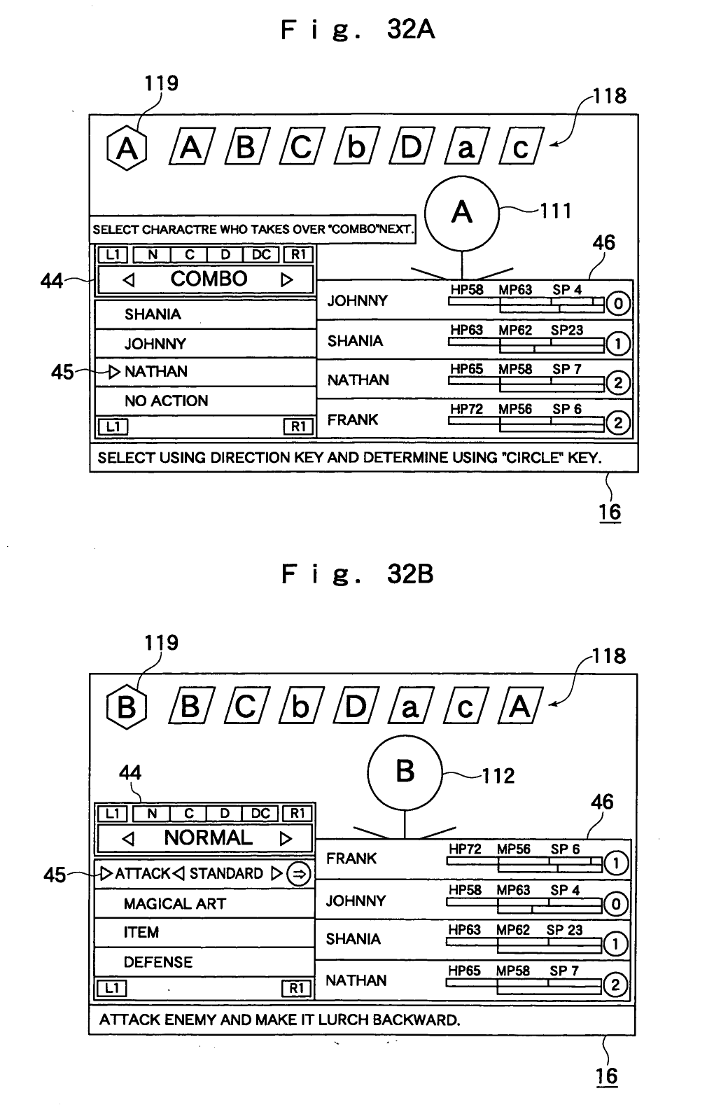

FIGS. 32A and 32B are illustrations showing a battle scene;

FIGS. 33A and 33B are illustrations showing a battle scene;

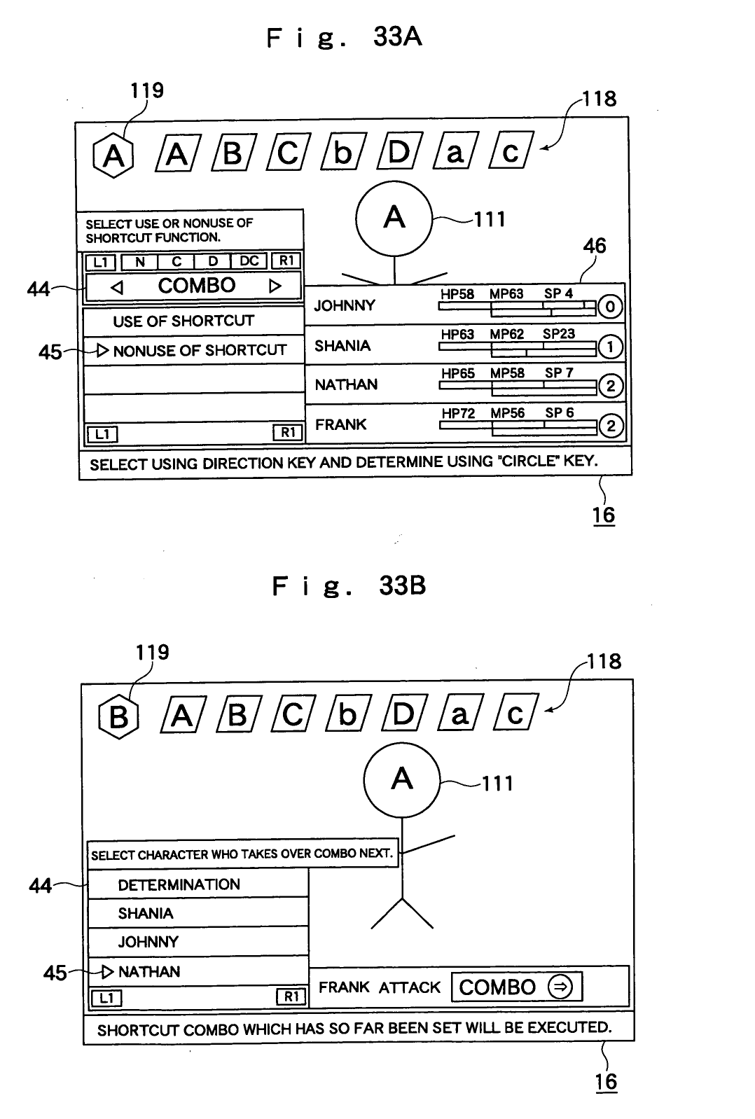

FIGS. 34A and 34B are illustrations showing a battle scene;

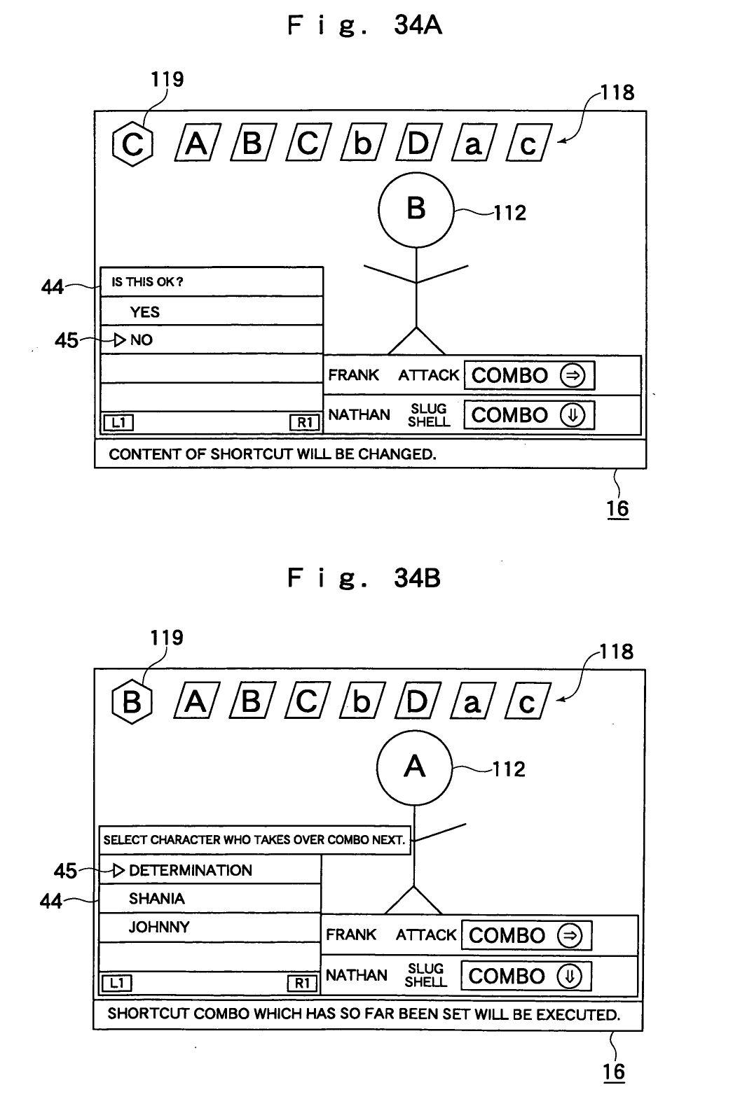

FIGS. 35A and 35B are illustrations showing a battle scene;

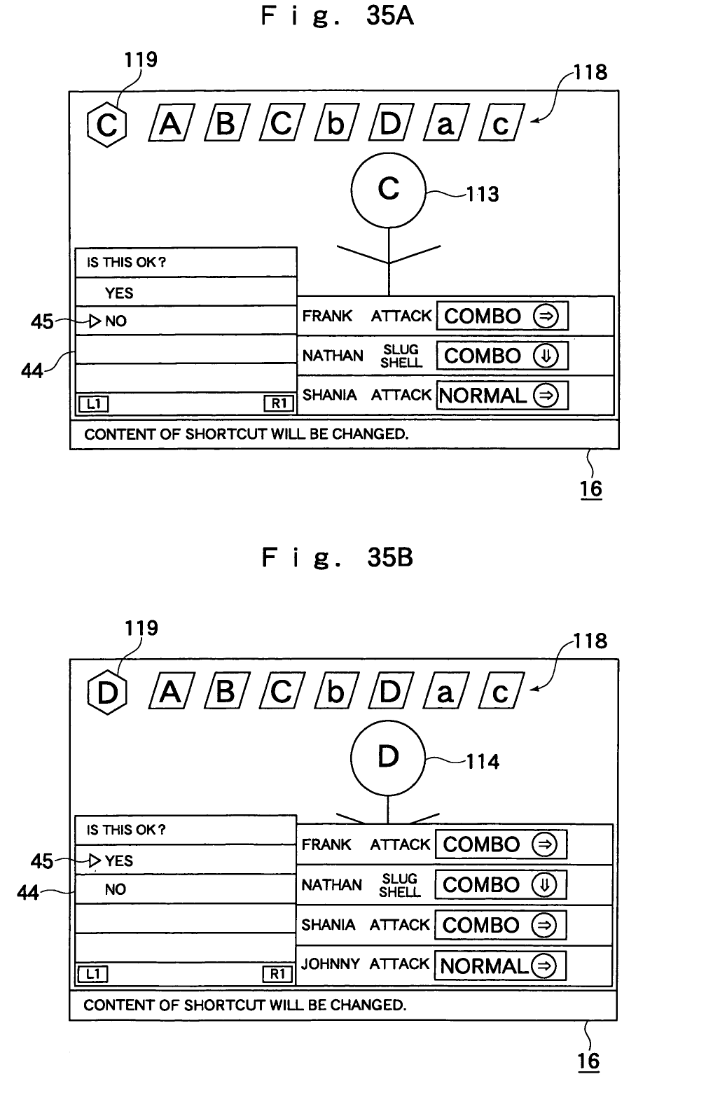

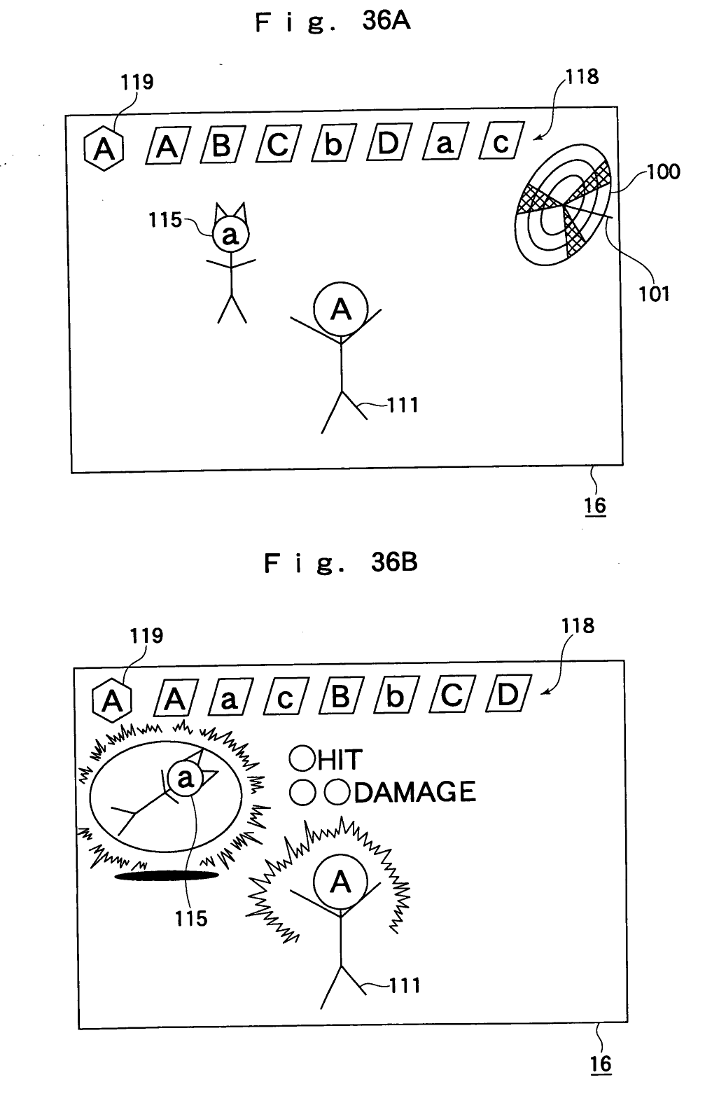

FIGS. 36A and 36B are illustrations showing a battle scene;

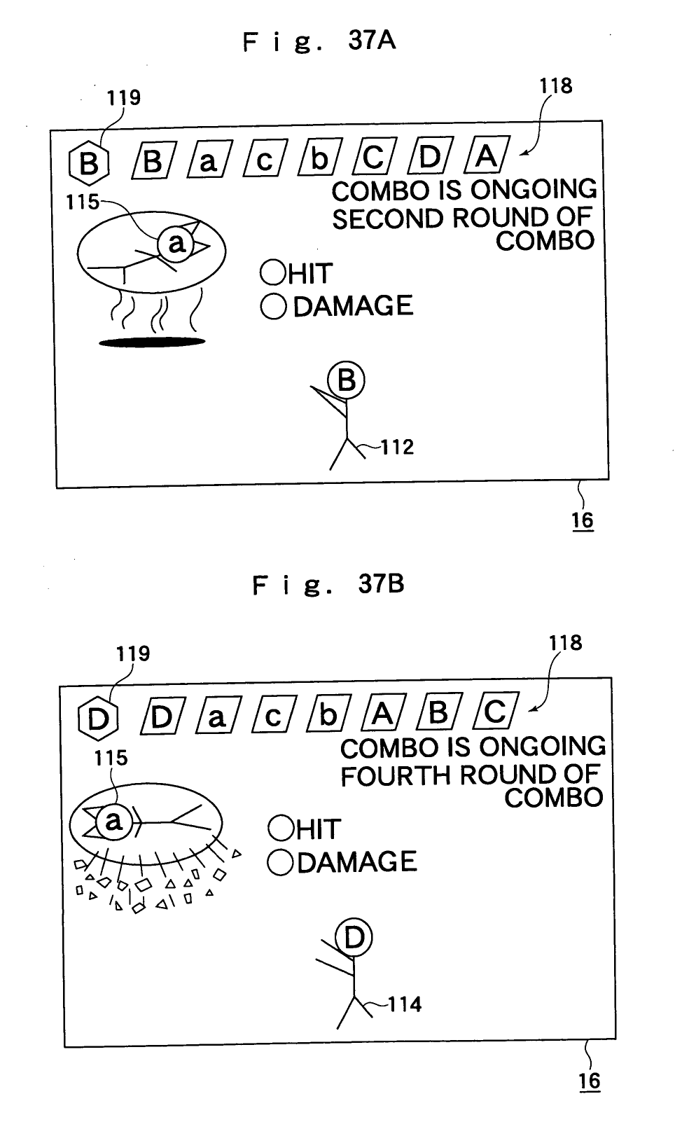

FIGS. 37A and 37B are illustrations showing a battle scene;

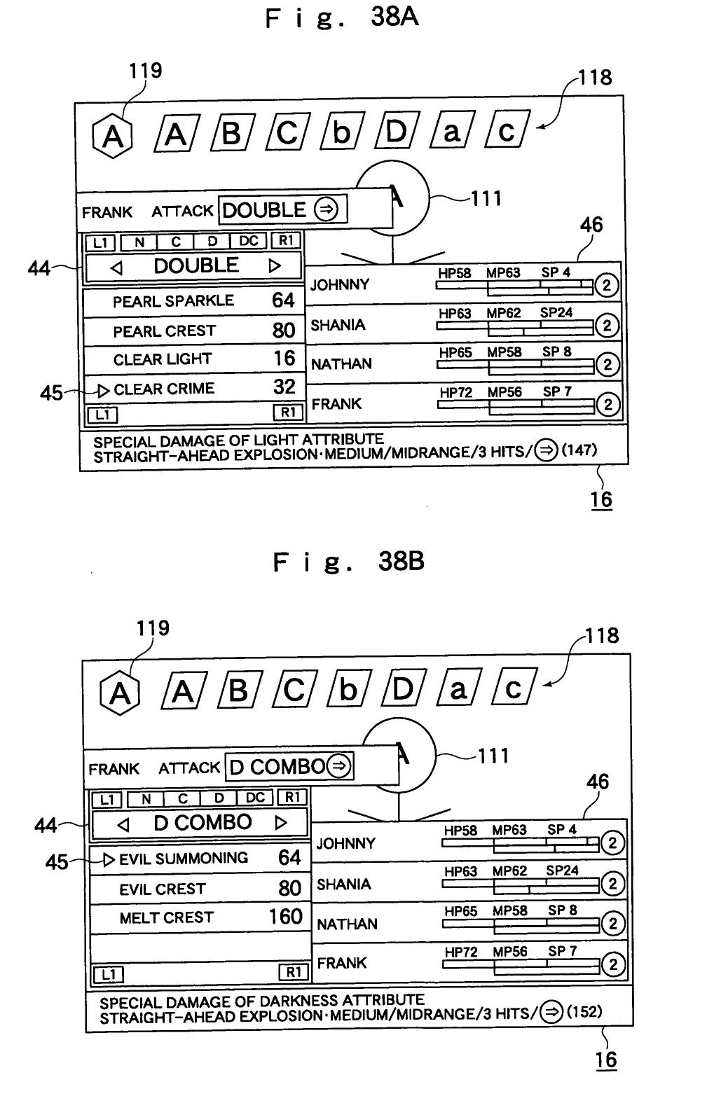

FIGS. 38A and 38B are illustrations showing a battle scene;

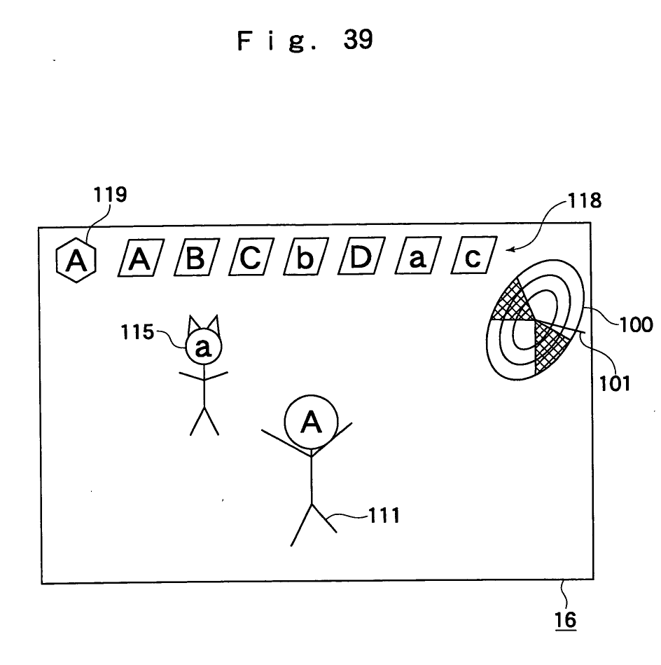

FIG. 39 is an illustration showing a battle scene;

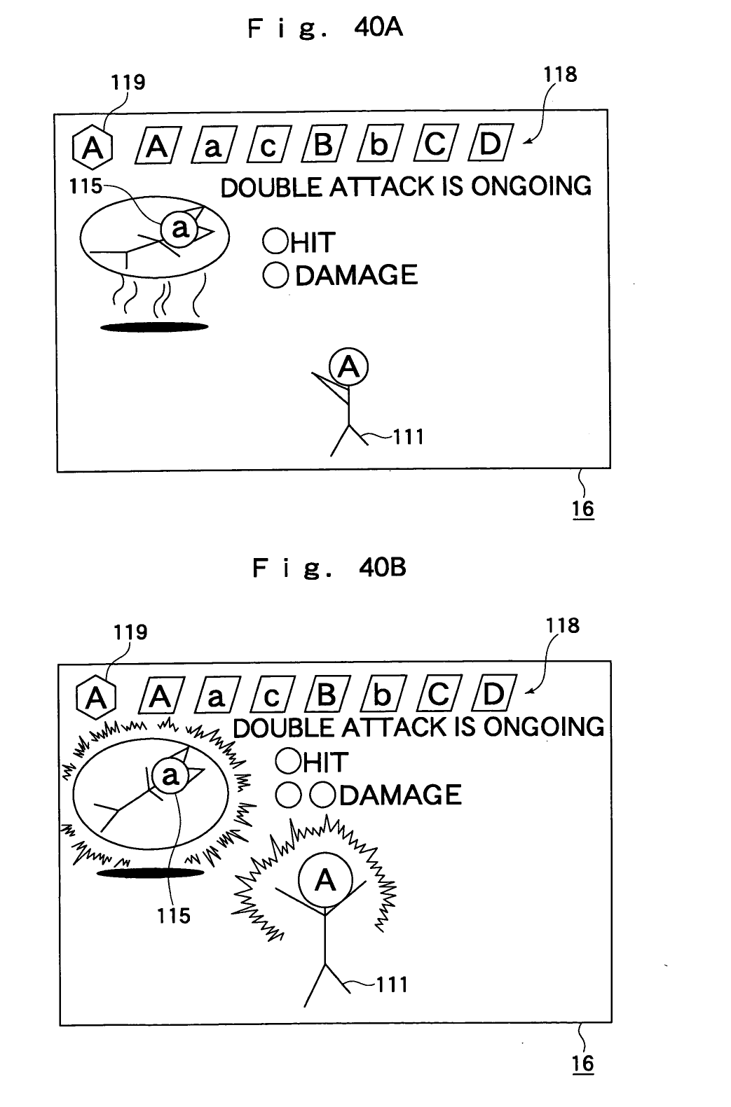

FIGS. 40A and 40B are illustrations showing a battle scene;

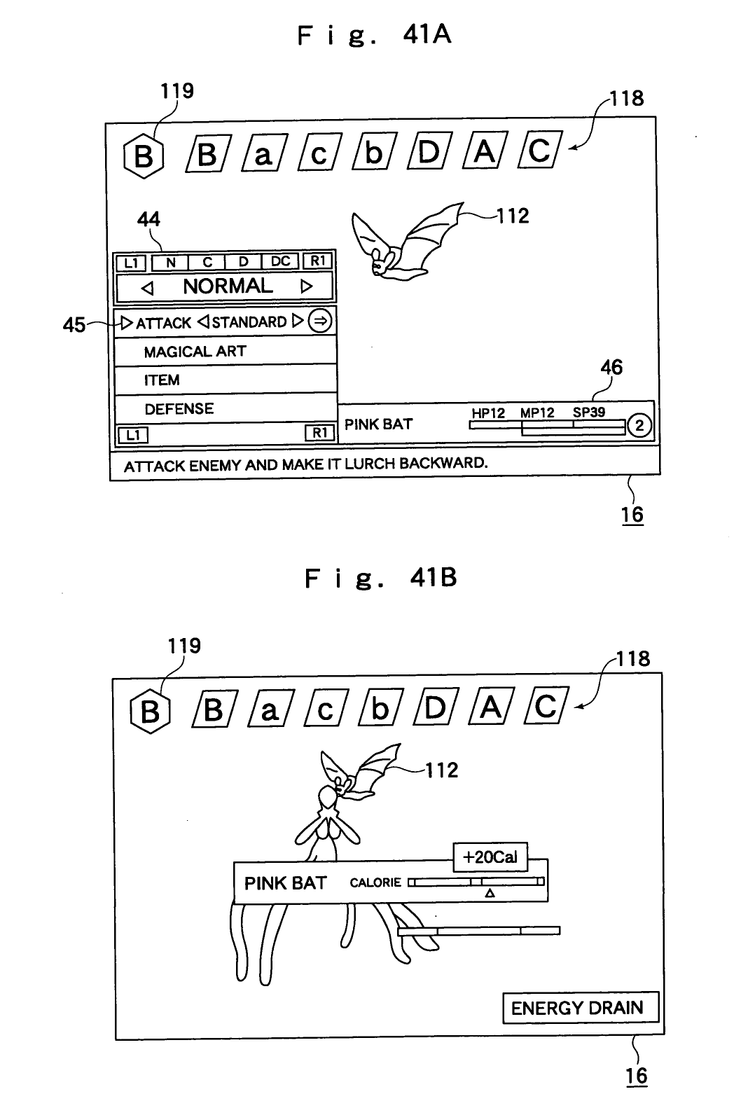

FIGS. 41A and 41B are illustrations showing a battle scene;

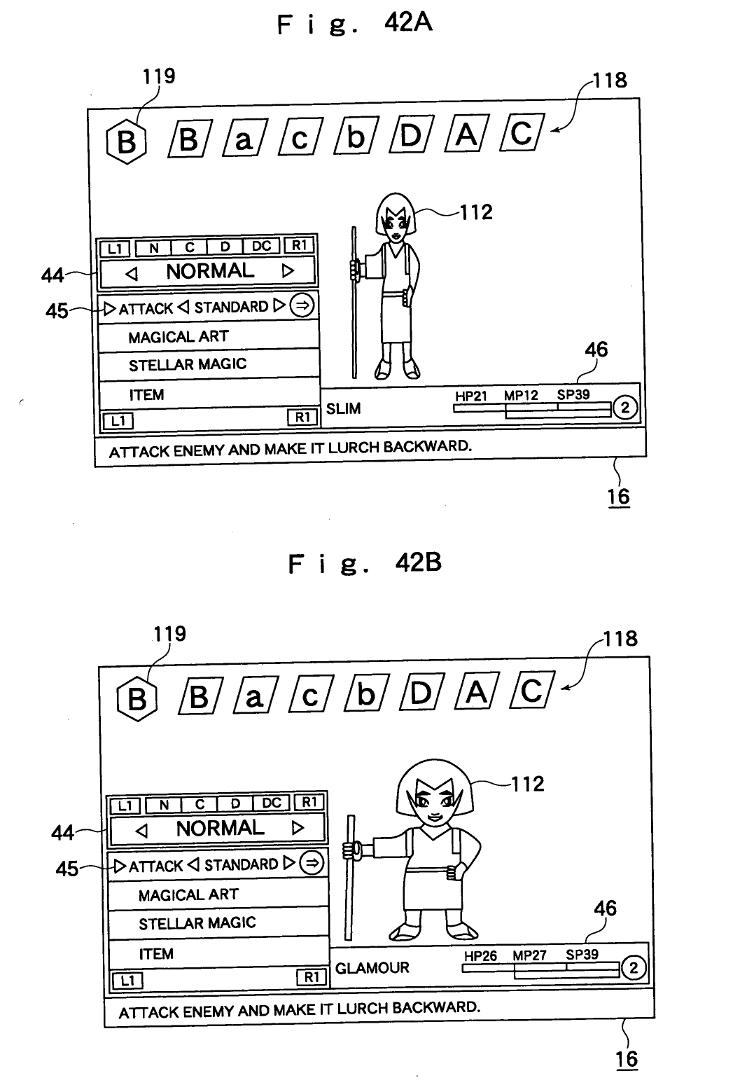

FIGS. 42A and 42B are illustrations showing a battle scene;

FIGS. 43A and 43B are illustrations showing a status display screen;

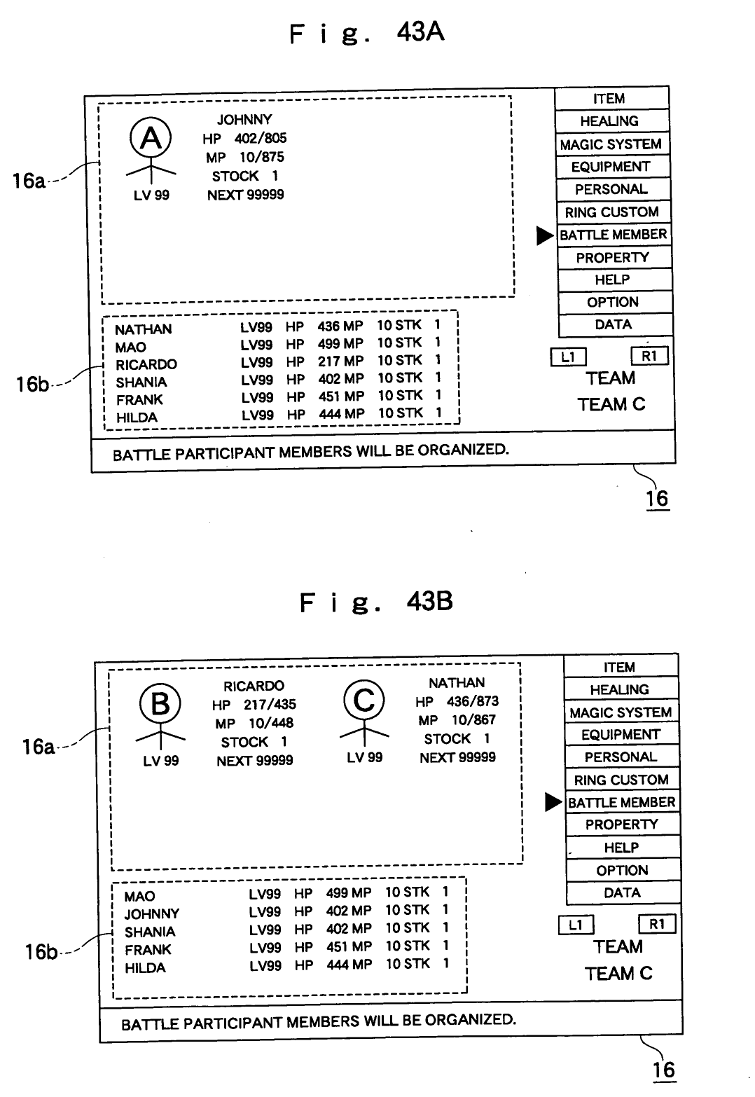

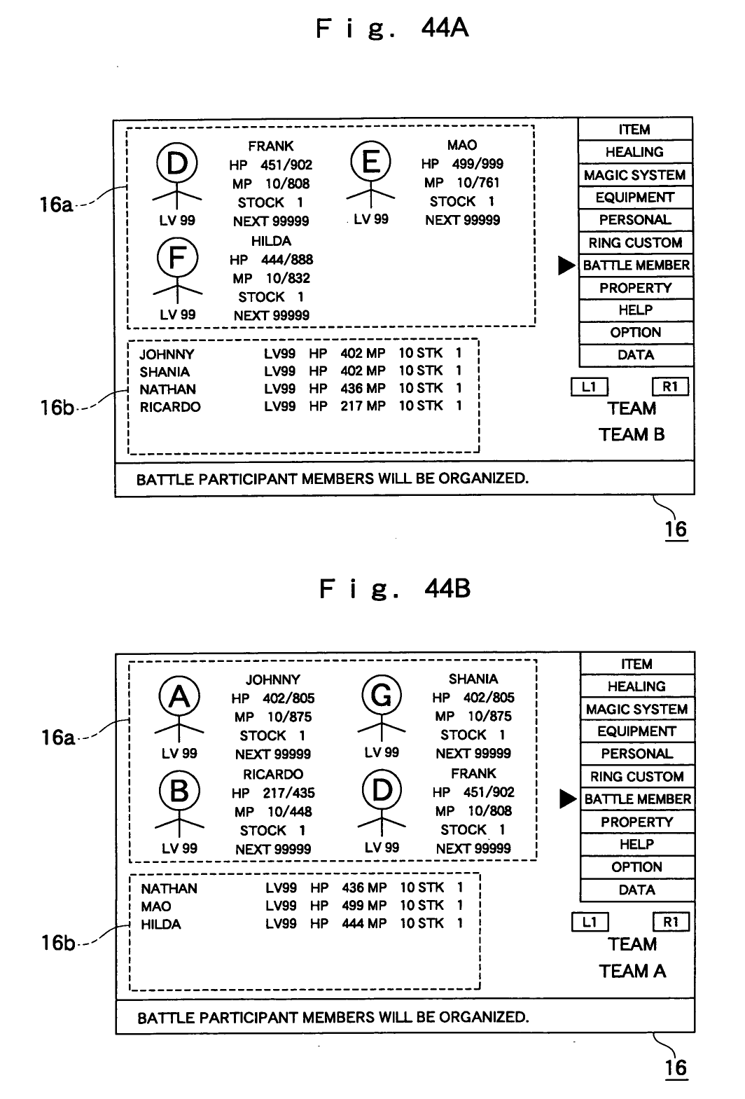

FIGS. 44A and 44B are illustrations showing a status display screen;

FIGS. 45A and 45B are illustrations showing a magic plate/magic stone setting screen;

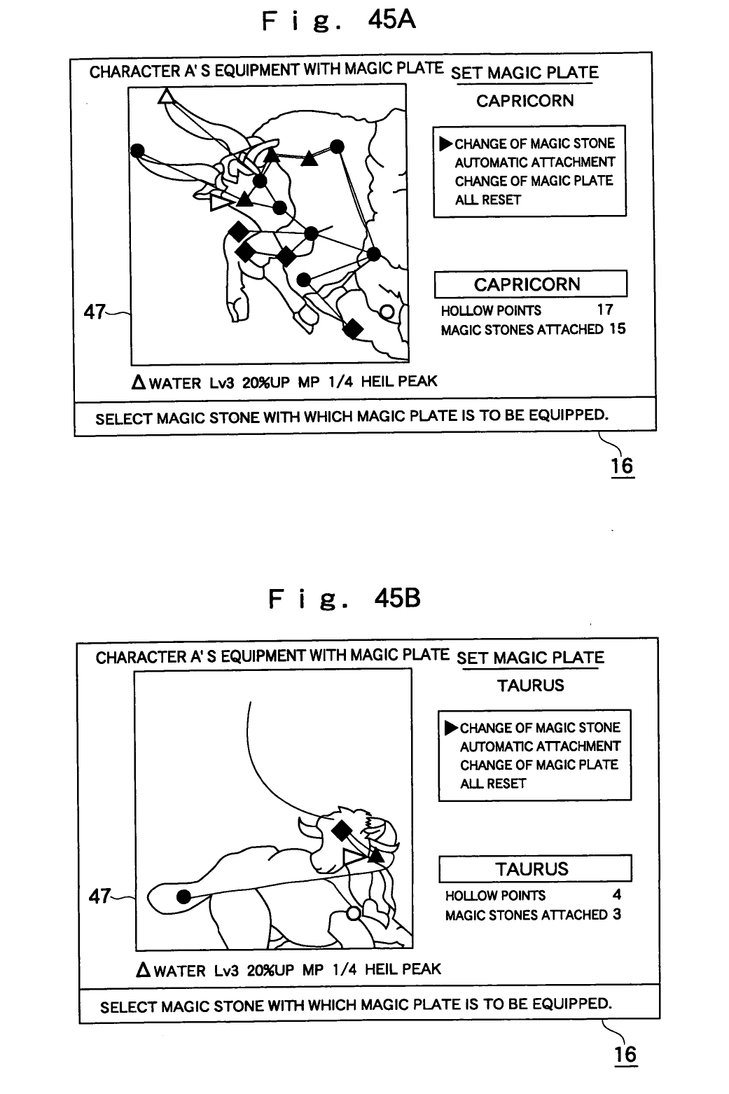

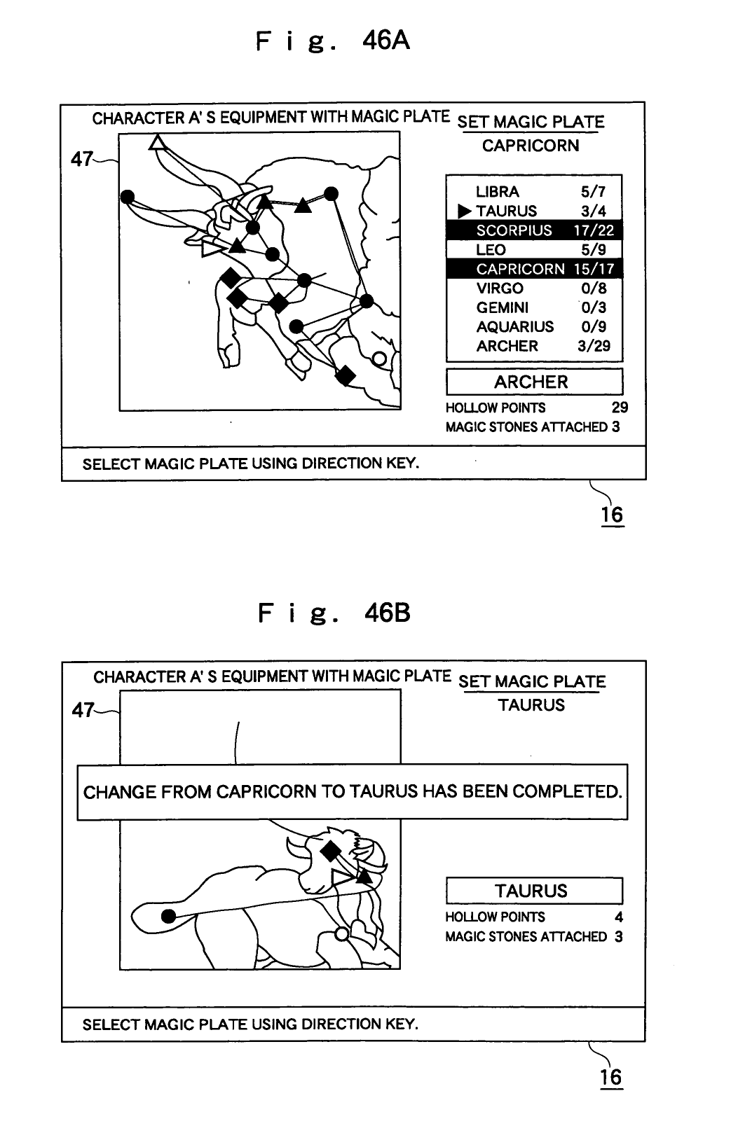

FIGS. 46A and 46B are illustrations showing a magic plate/magic stone setting screen;

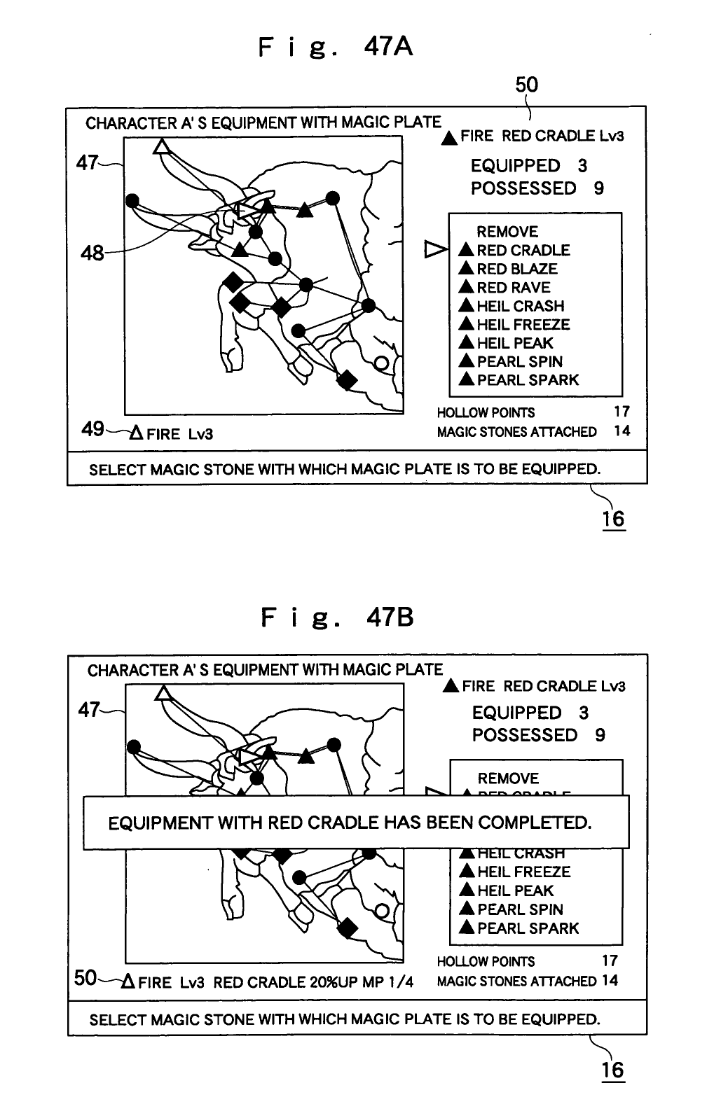

FIGS. 47A and 47B are illustrations showing a magic plate/magic stone setting screen;

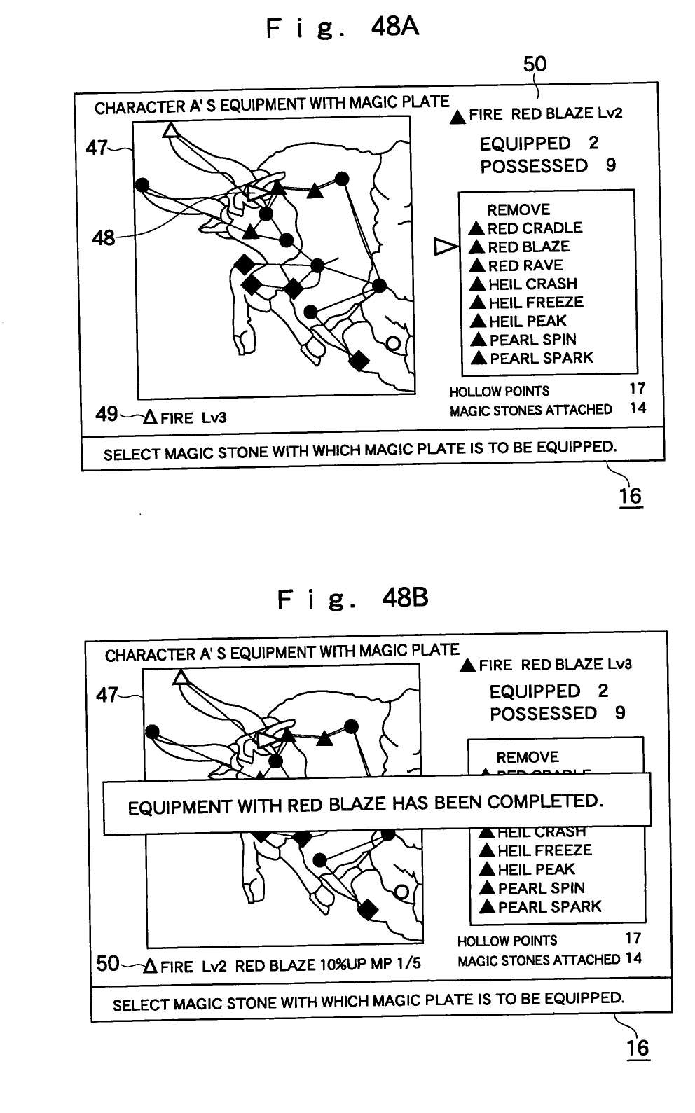

FIGS. 48A and 48B are illustrations showing a magic plate/magic stone setting screen;

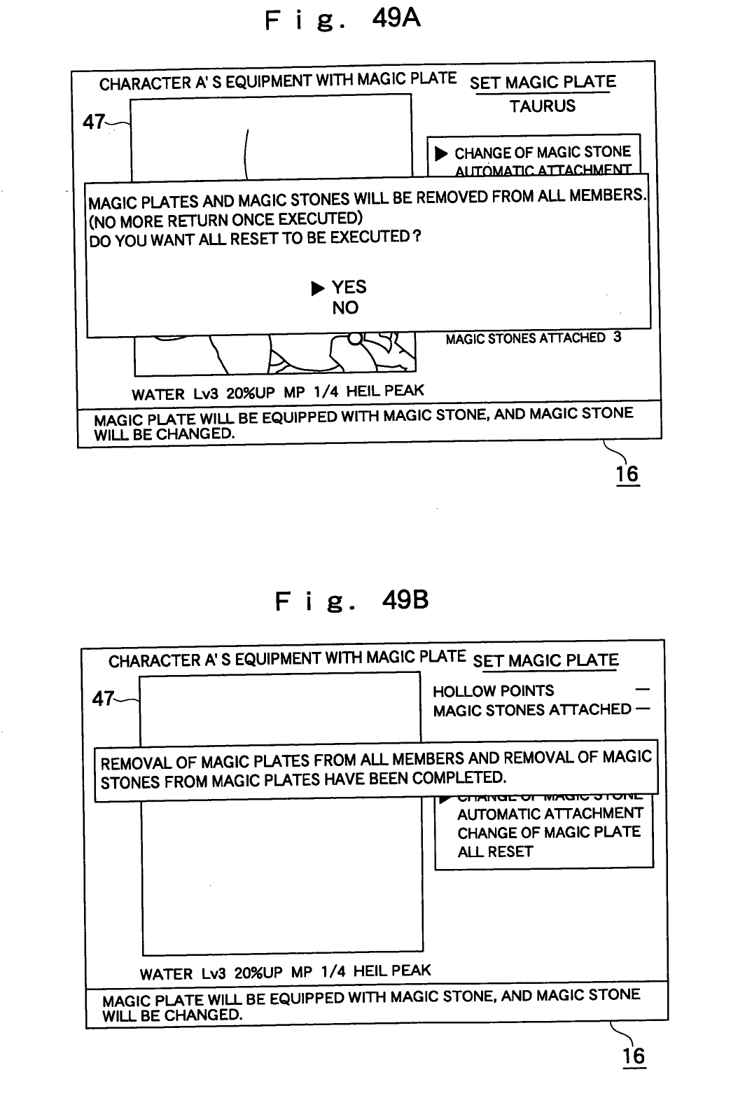

FIGS. 49A and 49B are illustrations showing a magic plate/magic stone setting screen;

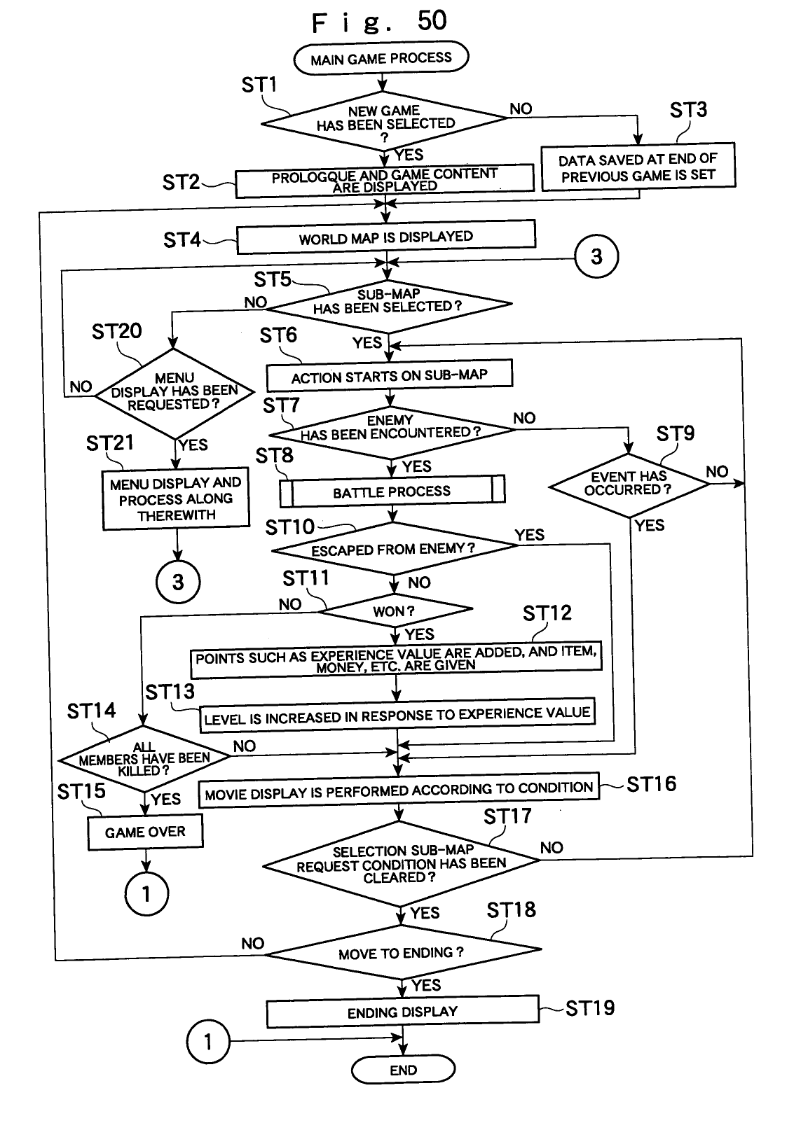

FIG. 50 is a flowchart showing the procedure of a main game process;

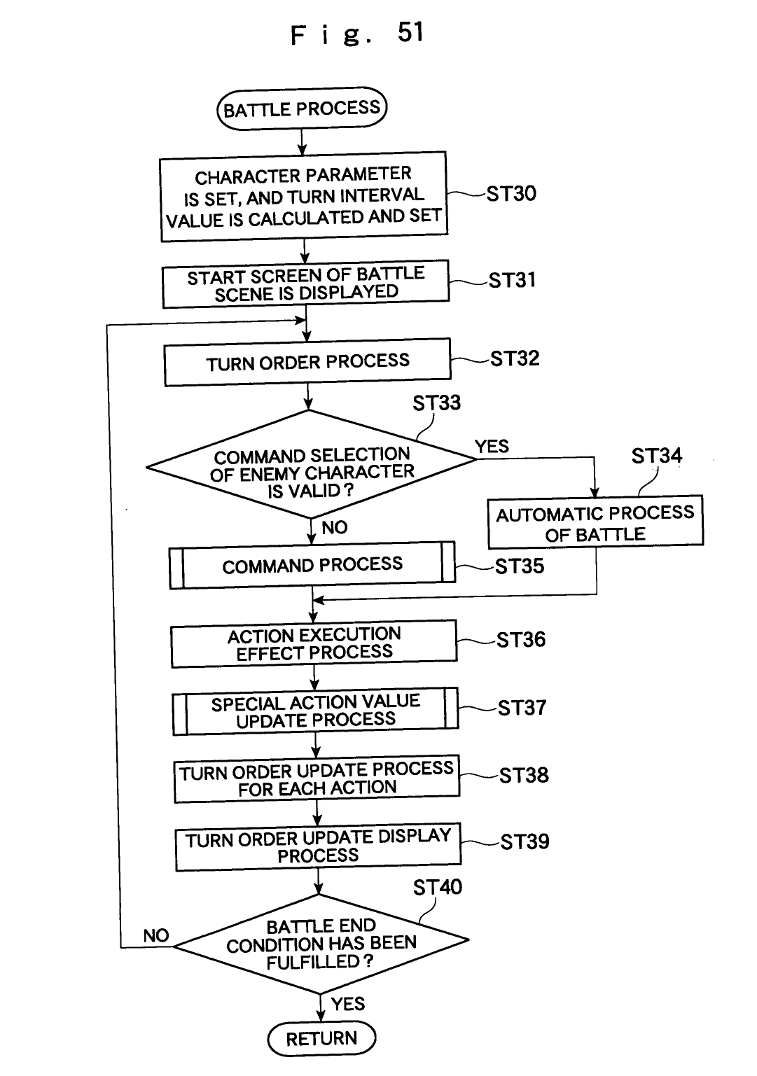

FIG. 51 is a flowchart showing the procedure of a battle process;

FIG. 52 is a flowchart showing the procedure of a special action value update process;

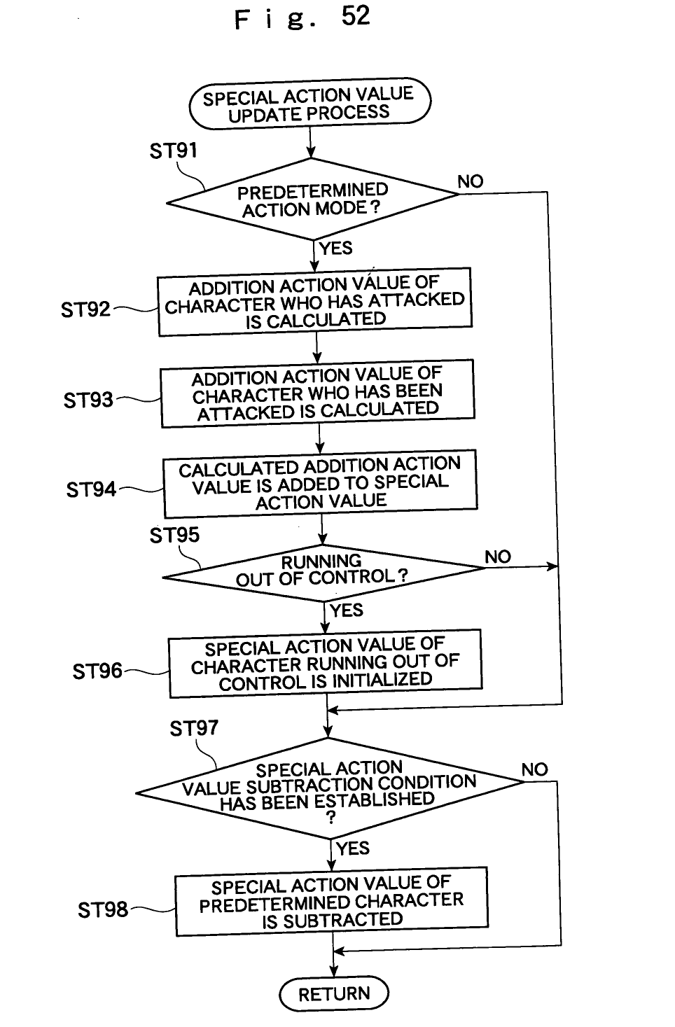

FIG. 53 is a flowchart showing the procedure of a command process;

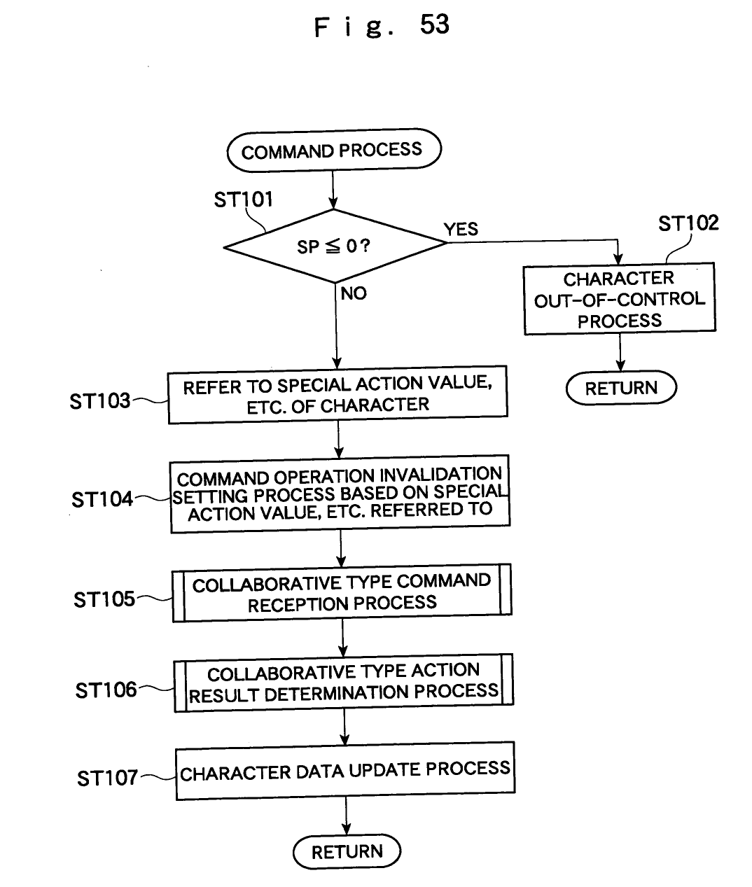

FIG. 54 is a flowchart showing the procedure of a normal command reception process;

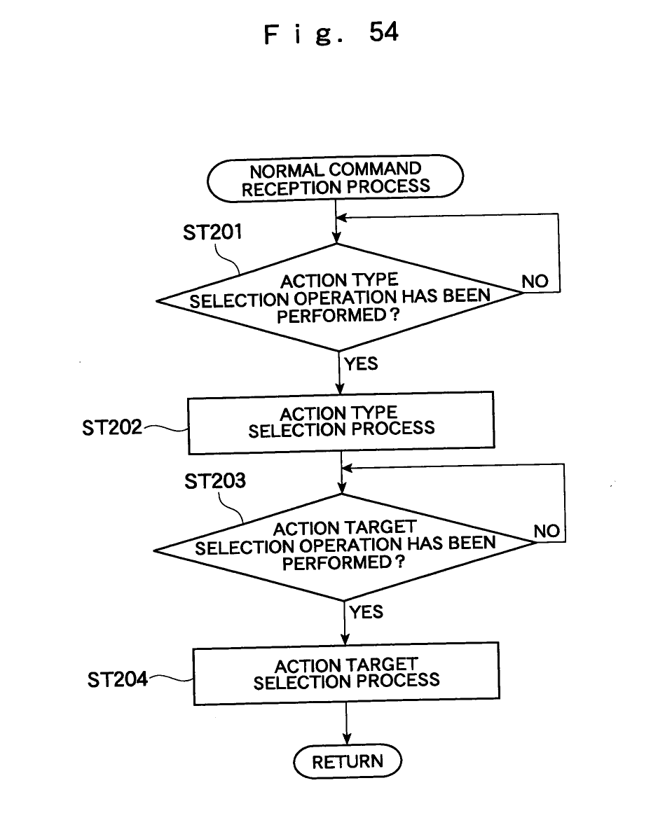

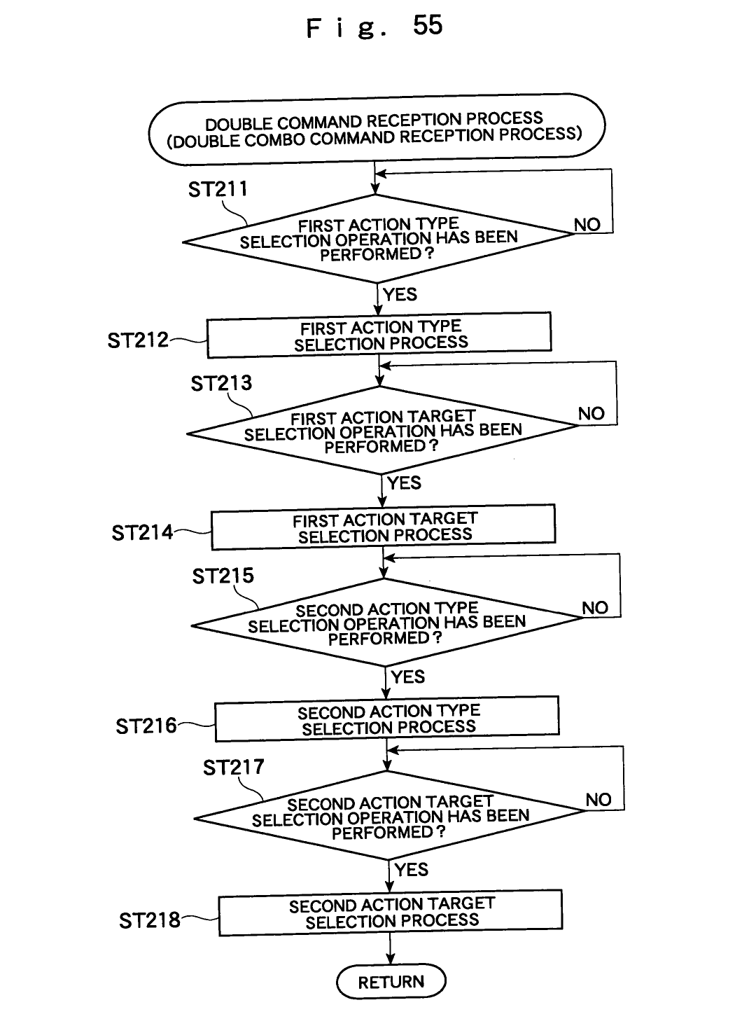

FIG. 55 is a flowchart showing the procedure of a double command reception process and a double combo command reception process;

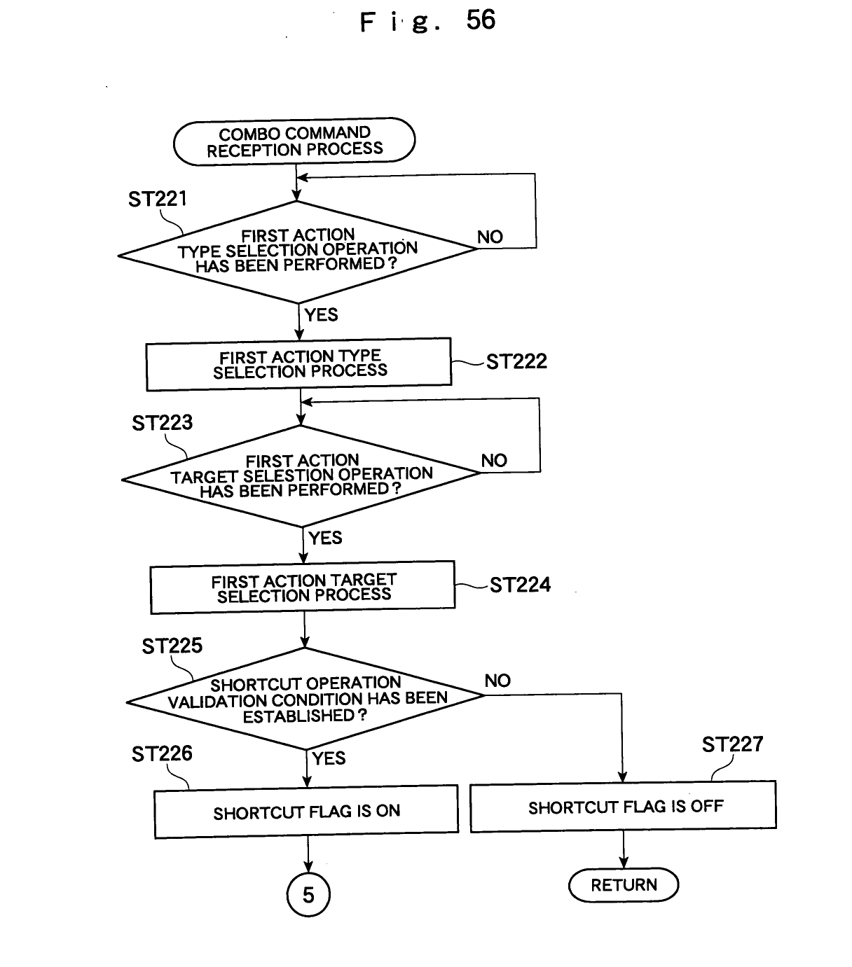

FIG. 56 is a flowchart showing the procedure of a combo command reception process;

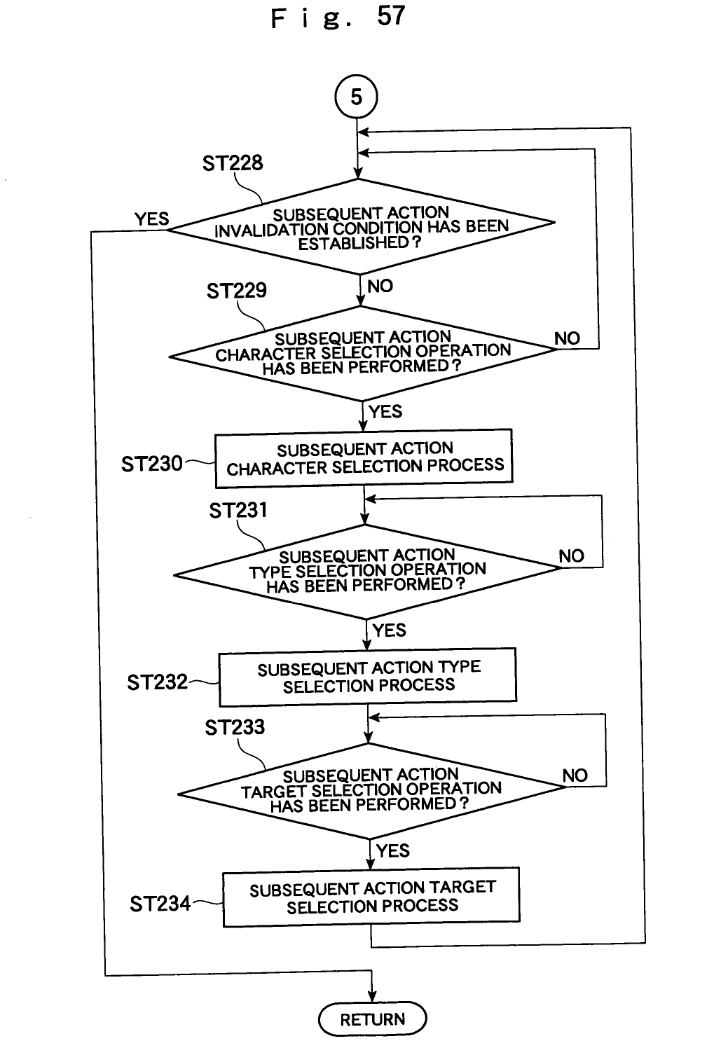

FIG. 57 is a flowchart showing the procedure of the combo command reception process;

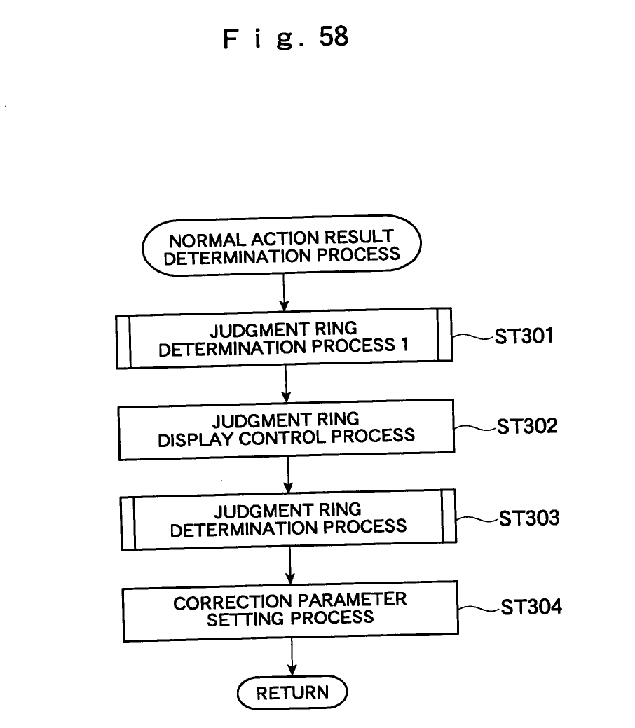

FIG. 58 is a flowchart showing the procedure of a normal action result determination process;

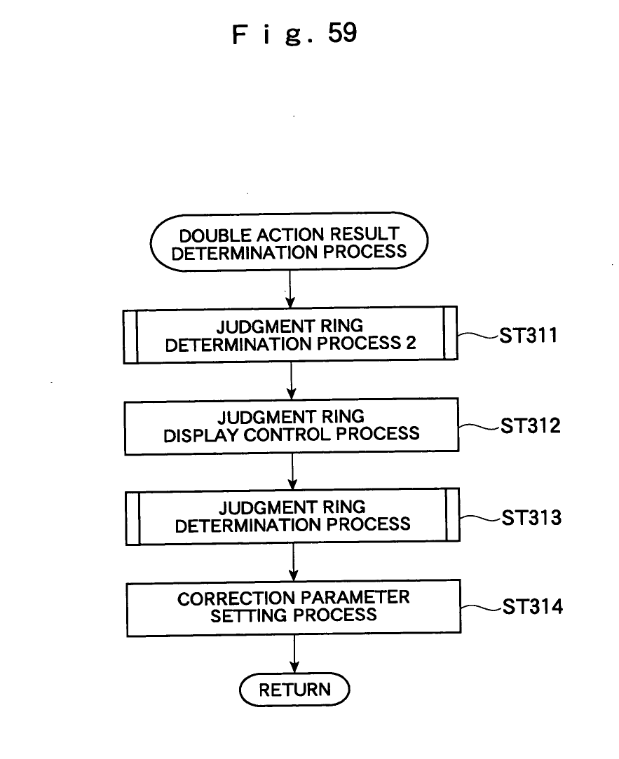

FIG. 59 is a flowchart showing the procedure of a double action result determination process;

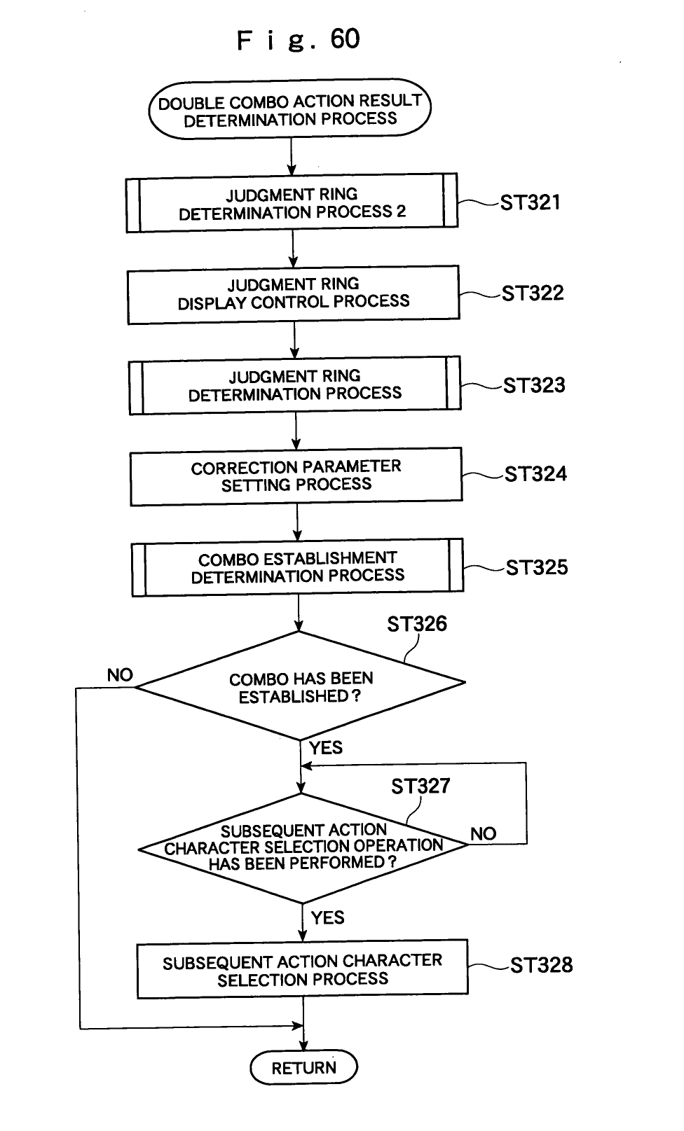

FIG. 60 is a flowchart showing the procedure of a double combo action result determination process;

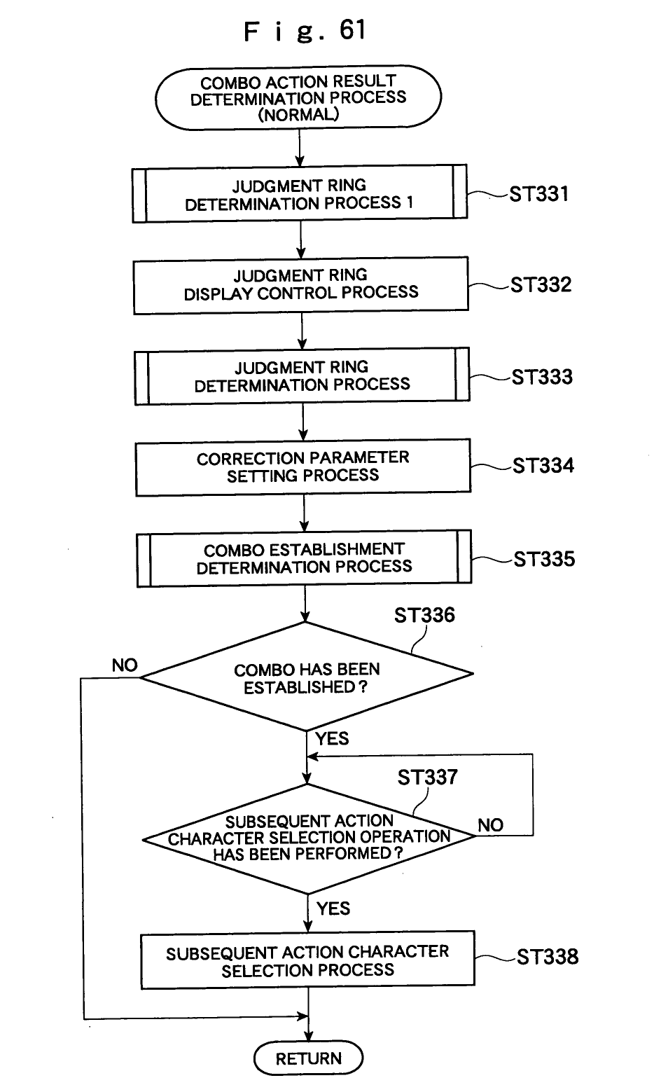

FIG. 61 is a flowchart showing the procedure of a combo action result determination process (normal);

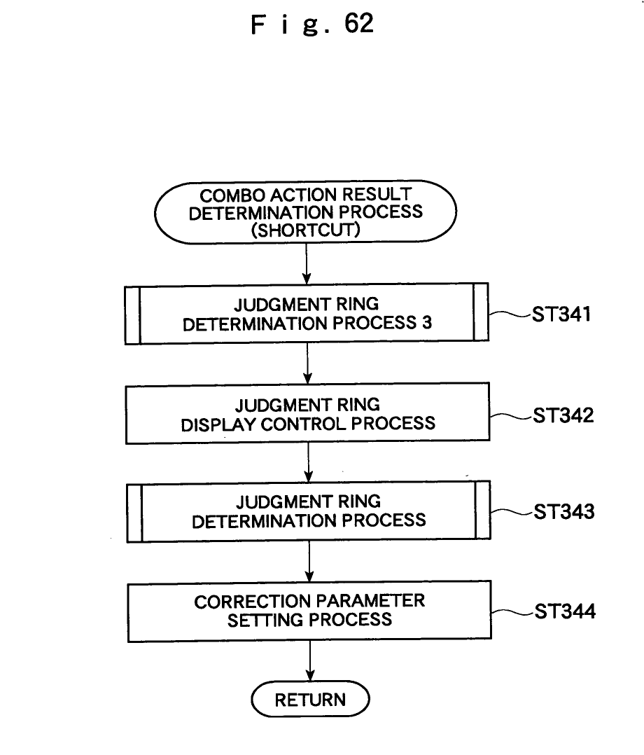

FIG. 62 is a flowchart showing the procedure of a combo action result determination process (shortcut);

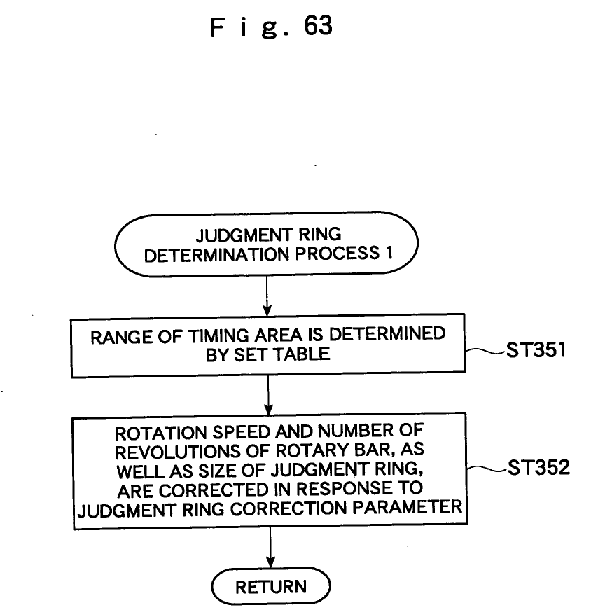

FIG. 63 is a flowchart showing the procedure of a judgment ring determination process 1;

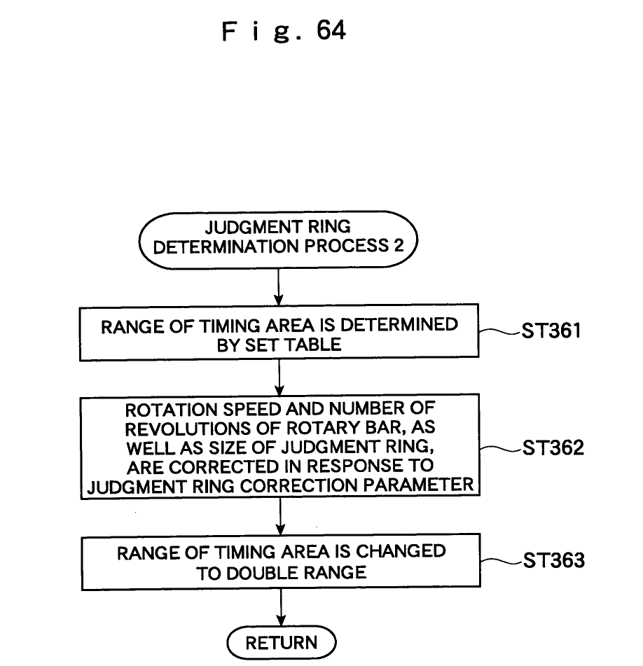

FIG. 64 is a flowchart showing the procedure of a judgment ring determination process 2;

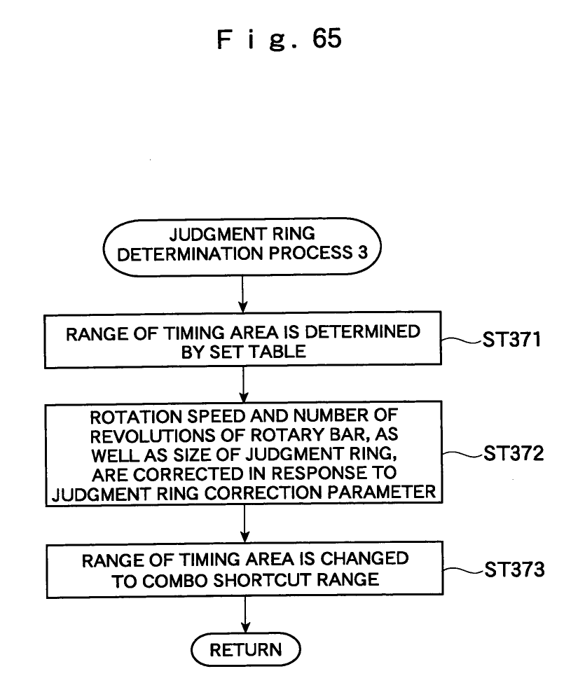

FIG. 65 is a flowchart showing the procedure of a judgment ring determination process 3;

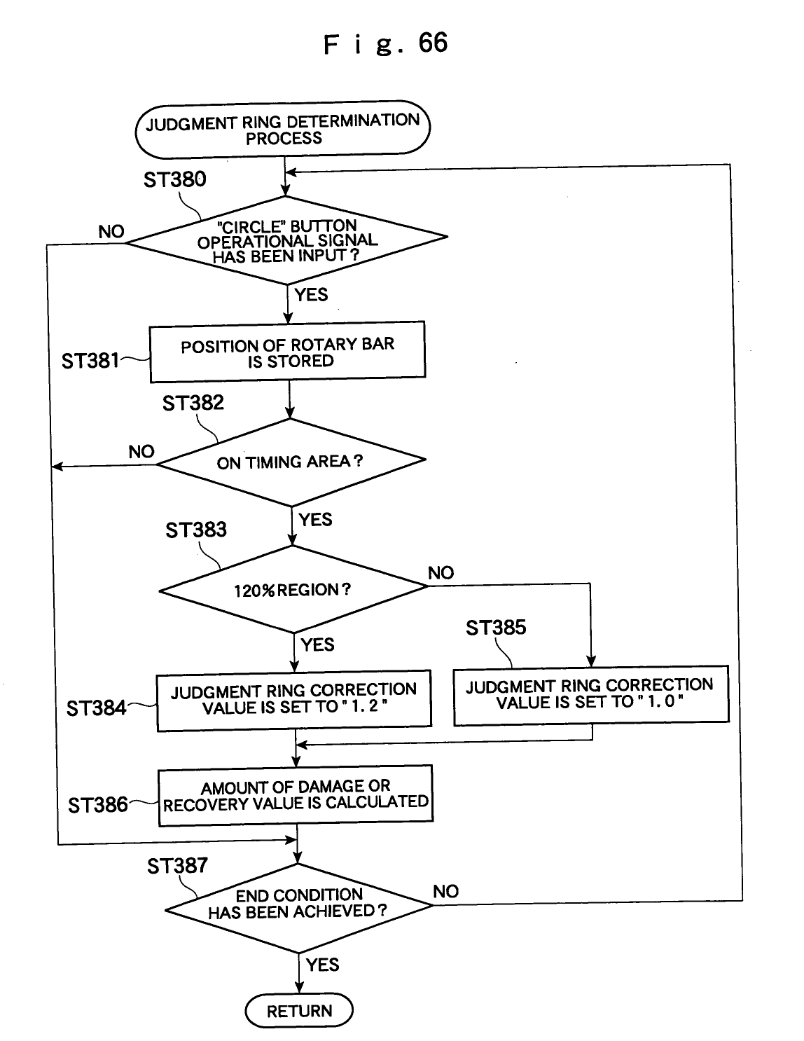

FIG. 66 is a flowchart showing the procedure of a judgment ring determination process;

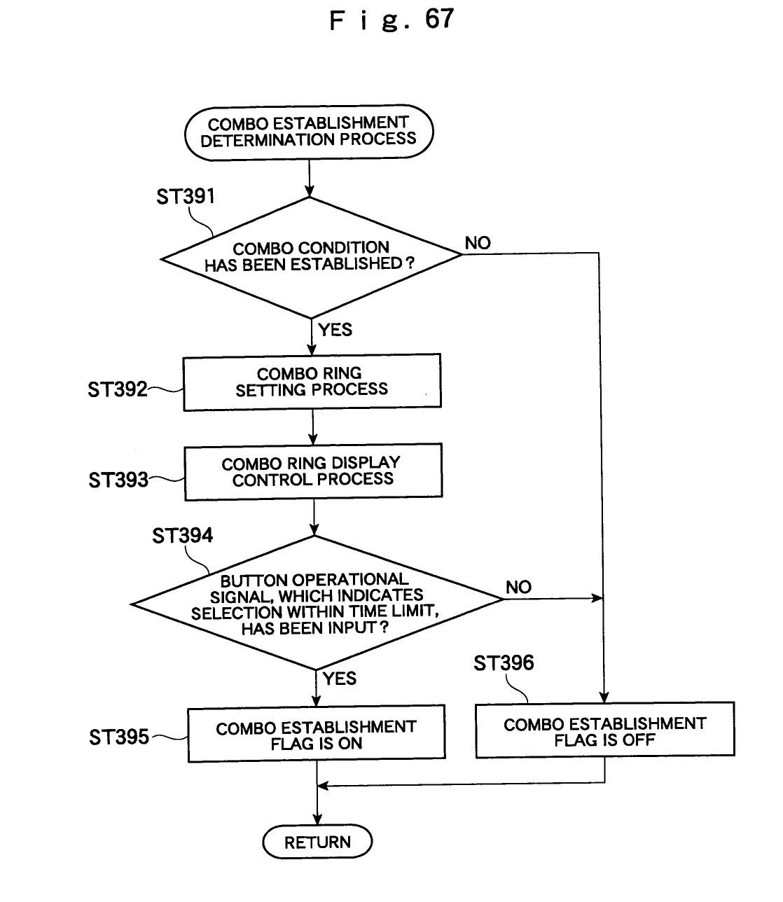

FIG. 67 is a flowchart showing the procedure of a combo establishment determination process;

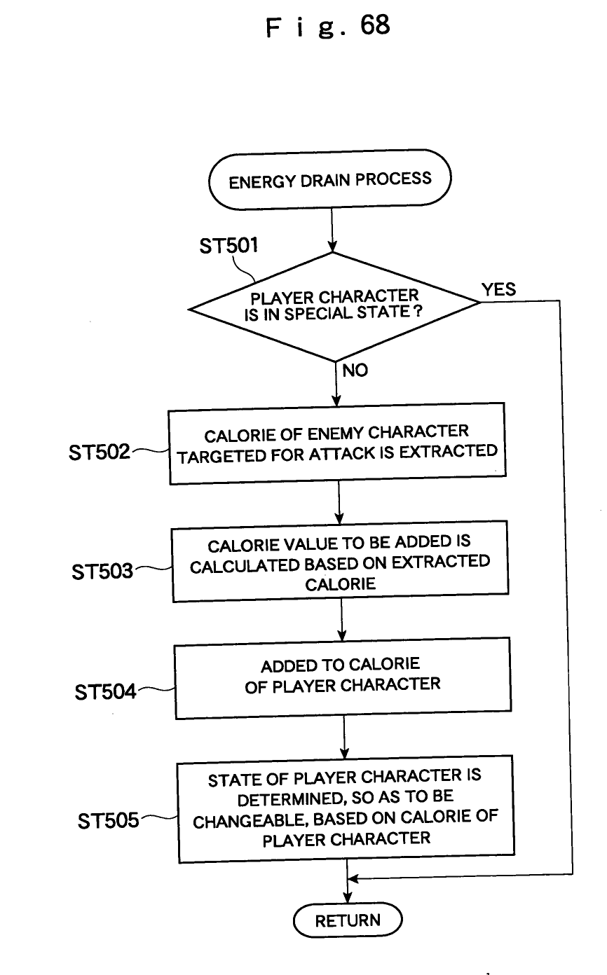

FIG. 68 is a flowchart showing the procedure of an energy drain process;

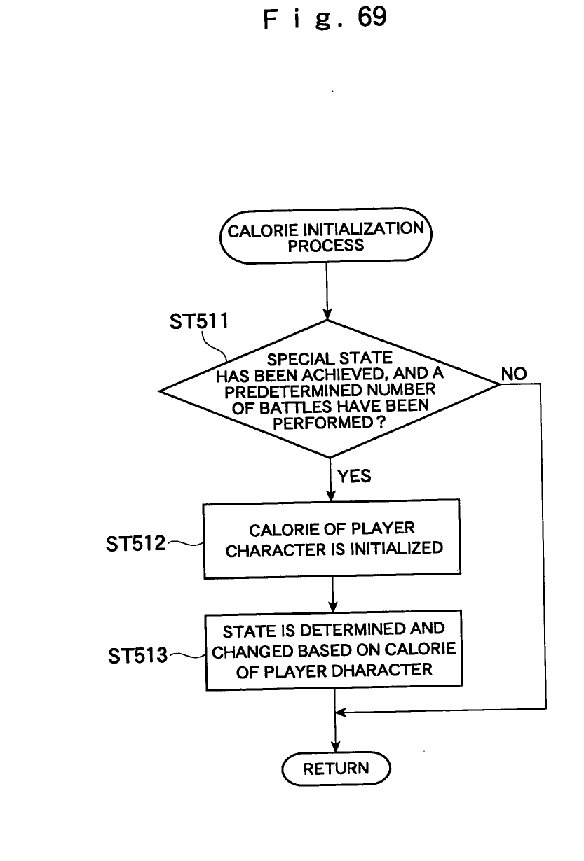

FIG. 69 is a flowchart showing the procedure of a calorie initialization process;

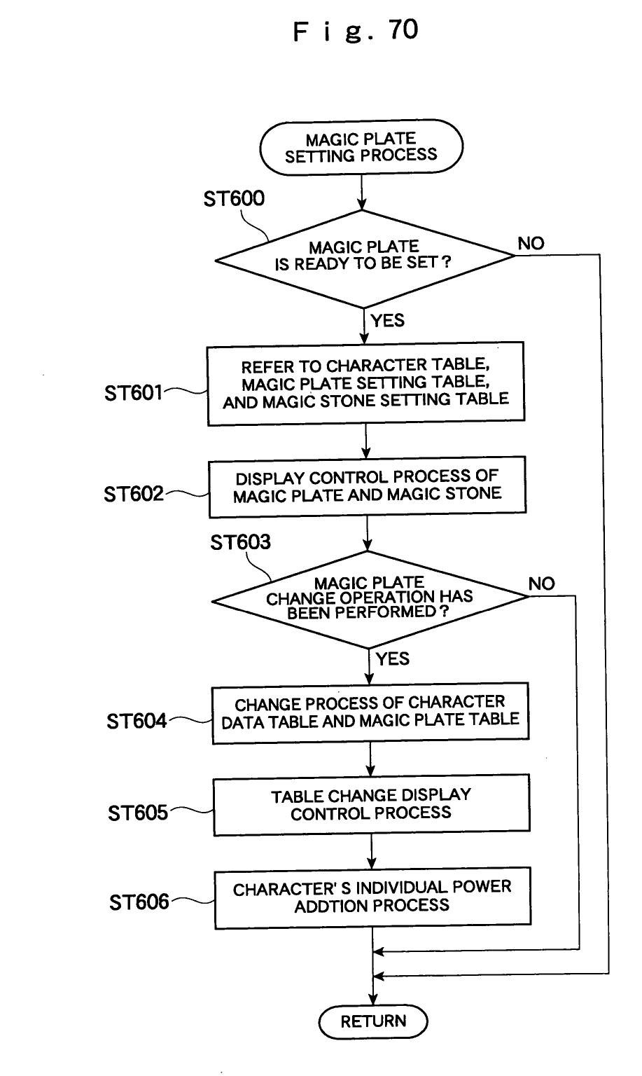

FIG. 70 is a flowchart showing the procedure of a magic plate setting process;

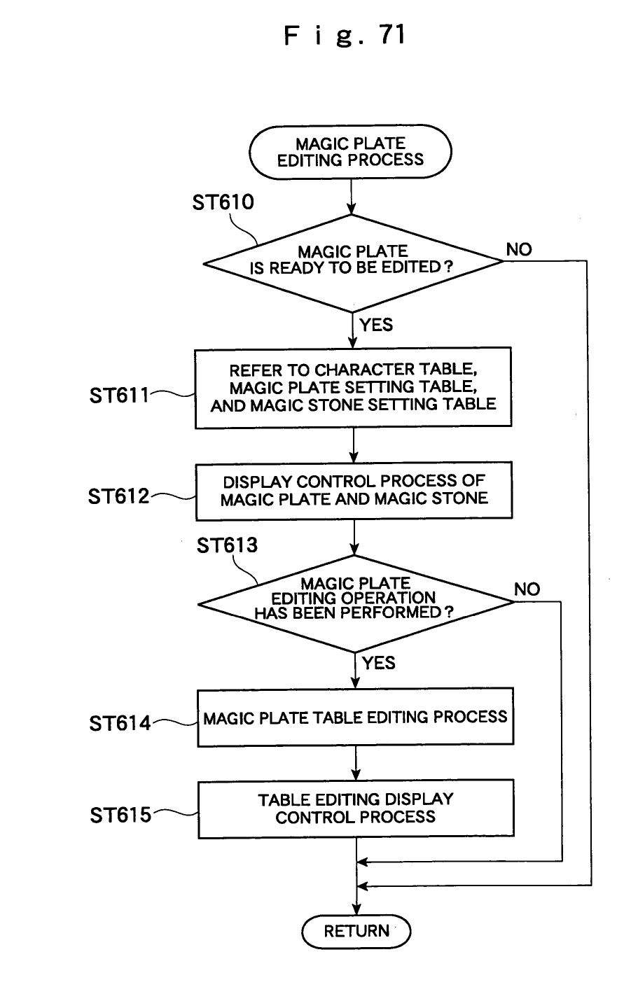

FIG. 71 is a flowchart showing the procedure of a magic plate editing process;

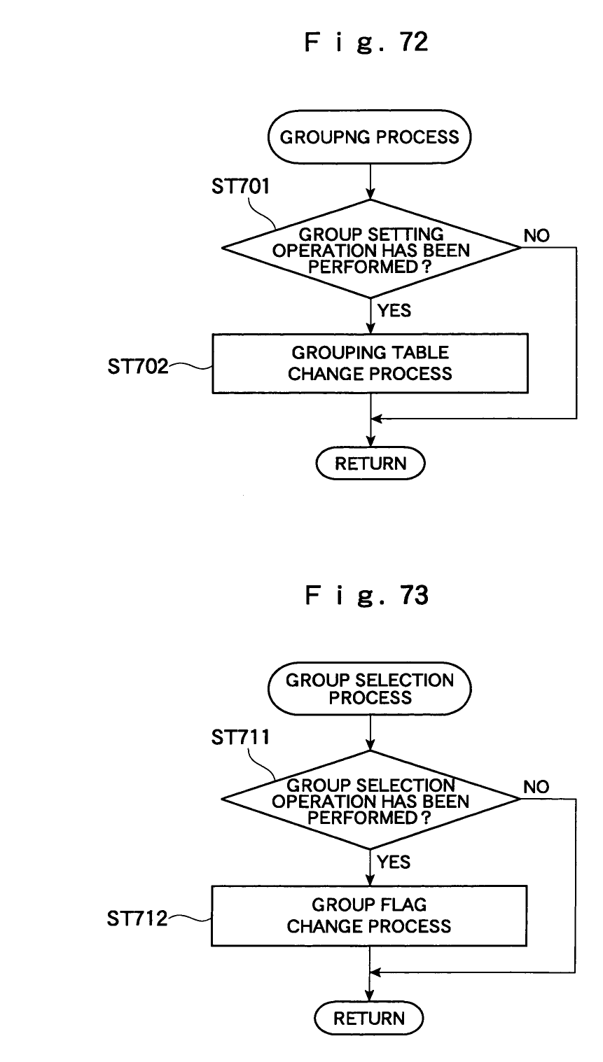

FIG. 72 is a flowchart showing the procedure of a grouping process;

FIG. 73 is a flowchart showing the procedure of a group selection process;

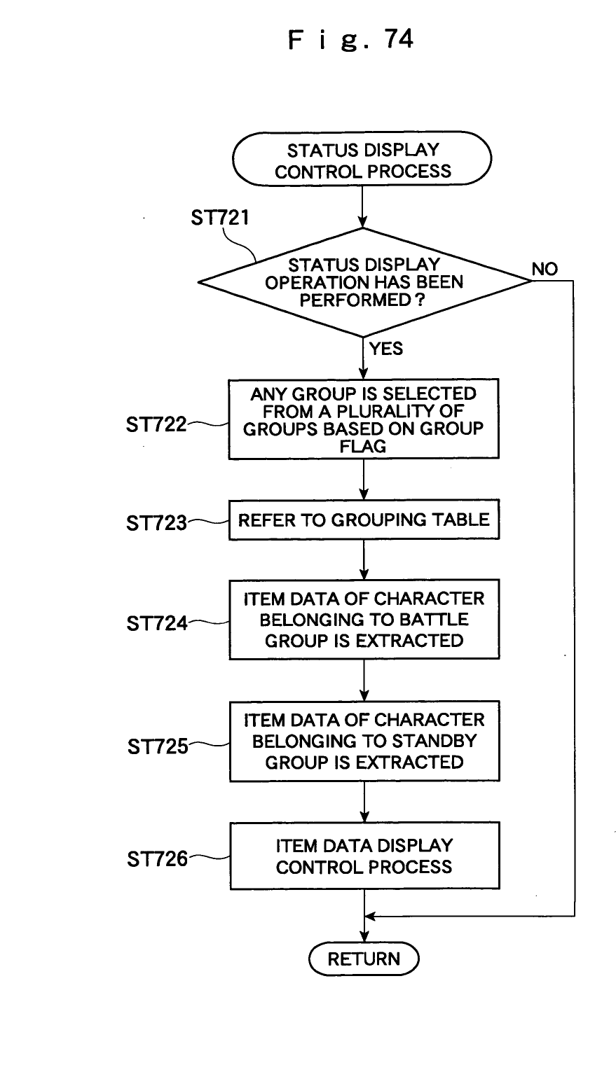

FIG. 74 is a flowchart showing the procedure of a status display control process; and

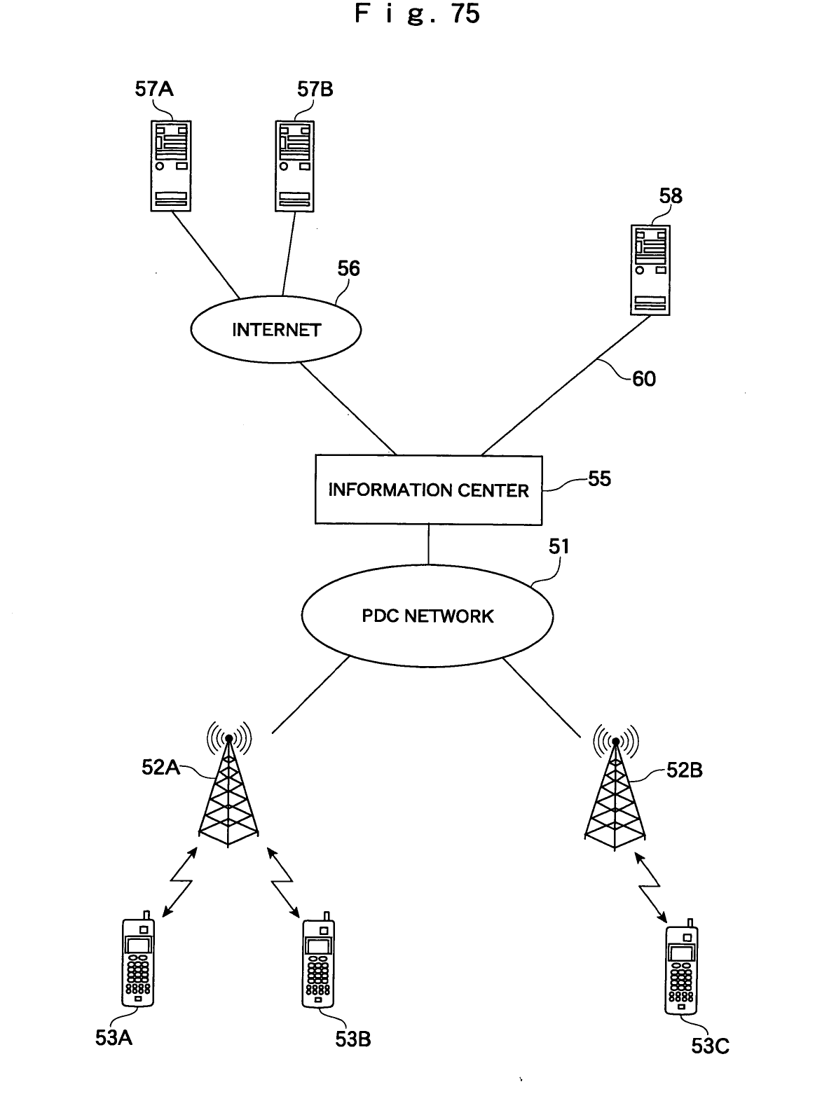

FIG. 75 is a diagram showing the configuration of a network gaming system.

### DESCRIPTION OF THE PREFERRED EMBODIMENTS

A preferred embodiment of the invention will hereafter be described with reference to the drawings.

Configuration of Gaming Apparatus

FIG. 1 shows the overall configuration of a gaming apparatus to which the invention is applied. This gaming apparatus 200 includes an apparatus body 1, a input device 4 which acts as an operating device (capable of being operated by a player) for outputting a control command to the apparatus body 1 in response to a player's operation, and a display device 15 which displays an image based on an image signal from the apparatus body 1. On this gaming apparatus 200, a game is executed as a variety of images, such as a plurality of characters which include a player character and an enemy character, are displayed on a display surface (hereafter called a “display”) 16, such as a CRT, of the display device 15.

The game to be executed on this gaming apparatus 200 is executed by reading a game program stored in an external recording medium separate from the apparatus body 1. The external recording medium which stores the game program can utilize an FD (Flexible Disk) and any other recording media, in addition to a CD-ROM and a DVD-ROM. This embodiment describes the case in which the DVD-ROM is used. An openable/closable cover 2 is disposed in the central upper portion of the apparatus body 1. By opening this cover 2, a DVD-ROM 31 (see FIG. 2) can be loaded into a DVD-ROM drive 29 (see FIG. 2) which acts as a recording medium drive disposed inside the apparatus body 1.

The input device 4 includes various input parts which a player operates to issue control commands to a CPU 21 (see FIG. 2) in the apparatus body 1. As the input parts, an up key 7, a down key 8, a left key 9, and a right key 10, which are operated mainly to move a character appearing in the game and to move an item selected from a menu, are disposed in the left portion of the input device 4. A “triangle” button 11, a “circle” button 12, an “Ex” button 13, and a “square” button 14, which are operated mainly to determine and cancel various items, are disposed in the right portion of the input device 4. A selection button 6 and a start button 5 are disposed in the central upper and lower portions of the input device 4.

The display device 15 includes a video signal input terminal and a sound signal input terminal, which are connected via terminal cables 18 and 19 to a video output terminal and a sound output terminal of the apparatus body 1, respectively. The display device 15 uses a TV receiver which integrally includes the display 16 capable of displaying image data output from an image output section 25 (see FIG. 2) to be described later and speakers 17L and 17R (see FIG. 2) capable of outputting sound data output from a sound output section 27 (see FIG. 2) to be described later. As shown in FIG. 1, the apparatus body 1 and the input device 4 which acts as the operating device are connected by a signal cable 20.

Additionally, a memory slot 3 which acts as an insertion slot for a memory card 32 (see FIG. 2) is disposed in a side surface of the apparatus body 1. The memory card 32 is a storage medium for temporarily storing game data when the player pauses the game or in the like case. The data recorded in this memory card 32 is read via a to-be-described communication interface 30 (see FIG. 2) which has the function of acting as a card reader.

Electrical Configuration of Gaming Apparatus

FIG. 2 shows the system configuration of the gaming apparatus 200. The apparatus body 1 includes the CPU 21 acting as a control section, the ROM 22 and RAM 23 acting as modulestorage modules, an image processing section 24, the image output section 25, a sound processing section 26, the sound output section 27, a decoder 28, the DVD-ROM drive 29, and the communication interface 30.

The DVD-ROM drive 29 is configured such that the DVD-ROM 31 is attachable and detachable therefrom, and a game program in the DVD-ROM 31 attached thereto is read out by the CPU 21 in accordance with a basic operating program, such as an OS (Operating System), stored in the ROM 22. The read-out game program is converted by the decoder 28 into a predetermined signal and stored in the RAM 23.

The game program stored in the RAM 23 is executed by the CPU 21 in accordance with the basic operating program or an input signal from the input device 4. Image data and sound data are read from the DVD-ROM 31 in response to the executed program, and the image data and the sound data are sent to the image processing section 24 and the sound processing section 26, respectively.

The image processing section 24 converts the received image data into an image signal and, by supplying the image signal from the image output section 25 to the display device 15, displays an image on the display 16. Particularly, the image processing section<24 has the function of exerting control to calculate, at each predetermined time, the position between a display target (e.g., a display object such as a character) located in a virtual 3D coordinate space and a view point, to generate image data of the display target viewed from the view point, and to display an image, which is based on the generated image data, on the display 16.

The sound processing section 26 converts the received sound data into a sound signal and supplies the sound data from the sound output section 27 to the speakers 17L and 17R.

The communication interface 30 is configured such that the input device 4 and the memory card 32 can be attachably and detachably connected thereto. Via this communication interface 30, data is read and written to the memory card 32, and signals from the input device 4 are sent to units such as the CPU 21.

Character's Individual Power

Additionally, the aforementioned RAM 23 stores the game program read from inside the DVD-ROM 31 and a parameter relating to a character, which parameter is based on the memory card 32. As one specific example of such a parameter relating to a character, character's individual power will be described using FIGS. 3A and 3B. FIGS. 3A and 3B are illustrations showing the character's individual power of player character A and player character B. The character's individual power of player character A and player character B will be described hereafter, but the character's individual power of another player character and an enemy character will also be stored in the RAM 23.

The character's individual power shown in FIGS. 3A and 3B (one example of character data) is stored for each plurality of characters appearing in the game. The type of the character's individual power includes “hit points” (hereafter called “HP”), “magic points” (hereafter called “MP”), “sanity points” (hereafter called “SP”), “physical attack power” (hereafter called “STR”), “physical defense power” (hereafter called “VIT”), “speed” (hereafter called “AGL”), “magic attack power” (hereafter called “INT”), “magic defense power” (hereafter called “POW”), and “luck” (hereafter called “LUC”). These are expressed in numerical terms and are, even though at an identical character level, set to values which differ from one type of character to another.

Additionally, the character individual power is set in response to a character level (hereafter called “LV”). This LV varies depending on an experience value which is cumulatively stored in response to an experience, such as a battle, in the game. Particularly, in the case of HP, MP, and SP, maximum HP, maximum MP, and maximum SP which correspond to the character's individual power, as well as actual HP, MP, and SP which vary during the game, are stored. Of course, ACL and LUC also vary depending on a special item or a special skill, as described later.

Furthermore, as described above, the character's individual power is loaded onto the RAM 23. Besides, the character's individual power varies depending on a weapon, a protective gear, an item, and the like with which a character is equipped. Also, the character's individual power varies depending on magic worked by the character and an item used by the character.

Character Data Table

Additionally, the aforementioned RAM 23 stores the game program read from inside the DVD-ROM 31 and character data relating to a character, which data is based on the memory card 32. A character data table having stored therein such character data relating a character will be described using FIG. 4. FIG. 4 is an illustration showing character data relating to characters: player character A, player character B, player character C, and enemy character A. The character data of player character A, player character B, player character C, and enemy character A will be described hereafter, but the character data of another player character and another enemy character is also stored in the RAM 23.

The character data table positioned in the RAM 23 is a table which stores character data (including player character data and enemy character data) relating to a character (including a player character and an enemy character). In this character data table, the character is related to “attribute”, “special action value”, “position (reference)”, “position (current)”, “calorie”, and “equipment with magic plate”. The attribute is information indicating that the character has at least any of a plurality of types of attributes, such as a light attribute or a fire attribute. The special action value is a value which is used to determine whether a special action, such as “combo”, “double”, or “double combo”, can be executed or not, and it will be determined, in accordance with a to-be-described special action table (see FIG. 11), whether various special actions can be executed or not. Also, this special action value is retained not only during one battle scene but even after the battle scene ends. The position (reference) is information indicating a reference position of a character, for example, a ground position or an air position. Also, the position (current) is information indicating a current position of the character, for example, a ground position or an air position. Additionally, while “combo”, “double”, “double combo”, or the like is continuing, such positions (reference) and (current) can differ from each other, and when “combo”, “double”, “double combo”, or the like ends (breaks), the position (current) turns to the position (reference). Furthermore, as described later in detail, damage suffered can differ according to whether such positions (reference) and (current) differ from each other or not. The calorie is a calorie of the character. Particularly, a calorie corresponding to player character B is increasable and reducible. When player character B's turn has come for action, an action category “energy drain” is selected in response to an operation of the input device 4, and when the action becomes successful, a calorie of a character (e.g., enemy character A) targeted for the action will be added to the calorie of player character B. A calorie of any character other than player character B, such as enemy character A, will neither increase nor decrease, and falls within the range in which it can take not only a positive value but also a negative value. Of course, there is also a character having a calorie of “0”. The calorie of player character B thus increases and decreases, and the state of player character B is determined based on that calorie and a to-be-described player character state setting table (see FIG. 10). Additionally, the equipment with magic plate is information indicating a magic plate stored related to a character. Furthermore, the magic plate includes a plurality of types of magic plates, and a magic stone is set for each plurality of types of magic plates, whereby additional power data corresponding to the magic plate and the magic stone will be added to character data relating to a character equipped with the magic plate. Specifically, special magic can be used, MP consumption is reduced by half, or damage corresponding to an attack action is increased by half.

Action Table

Additionally, the aforementioned RAM 23 stores the game program read from inside the DVD-ROM 31 and data relating to an action of a character, which data is based on the memory card 32. An action table in which such data is stored will be described using FIG. 5. FIG. 5 is an illustration showing character data relating to characters: player character A and enemy character A, particularly, data relating to the actions of player character A and enemy character A. Player character A and enemy character A will be described hereafter, but the character data of another player character and another enemy character is also stored in the RAM 23.

The action table positioned in the RAM 23 is a table relating to an action of a character (including a player character and an enemy character). In this action table, the character is related to “action type” (including the action category) which can be executed by the character, “hit attribute” corresponding to the action type, “damage attribute”, and “basic value” corresponding to the action type. The action type includes various actions, such as “physical attack”, “attack magic”, “auxiliary magic”, “recovery magic”, and “item use”, as well as “damage” in response to a player character and “turn and damage” in response to an enemy character. The damage means that a player character or an enemy character is attacked, and the turn indicates that enemy character's turn has been executed. The basic value to be described later is thus set related to the damage, the turn, and the like. The hit attribute is information which is used to determine whether a hit is scored or not according to the position of an enemy character or the like targeted for an action (attack action) type of the hit attribute, specifically, such as “to whole area”, “to ground”, “to air”, and “to low altitude”. The details will be described using FIG. 13. The damage attribute is information which is used to determine a position of an action target, such as an enemy character, after an action based on an action (attack action) type of the damage attribute is performed. Specifically, the damage attribute includes “standard”, “hard hit”, “high angle”, “knockdown”, and the like. The details will be described using FIG. 14. The basic value is a basic value of an addition action value which is added to a special action value based on the type of an action executed. The addition action value is determined based on this basic value and a to-be-described addition action value calculation table (see FIG. 12), and the determined addition action value will be added to the special action value. That is, the addition action value is related to each character for each action of the character. Also, the addition action value is related to each character when the character suffers damage.

The CPU 21 will thus read from the RAM 23 a parameter relating to a character, such as the character's individual power (see FIGS. 3A and 3B), which is stored in the RAM 23. Also, the CPU 21, by fulfilling various conditions, updates the character data table (see FIG. 4) and the like based on the character's individual power and the like. Such a CPU 21 and RAM 23 correspond to one example of a character data storage module which stores a plurality of character data relating to a plurality of characters. Also, such a CPU 21 and RAM 23 will store a plurality of item data (character data) for each plurality of characters (including a player character and an enemy character).

Additionally, such a CPU 21 and RAM 23 correspond to one example of a player character data storage module which stores player character data relating to a player character. Particularly, the CPU 21 and RAM 23 store such character's individual power (see FIGS. 3A and 3B), character data table (see FIG. 4), action table (see FIG. 5), and the like, and will accordingly store player character state data (e.g., a calorie of player character B) relating to the state of a player character. Also, the CPU 21 which loads such character's individual power onto the RAM 23, as well as the RAM 23, corresponds to one example of an enemy character data storage module which stores enemy character data relating to an enemy character. Particularly, the CPU 21 which stores such a character data table (see FIG. 4) in the RAM 23 and updates the character data table, as well as the RAM 23, will store a calorie (one example of specific data) for each enemy character.

Grouping Table

Additionally, the aforementioned RAM 23 stores the game program read from inside the DVD-ROM 31 and data relating to grouping of player characters, which data is based on the memory card 32. A grouping table in which such data is stored will be described using FIG. 6. FIG. 6 is an illustration showing grouping of player characters. The data of player characters other than characters to be described hereafter may also be stored in the RAM 23.

The grouping table positioned in the RAM 23 is a table for storing a plurality of group patterns (corresponding to teams to be described later) which are used to classify characters into a battle group who participates in a battle and a standby group who does not participate in the battle. In this grouping table, the plurality of group patterns are related to the members in the battle group and the members in the standby group. The number of members in the battle group has a maximum limit, which is four for example. Also, array orders 1 to 4 are related to the members in the battle group. That is, a plurality of grouping patterns themselves, each for a plurality of characters, will be stored in the RAM 23.

As described later in detail, a group flag positioned in the RAM 23 can be changed in response to an operation of the input device 4. Based on the group flag and the grouping table, any grouping pattern is selected from a plurality of grouping patterns, such e.g. as group pattern A to group pattern C. Based on the selected grouping pattern, a plurality of characters will then be classified into the battle group and the standby group. Accordingly, any grouping pattern can be selected from the plurality of grouping patterns, which enables easy and smooth classification of groups in response to the power and state of a character, the progress of the game, and the like, so that the game can be enjoyed simply and strategically. The CPU 21 which stores such a grouping table in the RAM 23, as well as the RAM 23, corresponds to one example of a grouping pattern storage module which stores a plurality of grouping patterns each for a plurality of characters.

Display Item Setting Table

Additionally, the aforementioned RAM 23 stores the game program read from inside the DVD-ROM 31 and data relating to a display item in character data of a player character, which data is based on the memory card 32. A display item setting table in which such data is stored will be described using FIG. 7. FIG. 7 is an illustration showing the display item table.

The display item setting table positioned in the RAM 23 is a table which is used to determine an item to be displayed for each character when performing status display. In this display item setting table, a group is related to a display item. The group is divided into a battle group who participates in a battle and a standby group who does not participate in the battle. In a battle scene, action control is exerted without referring to various item data of a character belonging to the standby group, but by referring to various item data of a character belonging to the battle group. That is, action control of a character (first character) classified as the battle group (first group) will be exerted based on a larger number of pieces of item data than that of a character (second character) classified as the standby group (second group). Also, the display item is the type of various item data in character data stored for each character.

Specifically, a name, a level, maximum HP, HP, maximum MP, MP, the number of combo gauge stocks, and a level-up condition are related as the display items to the battle group, while a name, a level, HP, MP, and the number of combo gauge stocks are related as the display items to the standby group. The battle group thus has a larger number of display items than the standby group.

That is, a first display region 16a (see FIGS. 43A to 44B), which displays item data corresponding to a character classified as the battle group, and a second display region 16b (see FIGS. 43A to 44B), which displays item data corresponding to a character classified as the standby group, are made different in the number of pieces of item data. Particularly, the number of pieces of item data in the first display region is made larger than that in the second display region. Such a number of pieces of item data corresponding to a character classified as the battle group will thus be displayed in the first display region. In this way, based on a plurality of item data, the plurality of item data are displayed, for each plurality of characters, in a predetermined display region on the display 16.

As described above, the first display region, which displays item data corresponding to the first character classified as the first group, and the second display region, which displays item data corresponding to the second character classified as the second group, are made different in the number of pieces of item data. Accordingly, item data to be displayed can be made different according to the type, state, and the like of a character, such as according to whether the character is the first character or the second character, so that a plurality of item data can be displayed in a display mode in which a display region has been effectively utilized. Consequently, unnecessary item data which varies depending on the type and state of a character can be omitted, thus enabling display in a more easily viewable display mode.

Additionally, to exert action control of the first character based on a larger number of pieces of item data than that of the second character, item data corresponding to the first character is displayed in the first display region, with a larger number of pieces of item data than that in the second display region. Accordingly, a larger number of pieces of item data can be displayed for a character of which the action control is exerted based on a relatively large number of pieces of item data. Consequently, unnecessary item data which varies depending on the type and state of a character can be omitted, thus enabling display in a still more easily viewable display mode.

Magic Plate Setting Table

Additionally, the aforementioned RAM 23 stores the game program read from the DVD-ROM 31 and data relating to a magic plate capable of being set in response to a character, which data is based on the memory card 32. A magic plate setting table in which such data is stored will be described using FIG. 8. FIG. 8 is an illustration showing the magic plate setting table.

The magic plate setting table positioned in the RAM 23 is a table which is used to set a plurality of types of magic plates which are set in response to a character. In this magic plate setting table, “magic plate type” is related to “star region” (which shows a star in the figure), “shape type”, “attribute”, “size”, and “equipment with magic stone”. Particularly, a plurality of star regions are set in each plurality of types of magic plates, and the shape type, attribute, size, and equipment with magic stone are related to each of those star regions. The magic plates are each an item which is stored in response to a character to thereby determine additional power data to be added to character data relating to the character. As for equipment with this magic plate, character's equipment with the magic plate is set according to the aforementioned character data table (see FIG. 4). The plurality of star regions are regions which are set in each magic plate and in which magic stones for determining additional power data can be set.

The shape type of these star regions (regions) includes a circular shape which represents additional power data relating to an attack, a triangular shape which represents additional power data relating to auxiliary power, and a rhomboid shape which represents additional power data relating to recovery. The attribute of these star regions includes various attributes, for example, “ground attribute”, “water attribute”, and “fire attribute”. The size of these star regions includes sizes 1 to 4. Magic stones can be set in these star regions. These star regions are placed in a state capable of editing a magic plate, for example, at a magic plate arranging shop if a predetermined amount of money is possessed, wherein the shape type and size of those star regions can be changed. The equipment with magic stone functions as follows. That is, various magic stones to be described later are set in star regions, whereby additional power data corresponding to the various magic stones set will be set in character data relating to a character. Also, as described later in detail, these magic stones, by fulfilling a predetermined setting condition that they can be set in star regions of a magic plate, will be set in the magic plate. It is not until a magic plate is equipped with a magic stone and a character is equipped with the magic plate that additional power data corresponding to the magic stone will be added to character data relating to the character.

Magic Stone Setting Table

Additionally, the aforementioned RAM 23 stores the game program read from inside the DVD-ROM 31 and data relating to a magic stone capable of being set in response to a magic plate, which data is based on the memory card 32. A magic stone setting table in which such data is stored will be described using FIG. 9. FIG. 9 is an illustration showing the magic stone setting table.

The magic stone setting table positioned in the RAM 23 is a table having set therein data relating to a magic stone which can be set in a region of a magic plate and is used to determine additional power data. In this magic stone setting table, a magic stone is related to “shape type”, “attribute”, “size”, “level”, and “effect”. That is, the shape type, attribute, size, level, and effect are related to each plurality of types of magic stones.

Similar to the aforementioned regions, these magic stones have the shape type, attribute, size, and the like. The shape type of these magic stones, similar to that of the regions, includes a circular shape which represents additional power data relating to an attack, a triangular shape which represents additional power data relating to auxiliary power, and a rhomboid shape which represents additional power data relating to recovery. The attribute of those magic stones, similar to that of the regions, includes various attributes, for example, a ground attribute, a water attribute, and a fire attribute. The size of these magic stones, similar to that of the regions, includes sizes 1 to 4. The level indicates the levels of additional power data corresponding to these magic stones, and is related to the size of the magic stones. That is, additional power data, which is made relatively favorable pursuant to the size of a magic stone, is added to character data. The effect is the content of additional power data of a magic stone, including various additional power data with which, for example, attack magic A1 can be used, damage to be inflicted on an enemy character or the like is increased by 5%, recovery magic C1 can be used, and MP consumption by a player character is reduced to 50%.

These magic stones fulfill a predetermined setting condition that they can be set in star regions of a magic plate, whereby additional power data corresponding to a set magic stone will be added to character data relating to a character equipped with the magic plate. The predetermined setting condition can be set when a magic stone conforms in shape type to a star region of a magic plate and has a size equal to or smaller than that of a star region of the magic plate.

Additionally, as described above, a magic stone has the function of adding, to character data, additional power data which is made relatively favorable pursuant to the size of the magic stone. Consequently, a region of a magic plate can be edited so that more favorable additional power data is added to character data. In this case, the data relating to the magic plate will be stored in such a way as to change the shape type, attribute, size, and the like in the magic plate setting table. Also, the data relating to the magic plate will be stored in such a way that the magic stone is equipped to thereby change the equipment with magic stone in the magic plate setting table.

Furthermore, the CPU 21, which stores in the RAM 23 and updates such a character data table (see FIG. 4), magic plate setting table (see FIG. 8), magic stone setting table (see FIG. 9), and the like, and the RAM 23 correspond to one example of an additional power data storage module which stores additional power data (magic plate and magic stone) in order that the additional power data is added to character data. Particularly, such a CPU 21 and RAM 23 will store a plurality of types of additional power data classified by type. In other words, such a CPU 21 and RAM 23 will store a plurality of types of magic stones (power objects) which are classified by a shape corresponding to the type and are used to determine the power of a character. Also, in other words, such a CPU 21 and RAM 23 will store additional power data which corresponds to the size of a magic stone (power object) and is made relatively favorable for a character pursuant to the size of the magic stone. Furthermore, in other words, such a CPU 21 and RAM 23 stores additional power data for changing the increase/decrease ratio of character data to a character action mode.

Player Character State Setting Table

Additionally, the aforementioned RAM 23 stores the game program read from inside the DVD-ROM 31 and data relating to the state of a player character, which data is based on the memory card 32. A player character state setting table in which such data is stored will be described using FIG. 10. FIG. 10 is an illustration showing the player character state setting table.

The player character state setting table positioned in the RAM 23 is a table which is used to set (determine) a player character's state. In this player character state setting table, “player character's calorie” is related to “player character's state”. The player character's calorie is the calorie of player character B in the aforementioned character data table (see FIG. 4). Also, in the player character's state, “type” is related to “power”.

Specifically, when the player character's calorie is “−11” to “+11”, the player character's state becomes PINK BAT which is a standard power. When the player character's calorie is higher than “+11” and lower than “+100”, the player character's state becomes “glamour” which is a specialized power for a physical attack. When the player character's calorie is higher than “−100” and lower than “−11”, the player character's state becomes “slim” which is a specialized power for a magic attack. When the player character's calorie is equal to or higher than “+100”, the player character's state becomes “superglamour” having an improved power of “glamour”. When the player character's calorie is equal to or lower than “−100”, the player character's state becomes “superslim” having an improved power of “slim”. In the cases of these “superglamour” and “superslim”, unlike the cases of “pink bat”, “glamour”, and “slim”, the power is especially increased. Specifically, in the case of “superglamour”, damage by the physical attack is increased by 150% as compared with the case of “glamour”, while, in the case of “superslim”, damage by the magic attack is increased by 150% as compared with the case of “slim”. In this way, the states of these “superglamour” and “superslim” are a relatively favorable specific state, and on condition that the calorie (player character state data) has reached a predetermined value (e.g., +100 or −100), the state of a player character is changed to the state of “superglamour” or “superslim” which is relatively favorable for the player character. Accordingly, by setting the player character state data to the predetermined value, a player can purposefully change the player character's state to a relatively favorable specific state, and the player can change the player character state data to the initial value. This can therefore harmonize a change to the specific state with a limitation on the specific state, thus making it possible to provide a strategic game.

Special Action Table

Additionally, the aforementioned RAM 23 stores the game program read from inside the DVD-ROM 31 and data relating to a special action to be performed by a character, which data is based on the memory card 32. A special action table in which such data is stored will be described using FIG. 11. FIG. 11 is an illustration showing the special action table.

The special action table positioned in the RAM 23 is a table relating to the special action. In this special action table, “action type” is related to “special action consumption value”. For the purpose of facilitating understanding the invention, FIG. 11 shows an explanation corresponding to this action type. The special action consumption value is a special action value which is consumed by performing that action type, and in the case of a character whose special action value is less than the special action consumption value, selection of an action type corresponding to this special action consumption value is limited.

Specifically, when the attack type is a hard hit attack, “50” is determined as the special action consumption value. In the case of this hard hit attack, the attack has scored a hit, whereby the special action value of a character targeted for an attack action is reduced by “100”.

When the attack type is a combo attack, “100” is determined as the special action consumption value. In the case of this combo attack, an attack (action) is possible in relation to a character action to be performed in a subsequent turn. That is, in the combo attack, a plurality of actions can be executed by a plurality of characters.

When the attack type is a double attack, “100” is determined as the special action consumption value. In the case of this double attack, an attack (action) is possible with a plurality of actions combined. That is, in the double attack, a plurality of actions can be executed by one character.

When the attack type is a double combo attack, “200” is determined as the special action consumption value. In the case of this double combo attack, an attack (action) is possible with a plurality of actions combined and in relation to a character action to be performed in a subsequent turn. That is, in the double combo attack, a plurality of actions can be executed by one character, and a plurality of actions can be executed by a plurality of characters.

In this embodiment, in the hard hit attack, combo attack, double attack, and double combo attack, the special action value is subtracted, but the invention is not limited to this configuration. For example, the configuration may include collaborative magic which only the last character (fourth character) in “combo” can execute on condition that the special action value is a specific value (e.g., 200).

Addition Action Value Calculation Table

Additionally, the aforementioned RAM 23 stores the game program read from inside the DVD-ROM 31 and data relating to calculation of an addition action value corresponding to a character, which data is based on the memory card 32. An addition action value calculation table in which such data is stored will be described using FIG. 12. FIG. 12 is an illustration showing the addition action value calculation table.

The addition action value calculation table positioned in the RAM 23 is a table which is used to calculate an addition action value. This addition action value is a value which is used to add a special action value. This special action value is a value which is used to execute a special action such as “combo”, “double”, and “double combo”, and is set for each player character and enemy character so as to be changeable.

In this addition action value calculation table, “addition condition” and “coefficient/points” are stored related to each other. The addition condition is a condition to add the special action value of a player character or an enemy character who has performed an action, and of a player character or an enemy character who has suffered an attack action. The coefficient and points are numerical values which are used to calculate the addition action value, and will be added to and multiplied by a basic value corresponding to each aforementioned action.

Specifically, in the case of the addition condition relating to HP, when current HP, which corresponds to a character (including a player character and an enemy character) who has performed an action or a character (including a player character and an enemy character) who has suffered an attack action, is ⅕ or more of an HP maximum (which is indicated by HPMAX in the figure), an HP coefficient is “1.0”. And, when the current HP is smaller than ⅕, the HP coefficient is “2.0”. As described later in detail, for a character having small current HP, a greater addition action value is calculated and will be added as the special action value. This enables selection of a strategic action mode in which HP is prevented from frequent recovery, thus making it possible to increase player's interest in the game.

In the case of the addition condition relating to SP, when current SP, which corresponds to a character (including a player character) who has performed an action or a character (including a player character) who has suffered an attack action, is “5” or larger, or ¼ or more of an SP maximum (which is indicated by SPMAX in the figure), an SP coefficient is “1.0”. And, when the current HP is smaller than “5” and less than ¼ of the SP maximum (which is indicated by SPMAX in the figure), the SP coefficient is “2.0”. As described later in detail, for a character having small current SP, a greater addition action value is calculated and will be added as the special action value. This enables selection of a strategic action mode in which SP is prevented from frequent recovery, thus making it possible to increase player's interest in the game.

In the case of the addition condition relating to the special action value, when a current special action value, which corresponds to a character (including a player character) who has performed an action or a character (including a player character) who has suffered an attack action, is “0” to “100”, a special action value coefficient is “1.0”. And, when the current special action value is greater than “100” and smaller than “200”, the special action value coefficient is “0.6”. For example, when the current special action value is “99”, the special action value coefficient becomes “1.0” before “100” is reached, and becomes “0.6” after “100” is reached. As described later in detail, for a character having a small current special action value, a greater addition action value is calculated and will be added as the special action value. This can avoid the state in which the special action value is extremely small and the state in which the special action value is extremely large, thus making it possible to increase player's interest in the game.

In the case of the addition condition relating to the number of collaborative hits, in the event that a character (including a player character) has performed an attack action, when the number of collaborative hits, which is obtained by performing continuous attack actions in “combo” and “double combo” before the character performs the attack action, is “0” to “9”, a number-of-collaborative-hits coefficient is “1.0”. When the number of collaborative hits is “10” to “19”, the number-of-collaborative-hits coefficient is “1.25”. And, when the number of collaborative hits is “20” or larger, the number-of-collaborative-hits coefficient is “1.5”. For example, when two characters, prior to a character who performs an attack action, have performed 18 hits of attack actions (“combo”, “double combo”, and the like) during “combo”, a number-of-collaborative-hits coefficient for the character who currently performs the attack action is “1.25”. And, when the attack action has scored 4 hits and “combo” is ongoing, the number of collaborative hits during “combo” is 22 hits, and a number-of-collaborative-hits coefficient for the next character is “1.5”. As described later in detail, for a character having a large number of collaborative hits, a greater addition action value is calculated and will be added as a special action value. This enables selection of a strategic action mode in which the number of collaborative hits is increased, thus making it possible to increase player's interest in the game. Also, the addition action value may be changed using the information of compatibility between characters who have performed “combo” or “double combo”.

In the case of the addition condition relating to an attack attribute, when a character (including a player character) has performed an attack action, the attack action of the character conforms to the attack attribute of a character who suffers the attack action, an attack attribute coefficient is “1.5”. And, when there is no conformation therebetween, the attack attribute coefficient is “1.0”. As described later in detail, for characters whose attack attributes conform to each other, a greater addition action value is calculated and will be added as a special action value. This enables the addition action value to be increased and reduced based on an attribute corresponding to an enemy character, and a strategic game is provided, thereby making it possible to increase player's interest in the game. In this embodiment, when a player character's own attack attribute conforms to the attribute of a character who suffers an attack, the attack attribute coefficient is increased, but the invention is not limited to this configuration. For example, the configuration may be such that, when a weakness attribute of a character who suffers an attack conforms to the player character's own attack attribute, the attack attribute coefficient is increased, while, when a tolerance attribute of a character who suffers an attack conforms to the player character's own attack attribute, the attack attribute coefficient is reduced.

In the case of the addition condition relating to a hit mode, in the event that a character (including a player character) has performed actions, when the character has scored a hit in every action performed (all hits), hit mode points are “+1.0”. When the character has missed in one action (one miss) out of all performable actions, the hit mode points are “−0.5”. When the character has missed in two actions (two misses), the hit mode points are “−1.0”. And, when the character has missed in three actions or more (three misses or more), the hit mode points are “−2.0”. For example, in the case of the action order of a character capable of four actions, when the character has missed in a first action (missed in a first timing area) in response to a first action operation, and when the character has not been involved in second to fourth action operations and has thus missed second to fourth actions, then the result is four misses, which will be determined to be three misses or more. As described later in detail, for a character of the hit mode with a small number of misses, a greater addition action value is calculated and will be added as a special action value. This makes the player conscious of taking a risk involving misses, which enables selection of a strategic action mode intended to reduce the risk, and enhances the enjoyment of scoring all hits, thus making it possible to increase player's interest in the game.

The addition action values are calculated based on the coefficients and points determined in accordance with such addition conditions and based on the basic values corresponding to the aforementioned actions. Specifically, the addition action value of a player character who has executed an attack action is calculated by the expression of (basic value×HP coefficient×SP coefficient×special action value coefficient×number-of-collaborative-hits coefficient×attack attribute coefficient×number of hits in currently performed attack action)+hit mode points. The addition action value of a player character who has suffered an attack action is calculated by the expression of basic value×HP coefficient×SP coefficient×special action value coefficient×number of hits in currently suffered attack action. The addition action value of an enemy character who has executed an attack action is calculated by the expression of basic value (turn)×HP coefficient×special action value coefficient. The addition action value of an enemy character who has suffered an attack action is calculated by the expression of basic value (damage)×HP coefficient×special action value coefficient. In this embodiment, the addition action value is changed in accordance with the aforementioned addition conditions, but the invention is not limited to this configuration. The addition action value may be changed in accordance with any other condition and any other situation.

Hit Attribute Table

Additionally, the aforementioned RAM 23 stores the game program read from inside the DVD-ROM 31 and data relating to a hit attribute corresponding to the action type of a character, which data is based on the memory card 32. A hit attribute table in which such data is stored will be described using FIG. 13. FIG. 13 is an illustration showing the hit attribute table.

The hit attribute table positioned in the RAM 23 is a table which is used to determine whether an action corresponding to an action type is executable or not. The hit attribute is determined as to whether it is executable or not, according to the position of a character targeted for an action (targeted for an attack action) (e.g., an enemy character). In the hit attribute table, “hit attribute” is related to “hit condition”.

Specifically, when the hit attribute is “to whole area”, “possibility of hit in all positions” is related thereto. When the hit attribute is “to ground”, “possibility of hit in ground position” and “no hit in to-air position” are related thereto. When the hit attribute is “to air”, “no hit in ground position” and “possibility of hit in to-air position” are related thereto. When the hit attribute is “to low altitude”, “possibility of hit in ground position and in to-air position at height level of up to +1” and “no hit in to-air position at height level of +2 or more” are related thereto. In this way, the action type cannot be selected in some cases depending on the position of a character targeted for an action. In this embodiment, the action type cannot be selected depending on the position of a character, but the invention is not limited to this configuration. For example, the configuration may be such that the action type can be selected but an actual action will not be successful.

Damage Attribute Table

Additionally, the aforementioned RAM 23 stores the game program read from inside the DVD-ROM 31 and data relating to a damage attribute corresponding to an action type of a character, which data is based on the memory card 32. A damage attribute table in which such data is stored will be described using FIG. 14. FIG. 14 is an illustration showing the damage attribute table.

The damage attribute table positioned in the RAM 23 is a table which is used, after an action corresponding to the action type, to determine the state (position and the like) of a character targeted for the action. In the damage attribute table, “damage attribute” is related to “effect”.

Specifically, when the damage attribute is “standard”, “current height level is maintained” is related thereto. When the damage attribute is “hard hit”, “combo ends unconditionally”, “there is additional damage”, “special action value of character performing attack action is −50”, “special action value of character targeted for attack action is −100”, and “height level decreases to ‘0’” are related thereto. When the damage attribute is “high angle”, “placed in to-air position (height level of +1)” is related thereto. When the damage attribute is “knockdown”, “placed in ground position (“0” at current height level of +1 or more)” is related thereto. In this way, the state of a character targeted for an action can be made to differ from one action type to another.

Display Screen

Next, a specific example of a display screen which is displayed on the display 16 in accordance with a game content which is executed by the CPU 21 based on the game program recording in the DVD-ROM 31 will be described using FIGS. 26A to 49B.

When the DVD-ROM 31 is mounted on the DVD-ROM drive 29 and the apparatus body 1 is powered on, an “opening demonstration” is displayed on the display 16. The “opening demonstration” is an effect display announcing the start of the game. After this “opening demonstration” is displayed for a predetermined time period, as shown in FIG. 26A, a “title screen” with a large game title described thereon is displayed.

At this point, specifically, the letters of the game title of SHADOW HEARTS are displayed, and two selection items (NEW GAME and CONTINUE) are displayed therebelow. Also, a cursor 41 is displayed on the left of any one of the selection items NEW GAME and CONTINUE, and the cursor 41 switches from one position to the other as the player operates the up button 7 or the down button 8. When the player operates the “circle” button 12, the selection item indicated by the cursor 41 is selected.

When NEW GAME is selected on the “title screen”, a prologue and a game content are displayed, and thereafter, as shown in FIG. 26B, a “world map” is displayed. In contrast, when CONTINUE is selected on the “title screen”, the prologue or the game content is not displayed, but the “world map” is displayed based on data saved at the end of the previous game.

Specifically, displayed on this “world map” are major cities of “county A”, in which a game story is placed are displayed, and selection items indicated by five city names (“city A” 42a, “city B” 42b, “city C” 42c, “city D” 42d, and “city E” 42e). These are the selection items which are used to make the transition to previously prepared “sub-maps”. The cursor 41 indicating each selection item is moved by a player's operation of the up button 7 or the down button 8, and one item selection is selected by a player's operation of the “circle” button 12. When a “sub-map” is thus selected, the transition is made to a screen per each of the “sub-maps”, and various games set in response to the “sub-map” are ready to be performed. Specifically, the configuration is such that a background showing the inside of each city is prerender-displayed as a background image in response to the development of a scene, and such that a story progresses as player characters conquer various events while moving through the background.

Additionally, when, on this “world map”, the “square” button 14 is operated by the player, a “menu screen” is displayed, and on the “menu screen”, the player can perform various settings and the like. Also, when a city is selected with the “world map” displayed, the start screen of a “sub-map” corresponding to the city is displayed. Actions, such as player character's walking, talking to a passer-by, and doing shopping, are possible on this “sub-map”.

In the game of this embodiment, there appear a player character who acts based on an operation of the player and an enemy character who acts based on only the game program, and the game which develops centering on the battle between these two characters is actualized on the display 16. Also, in this embodiment, as the player character, four player characters A111, B112, C113, and D114 (see FIG. 27A for these player characters) appear, and the game is adapted for an action in a party formed by these four characters. Furthermore, various statuses are preset for each character. Set as these statuses are an experience value, which is added according to the number of games, the number of enemy characters defeated, and the like, money in hand, a weapon, power, and the like.

Display of Battle Scene

When the party of player characters, who has started an action on the “sub-map”, thereafter encounters an enemy character, as shown in FIG. 27A, a battle with enemy characters is started. In this case, for example, the battle with three enemy characters a115, b116, and c117 is started.

In such a battle screen, an action order of all the characters (including player characters and enemy characters) is determined, and in accordance with the action order, an action will be selected and controlled.

Specifically, as shown in FIG. 27A, the battle between player characters A111, B112, C113, and D114 and enemy characters a115, b116, and c117 is started. Also, in the upper portion of the screen, as shown in FIG. 27A, an estimated action order image 118 will be displayed. Furthermore, an action character image 119 showing the characters placed in the action order will be displayed.

When player character A111 then becomes an action character in accordance with the action order, as shown in FIG. 27B, an action selection screen is displayed, and based on an operation of the input device 4, an action type of player character A111, such as an attack, is selected.

On this action selection screen are displayed: a command menu 44 which is used to input a collaborative type command for selecting any of a normal attack, a combo attack, a double attack, a double combo attack, and the like, and an attack type command in the collaborative type; a cursor for selecting the command; the names of player characters; a player character status 46 showing HP, MP, SP, and the like; the action order image 118 showing the order in which the actions of the player characters and enemy characters are executed; the action character image 119 showing the characters placed in the action order; and the like.

Particularly, a special action value gauge showing a special action value is displayed below the player character status 46. This special action gauge is set to have an upper limit of “100”. Also, numerical numbers (the number of stocks) displayed encircled on the right side of the player character status 46 are information relating to the special action values. When the special action value has reached “100”, “1” is added, and the special action value gauge displays “0”. The special action value is set to have an upper limit of “200”. The combo attack, double attack, double combo attack, or the like can be selected depending on this special action value.

An action type in the normal attack is then selected, and as shown in FIG. 28A, an action target selection screen is displayed to select an action target of player character A111 in the action type. As shown in FIG. 28B, a judgment ring screen is then displayed, wherein a judgment ring 100 and a rotary bar 101 are displayed, and the feasibility, effect, and the like of an action are determined based on an operation of the input device 4. The judgment ring will be described later in detail using FIGS. 19 to 21B, etc.

As shown in FIGS. 29A and 29B, an action effect screen of player character A111 will then be displayed based on the type, target, feasibility, effect, and the like of the action of player character A111 which have been selected and determined based on an operation of the input device 4.

Display of Combo

Particularly, on the aforementioned action selection screen, when the combo attack has been selected as shown in FIG. 30A and an action target has been selected as described above, then as shown in FIG. 30B, it becomes possible to select, in response to an operation of the input device 4, whether or not to use a shortcut function. As described later in detail, this shortcut function is a function improved in the operability in executing “combo”. When nonuse of the shortcut function has been selected on a shortcut function selection screen, similar to the aforementioned normal attack, as shown in FIG. 31A, the judgment ring screen is displayed, wherein the judgment ring 100 and the rotary bar 101 are displayed, and the feasibility, effect, and the like of the action are determined based on an operation of the input device 4. When a hit has been scored in every timing area in this case, as shown in FIG. 31B, a combo ring 105 is displayed in a rotating fashion. In this combo ring 105, an operation button image 106 showing an operation button is depicted in and out of sight on one side of the combo ring displayed in a rotating fashion. Whether “combo” has been established or not is determined according to whether or not the same button as an operation button image 106 depicted within a predetermined time period has been operated in response to an operational signal from the input device 4.

When “combo” has not been established, the result is a combo break, which enables execution of the action of a character (including a player character and an enemy character) who is next in the action order. Conversely, when “combo” has been established, as shown in FIG. 32A, a combo character selection screen on which to select a character who takes over “combo” next is displayed. When the character has been selected, as shown in FIG. 32B, the action selection screen of the selected character is displayed. When nonuse of the shortcut function has thus been selected as shown in FIGS. 30A to 32B, the special action value increases, wherein a hit is scored in every timing area of the judgment ring 100, and success in the combo ring is achieved, whereby the actions of a plurality of player characters can be executed in relation to each other regardless of the action order.

Conversely, when use of the shortcut function has been selected as shown in FIG. 33A, then as shown in FIG. 33B, first, the combo character selection screen, on which to select a character who takes over “combo” next, is displayed instead of proceeding to display of the judgment ring, display of the combo ring, or the like. When the character has then been selected, the action selection screen of the selected character is displayed, and as shown in FIG. 34A, a screen on which to select whether this is the end of “combo” or not is displayed. When, in this case, it has been selected that this is the end of “combo”, “combo” by these two characters will be executed. Conversely, when it has been selected that this is not the end of “combo”, as shown in FIG. 34B, the combo character selection screen, on which to select a character who takes over “combo” next, is displayed. When the character has then been selected, the action selection screen of the selected character is displayed, and as shown in FIG. 35A, a screen on which to select whether this is the end of “combo” or not is displayed. When, in this case, it has been selected that this is the end of “combo”, “combo” by these three characters will be executed. Conversely, when it has been selected that this is not the end of “combo”, the combo character selection screen, on which to select a character who takes over “combo” next, is displayed. When the character has been selected, the action selection screen of the selected character is displayed, and as shown in FIG. 35B, the screen on which to select whether this is the end of “combo” or not is displayed. When, in this case, it has been selected that this is the end of “combo”, “combo” by these four characters will be executed.

To thus use the shortcut function, for example, in the case of performing a combo attack by four characters, as shown in FIG. 36A, the judgment ring 100 is displayed. The number of timing areas of this judgment ring 100 is equal to the number of characters who perform the combo attack. Specifically, when “combo” (shortcut) by four characters has been selected, four timing areas are set. These four timing areas correspond to the feasibilities of actions of the characters, wherein the feasibilities of the first, second, third, and fourth characters are determined in the first, second, third, and fourth timing areas, respectively. Consequently, when success has been achieved in the first timing area, but success has not been achieved in the second timing area, the combo attacks by the third and subsequent characters are not executed and are controlled as not having existed. For example, when success has been achieved in up to four timing areas, as shown in FIG. 36B, the attack action by the first character is executed. Subsequently, as shown in FIG. 37A, the attack action by the second character and the attack action by the third character will be executed, and as shown in FIG. 37B, the attack action by the fourth character will then be executed.

Display of Double and Double Combo

Additionally, on the aforementioned action selection screen, when the double attack has been selected as shown in FIG. 38A, and when the double combo attack has been selected as shown in FIG. 38B, it becomes possible to select a plurality of types of (e.g., two) actions to be performed by the character. When a plurality of kinds of action types have thus been selected, and action targets corresponding to those action types have been selected, as shown in FIG. 39, the judgment ring 100 is displayed. Based on the result thereof, as shown in FIGS. 40A and 40B, the double attack, in which a plurality of types of actions are executed by one character, will be executed. In these double attack and double combo attack, a plurality of judgment rings corresponding to a plurality of action types are combined, and as shown in FIG. 39, one judgment ring will be displayed. In the double combo attack, there is no such shortcut function as described above, and similar to FIGS. 31A to 32B, the judgment ring and combo ring are displayed, based on the result of which it will be determined whether “combo” has been established or not.

In this way, the result and progress of a plurality of actions, which are based on a plurality of action types selected based on an operational signal, is determined, based on the operational signal, by the determination mode of the result and progress of a smaller number of actions than the number of the plurality of actions. And, a plurality of action controls based on the determined result and progress of the plurality of actions are executed in accordance with the action order of a plurality of characters. Accordingly, the result and progress of the plurality of actions can be determined by a determination mode corresponding to at least any of the plurality of action types and by a smaller number of times than the number of times the plurality of action types have been selected. This can simplify an intricate determination mode and furthermore enables smooth execution of action progress, which can prevent player's interest in the game from decreasing.

Display of Energy Drain

Additionally, among such action types as described above, there is a player character who can change the state by sucking blood (“draining energy”) from an enemy character. Specifically, player character B112 will hereafter be described as a character capable of the “energy draining”.

As shown in FIG. 41A, player character B112 is a pink bat (“pink bat”) at normal times. As shown in FIG. 41B, this player character B112 can execute the energy draining“with respect to the enemy character. In this case, player character B112 deprives the enemy character of its preset calorie and owns the calorie. As a result thereof, as shown in FIG. 41B, player character B112 has a calorie of +20. Depending on how many calories this player character B112 has, player character B112 is changed to various states, such as a slim state full of magic power as shown in FIG. 42A and a glamour state full of physical attack power as shown in FIG. 42B.

On condition that the action mode of a player character against an enemy character has thus been selected based on an operational signal from the operating device, specific data corresponding to the enemy character is added to player character state data, and the state of the player character is changed based on the result obtained by the addition. Accordingly, by making it a condition that the action mode of the player character against the enemy character has been selected based on the operational signal from the operating device, the player can purposefully perform the addition of player character state data in response to the action mode against the enemy character. Furthermore, since specific data corresponding to an enemy character targeted for the action mode is added, for example, specific data which differs according to the type of the enemy character will be added. Consequently, it is possible to arbitrarily and easily change the state of a player character while executing an action against an enemy character.

Status Display

Additionally, when a menu is displayed in other than the battle scene, as shown in FIG. 43A, the status of a player character is displayed. In such a status display, the status can be divided into a battle group who participates in the battle scene and a standby group who does not participate in the battle scene. The status of a battle group character classified as the battle group is displayed in a first display region 16a, and the status of a standby group character classified as the standby group is displayed in a second display region 16b. Also, item data corresponding to each player character differs between the first display region 16a and the second display region 16b, and more item data is displayed in the status of the battle group character than the status of the standby group character.

Specifically, for a character classified as the battle group, displayed as its display items are “name”, “level”, “maximum HP”, “HP”, “maximum MP”, “number of combo gauge stocks”, and “level-up condition”. For a character classified as the standby group, displayed as its display items are “name”, “HP”, “MP”, and “number of combo gauge stocks”. In this way, the number of display items of the battle group is larger than the number of display items of the standby group.

The number of pieces of item data is thus made different between the first display region, which displays item data corresponding to a first character classified as a first group, and the second display region, which displays item data corresponding to a second character classified as a second group. Accordingly, item data to be displayed can be made different according to the type, state, or the like of a character, such as according to whether the character is the first character or the second character, so that a plurality of item data can be displayed in a display mode in which a display region has been effectively utilized. Consequently, unnecessary item data which varies depending on the type and state of a character can be omitted, thus enabling display in a more easily viewable display mode.

Also, to exert action control of the first character based on a larger number of pieces of item data than that of the second character, the item data corresponding to the first character is displayed in the First display region, with a larger number of pieces of item data than that in the second display region. Accordingly, a larger number of pieces of item data can be displayed for a character of which the action control is exerted based on a relatively large number of pieces of item data. Consequently, unnecessary item data which varies depending on the type and state of a character can be omitted, thus enabling display in a still more easily viewable display mode.

Furthermore, in these battle groups, their settings can be changed in response to an operation of the input device 4, and in the battle group shown in FIG. 43A, the battle group shown in FIG. 43B, and the like, various grouping is possible. Particularly, as shown in FIGS. 43B, 44A, and 44B, battle groups corresponding to team C, team B, and team A will be stored, respectively. Classification into the battle group and the standby group will then be performed by selecting any of the plurality of teams in response to an operation of the input device 4. That is, based on an operational signal from the input device 4, any grouping pattern will be selected from a plurality of grouping patterns, and based on the selected grouping pattern, a plurality of characters will be classified into the battle group (first group) and the standby group (second group).

In this way, a plurality of grouping patterns each for a plurality of characters are stored, and any grouping pattern is selected from the plurality of grouping patterns. Based on the selected grouping pattern, the plurality of characters are then classified into the first group and the second group. Accordingly, any grouping pattern can be selected from the plurality of grouping patterns, which enables easy and smooth classification of groups in response to the power and state of a character, the progress of the game, and the like, so that the game can be enjoyed simply and strategically.

Magic Plate and Magic Stone Setting Display

Additionally, when a magic system has been selected during a menu display, as shown in FIGS. 45A and 45B, a screen relating to various magic plates to be set on character A is displayed. Magic stones can be set on such respective magic plates. As shown in FIGS. 45A and 45B, a constellation image 47 showing a constellation is displayed on each magic plate. Star regions having a plurality of kinds of shape types, such as circular, triangular, and rhomboid shapes, are displayed on this constellation image 47. Also, a level and a region of a size corresponding to the level are set in each of these star regions. Furthermore, an attribute such as fire or water is set in each of these star regions. Additionally, as shown in FIGS. 47A and 48A, a cursor 48 is moved, in response to an operation of the input device 4, to display a region information image 49, such as the shape type, size, attribute, and the like of a star region designated by the cursor 48. Magic stones can be attached to these star regions by an operation of the input device 4. That is, these plurality of types of magic plates correspond to one example of a plurality of types of additional power data determination modules which are different in at least any of the number, shape size, and shape type of star regions (regions).

One magic plate can be set for one character. Consequently, as shown in FIG. 46A, in response to an operation of the input device 4, any of these plurality of types of magic plates is related to the character. Specifically, as shown in FIG. 46A, the magic plate of Capricorn has been set for character A111, but in an operation of the input device 4, as shown in FIG. 46B, the magic plate of Taurus is set instead. That is, any of the plurality of types of magic plates, which act as the plurality of types of additional power data determination modules, will be selected and set related to the character.

Furthermore, magic stones can be set in the regions of these plurality of types of magic plates. These magic stones are power objects which are used to determine additional power data to be added to character data. Similar to the star regions of the magic plates, the magic stones have a shape type such as circular, triangular, and rhomboid shapes, a size corresponding to a level, an attribute such as fire and water, and the like, and as shown in FIGS. 47A and 48A, a magic stone shape image 50 showing each of them is displayed.

Specifically, there are various magic stones, such as a magic stone called Red Cradle which has a triangular shape, a fire attribute, and a level (size) of 3 as shown in FIG. 47A, and a magic stone called Red Blaze which has a triangular shape, a fire attribute, and a level (size) of 2 as shown in FIG. 48A.

The magic stones can be set in star regions which are of the same shape type and size as or of larger size than that of the magic stones. As one specific example, a magic stone having a triangular shape and a size of 3 or smaller (1, 2, or 3) can be set in a star region having a triangular shape and a size of 3. That is, when a star region designated by the cursor 48 has a triangular shape and a size of 3 as shown in FIG. 47A, in response to an operation of the input device 4, the aforementioned magic stone called Red Cradle having a level of 3 can be set in the star region as shown in FIG. 47B, and the aforementioned magic stone called Red Blaze having a level of 2 can be set in the star region as shown in FIG. 48B. When a magic stone has been set in a region, the thus set magic stone shape image 50 is displayed in place of the region information image 49.

The larger the size of such a magic stone is, a result corresponding to an action becomes relatively favorable. Specifically, as shown in FIG. 47B, when the magic stone called Red Cradle having a size of 3 has been set, damage corresponding to an attack action increases by 20%, and MP consumption is reduced to ¼. As shown in FIG. 48B, when the aforementioned magic stone called Red Blaze having a level of 2 has been set, damage corresponding to an attack action increases by 10%, and MP consumption is reduced to ⅕. That is, additional power data for changing the increase/decrease ratio of character data to a character action mode is stored related to a region, and on condition that a power object of the character has been set in the region, additional power data corresponding to the region is determined as addition power data to be added to the character data. Accordingly, the increase/decrease ratio of character data to a character action mode can be changed by setting additional power data for changing the increase/decrease ratio of character data to a character action mode, so that additional power data of a character can be diversified, thus making it possible to increase player's interest in the game. In this embodiment, additional power data (e.g., an increase by 20% in damage corresponding to an attack action and a reduction to ¼ in MP consumption, and an increase by 10% in damage corresponding to an attack action and a reduction to ⅕ in MP consumption) is related to a magic stone itself, and when the magic stone has been set in a star region of a magic plate, additional power data corresponding to the magic stone is added to character data relating to a character equipped with the magic plate. However, the invention is not limited to this configuration. The configuration may be such that addition power data is related to a star region itself of a magic plate and is added to character data by setting a magic stone in the star region. Of course, the configuration may be such that additional power data is related to a magic stone itself and also related to a star region itself of a magic plate.

In this way, control is exerted to display a region of a shape, which corresponds to the type of additional power data, and the shape of a power object, and on condition that a power object corresponding to the shape of the region has been set in the region, additional power data corresponding to the type of the power object is determined as additional power data to be added to character data. Accordingly, the shape of the region is related to the shape of the power object, thereby determining additional power data corresponding to the power object, so that any player can easily recognize the relation and can easily customize a player character, thus making it possible to increase player's interest in the game.

There are provided a plurality of types of additional power data which are different in at least any of the number, shape size, and shape type of regions, and any of them are set related to a character. Also, based on character data and additional power data relating to the set character, power of the character is set. Accordingly, the additional power data of the additional power data determination module can be customized for each character, so that additional power data of a character can be diversified, thus making it possible to increase player's interest in the game.

Such a region is placed in the state where a magic plate can be edited, if a predetermined amount of money is possessed, at a magic plate arranging shop, wherein the shape type, size, attribute, and the like of the magic plate can be changed. Accordingly, since additional power data is made relatively favorable for a character pursuant to the size of a power object, a more favorable power object can be set by changing the size of a region, so that a player character can be customized, thus making it possible to increase player's interest in the game. Also, since additional power data is determined in response to the size of a power object corresponding to the region, any player can easily recognize the size of the power object and can easily customize a player character, thus making it possible to increase player's interest in the game. Furthermore, the type of additional power data can easily be changed, thus making it possible to increase player's interest in the game.

Additionally, by selecting “all reset”, as shown in FIG. 49A, a selection screen is displayed as to whether all settings of a magic plate and magic stones are reset or not. When YES has been selected on the screen, as shown in FIG. 49B, all the settings of the magic plate and magic stones are reset.

Operation of Gaming Apparatus

Various processes to be executed in the aforementioned configurations will hereafter be described using FIGS. 50 to 74.

Main Game Process

As described above, when the DVD-ROM 31 is mounted on the DVD-ROM drive 29 with the apparatus body 1 powered ON, the “opening demonstration” is displayed on the display 16, and a main game process, such as shown in FIG. 50, will be executed.

First, as shown in FIG. 50, it is determined whether or not NEW GAME out of the two selection items has been selected on a “title screen” such as shown in FIG. 26A (ST1). If the determination is YES, a prologue and a game content are displayed (ST2). If NO, i.e., if it is determined that CONTINUE has been selected on the “title screen”, the prologue or the game content is not displayed, but data saved at the end of the previous game is set (ST3).

Next, the “world map” shown in FIG. 26B is displayed (ST4). It is then determined whether any of the selection items displayed on the “world map” has been selected or not (ST5). If the determination is YES, the start screen of a “sub-map” responding to the selection, and a party of player characters starts an action on the “sub-map” (ST6). Conversely, if the determination in ST5 is NO, the “square” button 14 is operated on the “world map” to determine whether or not there is a display request for the “menu screen” (ST20). If the determination is YES, the “menu screen” is displayed, and various setting processes responding to player's operations are performed (ST21). Thereafter, the process moves to ST5. As described later in detail, such various setting processes include a magic plate setting process shown in FIG. 70, a magic plate editing process shown in FIG. 71, a grouping process shown in FIG. 72, a group selection process shown in FIG. 73, a status display control process shown in FIG. 74, and the like. Conversely, if the determination is NO, the process moves to ST5 again. As used herein, the term action on the “sub-map” refers to an action, such as a player character's walking, talking to a passer-by, and doing shopping. Also, even on this “sub-map”, the “menu screen” can be displayed by an operation of the “square” button 14, thus enabling various operations (enabling execution of various setting processes such as described above). For example, by selecting a “gear” command, a gear command process is executed to enable recovery of player character's power, and by selecting a “trading” command, a trading process is executed to enable trading of an item which can be possessed.

Subsequently, it is determined whether or not the party of player characters who has started the action on the “sub-map” has encountered an enemy character (ST7). If the determination is YES, a “battle process” is started. When the “battle process” is started, the process moves to a “battle scene” in which a battle is performed between the party of player characters and the enemy character. This “battle process” will be described later using FIG. 51. Conversely, if the determination in ST7 is NO, it is determined whether any event has occurred or not (ST9). If the determination is YES, the process moves to ST16, and if NO, the process moves to ST6 again.

The CPU 21 which executes the battle process will, in accordance with the determined action order of a plurality of characters, carry out determination of an action result and progress, and character action control. In other words, the CPU 21 will, in accordance with the determined action order of the plurality of characters, carry out selection of a character action mode and character action control. Also, when “combo” (character action connection mode), “double” (character combined action mode), “double combo” (character combined action connection mode), or the like has been selected as an action mode of a character, such a CPU 21 will, before selection of the next action mode of the character, carry out the character action control based on the “combo” (character action connection mode), “double” (character combined action mode), “double combo” (character combined action connection mode), or the like. The CPU 21 which executes such a process corresponds to one example of a special character action control section.

Subsequently, it is determined whether or not, in the “battle scene” executed by the “battle process”, the party of play characters has succeeded in escaping from the enemy character (ST10). If the determination is YES, the process moves to ST16. Conversely, if the party of characters has failed in escaping from the enemy character, or if the party of characters has battled with the enemy character, it is determined whether or not, in the “battle scene”, the party of play characters has won the battle against the enemy character (ST11). If the determination is YES, i.e., if the party of play characters has won the battle against the enemy character, points such as an experience value or soul points are added to, or an item, money, or the like is given to each character of the party in response to the type of the enemy character who the party has battled with and the content of the battle (ST12). The level of the characters is then increased in response to the experience value of each character (ST13). Conversely, if the determination in ST11 is NO, i.e., if the party of play characters has failed in winning the battle against the enemy character, it is determined whether or not the whole party of play characters has been killed (ST14). If the determination is YES, the game is over (ST15), and this main game process is brought to an end. If NO, the process moves to ST16.

In ST16, a movie responding to the situation is displayed, and it is subsequently determined whether a selection sub-map request condition has been cleared or not (ST17). If the determination is NO, the process moves to ST6 again, and if YES, it is determined whether or not the process moves to “ending” (ST18). If the determination is YES, a prescribed ending display is performed (ST19), and this main game process is brought to an end. Conversely, if the determination in ST18 is NO, the process moves to ST4 again.

Battle Process

The aforementioned “battle process” will be described using FIG. 51.

First, as shown in FIG. 51, a parameter relating to a character is set, then a turn interval value is calculated, and a setting process is executed (ST30). In this process, the CPU 21 reads the parameter relating to the character from the RAM 23 and a predetermined region of the DVD-ROM 31, and sets the read parameter on a predetermined region of the RAM 23. As used herein, the term character corresponds to a plurality of characters including a player character and an enemy character who appear in the “battle scene”. Also, the term turn interval value refers to a value which is used to determine an action order, which is calculated for each plurality of characters (including a player character and an enemy character). This turn interval value is determined in response to the speed (AGL) and luck (LUC), which have been set for each plurality of characters, and an execution command correction value corresponding to a command type to be executed. The CPU 21 sets, on a predetermined region of the RAM 23, the turn interval value calculated for each plurality of characters appearing in the “battle scene”. That is, the CPU 21 which executes such a process corresponds to one example of a character action order determination module which determines the action order of a plurality of characters. If this process ends, the process moves to ST31.

In ST 31, a battle scene start screen of the “battle scene”, such as shown in FIG. 27A, is displayed. On this start screen, a party of play characters (player character A111, player character B112, player character C113, and player character D114) are displayed in the front. Also, on the side opposite those player characters, enemy characters (e.g., enemy character a115, enemy character b116, and enemy character c117) are displayed at positions corresponding to the respective player characters. Additionally, although the display is omitted in FIG. 27A, information relating to the status of the player characters is displayed at the lower right position of this start screen. Furthermore, the action order image 118 in which order the actions of the player characters and enemy characters are executed and the action character image 119 showing a character whose turn has come for action are displayed at the upper position of the start screen.

In ST32, a “turn order process” is performed in order to manage the order in which player characters, inclusive of enemy characters as well, can perform an action such as an attack. In this process, the CPU 21, based on the turn interval value calculated from power and the like relating to each character, manages the turn order of characters the command selection of whom is validated. Specifically, the CPU 21 determines a turn order based on the turn interval value of each character. The CPU 21 then, based on the determined turn order, validates the command selection of a character who is made to execute an action. If there is any character capable of priority action, the command selection of the character has been validated in ST38 to be described later, so that a command selection validation process will be omitted. That is, the CPU 21 which executes such a process corresponds to one example of the character action order determination module which determines the action order of a plurality of characters.

Additionally, the CPU 21 displays, on the display 16, an image showing such a turn order. Also, the CPU 21 zooms in a player character the command selection of whom has been validated (here, player character A111), and displays a “command selection screen” such as shown in FIG. 27B. If this process ends, the process moves to ST33.

In ST33, it is determined whether the character the command selection of whom has been validated in the “turn order process” is an enemy character or not. If YES, an automatic process is performed in accordance with the game program so that the enemy character executes an attack against a player character (ST34). In this battle automatic process, the CPU 21 will, as with command selection to be described later, select an action mode (including selection of an action type and determination of the result and progress of an action which is based on the action type) of the enemy character. As used herein, the term selection of an action type refers to selection of an attack, magic, a specific skill, an item, and the like, as well as the type of the attack (“soft hit”, “normal hit”, “hard hit”, and the like), the type of the magic, the type of the specific skill, the type of the item, and the like. If this process ends, the process moves to ST 36.

Conversely, if it is determined in ST33 that the character the command selection of whom has been validated is a player character, then subsequently, a “command process” for receiving a command selection made by a player's operation is performed (ST35). In this process, a command is selected in response to an operational input from the input device 4, and an action mode which is based on the selected command will then be determined.

The CPU 21 displays on the display 16 the command menu 44 in which a command for determining an action type of player character A111 is shown as a selection item. The CPU 21 controls in such a way that a selection cursor 45 (see FIGS. 27B etc.) displayed on the left side of the command menu 44 (see FIGS. 27B etc.) is moved by an operation of the up button 7 or the down button 8 of the input device 4, and that a command with the selection cursor 45 displayed at the left position thereof is selected when the “circle” button 12 is operated, thereby determining an action type of player character A111. This command menu 44 displays various commands represented by “attack”, “magic”, “item”, “defense”, “escape”, and the like. In response to the determined action type, the CPU 21 then determines the result and progress of an action which is based on the action type. Particularly, in the “command process” of this embodiment, as a process in which the judgment ring 100 is used to enable technical intervention by a player's timely operation, the CPU 21 determines the result and progress of an action which is based on the action type. In this way, the CPU 21 will select an action mode of a player character. The details of this “command process” will be described using FIG. 53. If this process ends, the process moves to ST36.

In ST36, an action execution effect process is executed. If a command (“action” command to be described later) to perform, for example, “attack”, “magic”, “specific skill”, and “item use” has been selected, and the result and progress of an action which is based on the action type has been determined using the judgment ring, then a display process is executed in which the action is performed against a target character who acts as a target of a player character, an enemy character, or the like. As used herein, the term player character refers to any of player characters included in the battle group to be described later in detail using FIGS. 72 and 73.

The CPU 21 and the like which execute such a process will exert action control of the player character based on the action mode of the player character which has been selected in ST35. In other words, the CPU 21 and the like which execute such a process will exert action control of the player character based on the player character's action result and progress which has been determined in ST35. Also, the CPU 21 and the like which execute such a process will exert action control of the enemy character based on the action mode of the enemy character which has been selected in ST34. In other words, the CPU 21 and the like which execute such a process will exert action control of the enemy character based on the enemy character's action result and progress which has been determined in ST34.

That is, the CPU 21 and the like which execute such a process will, based on the action mode of a character (any of a plurality of characters) which has been selected in ST34 and ST35, exert action control of the character (any of the plurality of characters). In other words, the CPU 21 and the like which execute such a process will, based on the character's action result and progress which has been determined in ST34 and ST35, exert action control over the character (any of the plurality of characters). Also, generally, the CPU 21 and the like which execute such a process will, based on a plurality of character data stored in the RAM 23, exert action control of a plurality of characters.

Particularly, not based on character data of player characters (second characters) grouped not as the battle group but as the standby group, but based on character data of player characters (first characters) grouped as the battle group, the CPU 21 exerts action control of the player characters grouped as the battle group. That is, the CPU 21 which executes such a process will, based on a larger number of pieces of item data than that of the second characters grouped as the standby group (second group), exert action control of the first characters grouped as the battle group (first group). In this embodiment, the CPU 21 which executes such a process corresponds to one example of a character action control section and a first character action control section.

Additionally, the CPU 21 which executes a process such as ST34, ST35 and ST36 will, in accordance with the action order of a plurality of characters, carry out determination of an action result and progress, and action control of the characters. Also, in other words, the CPU 21 will, in accordance with the determined action order of the plurality of characters, carry out selection of a character action mode and character action control. Furthermore, when “combo” (character action connection mode), “double” (character combined action mode), “double combo” (character combined action connection mode), or the like has been selected as an action mode of a character, such a CPU 21 will, before selection of the next action mode of the character, execute the character action control based on the “combo” (character action connection mode), “double” (character combined action mode), “double combo” (character combined action connection mode), or the like. The CPU 21 which executes such a process corresponds to one example of the special character action control section. If this process ends, the process moves to ST37.

In ST37, a special action value update process is executed. In this process, the CPU 21 updates a special action value related to each character (including a player character and an enemy character) based on the action mode (action type, and action result and progress) and the like selected in ST34 and ST35. As described above, this special action value is a value which is used to execute “combo”, “double”, “double combo”, and the like. The details of this “special action value update process” will be described later using FIG. 52. If this process ends, the process moves to ST38.

In ST 38, a turn order is updated each time a character performs an action. In this process, the CPU 21 stores a character who has performed an action in a predetermined region of the RAM 23, and updates the turn order of the character who has performed the action. The CPU 21 thereby compares the updated turn order when executing the “turn order process” and will thus determine a character to be made to perform an action the command selection of whom is validated.

Particularly, the CPU 21 changes the turn interval value of a character targeted for the combined action (“combo” and “double combo”) selected in ST230, ST328, ST338, or the like to be described later.

Specifically, the CPU 21 initializes the turn interval value of the character targeted for the combined action (“combo” and “double combo”) selected in ST230, ST328, ST338, or the like. The CPU 21 will then add the turn interval value of the character targeted for the combined action (“combo”) selected in ST230 by a value based on the action type of the “combo”. The character targeted for the combined action (“combo” and “double combo”) selected in ST328 or ST338 will thereby be selected in ST32, ST38, or the like as a character whose turn will come next for action. When “double” and “double combo” has been executed, 90% of a plurality of total values corresponding to a plurality of (e.g., two) action types performed by one character will be added to the turn interval value. Also, the action order is determined in such a manner that the action order of characters who are made to execute a combined action (interruption of turn order) is prioritized. Furthermore, the CPU 21 exerts control to validate the command selection of a character determined to be prioritized.

On the other hand, out of characters targeted for the combined action (“combo”) selected in ST230, with respect to a character against whom “combo” has resulted in success, selection of an action type, determination of an action result and progress (including selection of an action mode), and action control have already been finished by the shortcut function to be described later. Therefore, this character will be determined in ST32, ST38, or the like as a character who has now finished the action. That is, the CPU 21 which executes such a process corresponds to one example of the character action order determination module which determines the action order of a plurality of characters. If this process ends, the process moves to ST39.

In ST39, a turn order update display process is executed. In this process, based on the turn order updated in the process of ST38, the CPU 21 updates and displays a turn order in which an action to be performed in the next turn is executed. If this process ends, the process moves to ST40.

In ST40, it is determined whether a “battle process” end condition is fulfilled or not. If NO, the process returns to the aforementioned ST32, while if YES, the “battle process” is brought to an end. As used herein, the term “battle process” end condition refers to any of the conditions that enemy characters appearing on the battle screen have been completely destroyed, that the player has selected the “escape” command and has succeeded in escaping from an enemy character, that a party of player characters has been completely destroyed, that an event to finish the battle has occurred, and so on.

Special Action Value Update Process

The aforementioned “special action value update process” will be described using FIG. 52.

First, as shown in FIG. 52, it is determined whether or not an action is in a predetermined action mode (ST91). The predetermined action mode of this embodiment refers to an action mode of an attack action such as “physical attack”, “magic attack”, “special skill attack”, and “item attack”, but the invention is not limited to this action mode. If the CPU 21 determines in this process that the action is in the predetermined action mode, it moves the process to ST92. Conversely, if the CPU 21 determines that the action is not in the predetermined action mode, it moves the process to ST97.

In ST92, the addition action value of a character who has performed an attack is calculated. Subsequently, in ST93, the addition action value of a character who has suffered an attack is calculated. In these processes, the CPU 21, by referring to the addition action value calculation table (see FIG. 12), calculates the addition action value of the character who has performed an attack and the addition action value of the character who has suffered an attack.

Specifically, by referring to the addition action value calculation table (see FIG. 12), the CPU 21 determines the feasibility of the addition condition based on “HP”, “SP”, “special action value”, “number of collaborative hits”, “attack attribute”, “hit mode”, and the like. When a player character has executed an attack action, the CPU 21 temporarily stores in the RAM 23, as the addition action value of the player character, the value calculated by the expression of (basic value×HP coefficient×SP coefficient×special action value coefficient×number-of-collaborative-hits coefficient×attack attribute coefficient×number of hits in currently performed attack action)+hit mode points. Also, when a player character has suffered an attack action, the CPU 21 temporarily stores in the RAM 23, as the addition action value of the player character, the value calculated by the expression of basic value×HP coefficient×SP coefficient×special action value coefficient×number of hits in currently suffered attack action. Besides, when an enemy character has executed an attack action, the CPU 21 temporarily stores in the RAM 23, as the addition action value of the enemy character, the value calculated by the expression of basic value (turn)×HP coefficient. Furthermore, when an enemy character has suffered an attack action, the CPU 21 temporarily stores in the RAM 23, as the addition action value of the enemy character, the value calculated by the expression of basic value (turn)×HP coefficient. That is, the CPU 21 which executes such processes and the RAM 23 temporarily store an action value, which varies according to the exerted action control, for each plurality of characters. The CPU 21 which executes such processes and the RAM 23 correspond to one example of the character data storage module. If these processes end, the process moves to ST 94.

An action value which varies according to the exerted action control is thus stored for each plurality of characters, and the character action connection mode for bringing a connection to a character action to be performed in a subsequent turn is made selectable on condition that the action value has reached a predetermined value. When the character action connection mode has been selected as an action mode of a character, character action control based on the character action connection mode is exerted before the next action mode of the character is selected. Accordingly, without selecting an action mode such as moving a character, the character action connection mode for bringing a connection to a character action to be performed in a subsequent turn is made selectable in response to an action value which varies according to the exerted action control. This enables smooth action progress, and prevents the existence value of the character action connection mode from decreasing. Thus, action mode selection is diversified, a strategic action mode is selected, and so on, thereby making it possible to increase player's interest in the game.

Additionally, an action value (special action value) is increased by performing an attack action or suffering an attack action, so that the attack action can be strategically and positively performed, thus making it possible to increase player's interest in the game. Also, an action value (special action value) is increased by suffering attack actions, so that even when those attack actions have been suffered, it will not merely reduce player's interest in the game. Thus, the player is led to strategically and positively participate in the game, thereby making it possible to increase player's interest in the game.

In ST94, a calculated addition action value is added to a special action value. In this process, the CPU 21 adds the addition action value calculated in ST93 and ST94 to a special action value corresponding to the character. If this process ends, the process moves to ST95.

In ST95, it is determined whether or not a character is running out of control. If it is determined in this process that SP has reached “0” and the character is running out of control, the CPU 21 initializes the special action value of the character running out of control (ST96), and moves the process to ST97. Conversely, if SP has reached “0” and it is determined that the character is not running out of control, the CPU 21 moves the process to ST97 without executing ST96.

In this embodiment, once the character falls in an out-of-control state, all command operations are stopped from being received. Alternatively, the configuration may be such that only some commands are received under a predetermined condition. For example, the configuration is such as to receive only an “item” command but prevent the player from recognizing whom a selected “item” is used for, or such as to receive a “fight” command once every three turns. The configuration may also be such that it is when “SP=0” that a player character runs out of control, and such that the player character does not keep running out of control but returns to normal after a lapse of time.

In ST97, it is determined whether a special action value subtraction condition has been established or not. In this process, by referring to the special action table (see FIG. 11), the CPU 21 will, based on the action mode (an action type and the result and progress of an action which is based on the action type) selected in ST35, determine whether the special action value subtraction condition has been established or not.

If the CPU 21 determines that the special action value subtraction condition has been established, it subtracts the special action value of a predetermined character (ST98). Specifically, if, in ST35, “combo” has been selected as an action type and the “combo” has been established, the CPU 21 will store a special action value, which corresponds to a character against whom the “combo” has been established, by reducing it by 100. That is, if the character action connection mode (“combo selection” and “combo establishment”) has been selected in ST35, the CPU 21 which executes such a process and the RAM 23 will store a special action value (action value) by reducing it to a specified value (value obtained by reducing the special action value by 100) (by reducing it by 100).

If, in ST35, “double” has been selected as an action type and the “double” has been established, the CPU 21 will store a special action value, which corresponds to a character against whom the “double” has been established, by reducing it by 100. That is, if the character combined action mode (“double selection” and “double establishment”) has been selected in ST35, the CPU 21 which executes such a process and the RAM 23 will store a special action value (action value) by reducing it to a specified value (value obtained by reducing the special action value by 100) (by reducing it by 100).

If, in ST35, “double combo” has been selected as an action type and the “double combo” has been established, the CPU 21 will store a special action value, which corresponds to a character against whom the “double combo” has been established, by reducing it by 200. That is, if the character combined action connection mode (“double combo selection” and “double combo establishment”) has been selected in ST35, the CPU 21 which executes such a process and the RAM 23 will store a special action value (action value) by reducing it to a specified value (value obtained by reducing the special action value by 200) (by reducing it by 200). Also, in other words, the CPU 21 which executes such a process and the RAM 23 store an action value, which varies according to the exerted action control, for each plurality of characters. The CPU 21 which executes such a process and the RAM 23 correspond to one example of the character data storage module. If this process ends, this sub-routine is brought to an end.

An action value which varies according to the exerted action control is thus stored for each plurality of characters, and on condition that the action value has reached a predetermined value, the character action connection mode for bringing a connection to a character action to be performed in a subsequent turn is made selectable. When the character action connection mode has been selected as an action mode of a character, character action control based on the character action connection mode is exerted before the next action mode of the character is selected. Accordingly, without selecting an action mode such as moving a character, the character action connection mode for bringing a connection to a character action to be performed in a subsequent turn is made selectable in response to an action value which varies according to the exerted action control. This enables smooth action progress, and prevents the existence value of the character action connection mode from decreasing. Thus, action mode selection is diversified, a strategic action mode is selected, and so on, thereby making it possible to increase player's interest in the game.

If any of the character action connection mode, character combined action mode, and character combined action connection mode has been selected, an action value is stored reduced to a specified value. Accordingly, action control based on the character action connection mode, character combined action mode, and character combined action connection mode is prevented from being easily exerted in succession. Thus, action mode selection is diversified, a strategic action mode is selected, and so on, thereby making it possible to increase player's interest in the game.

Conversely, if the CPU 21 determines that the special action value subtraction condition has not been established, it brings this sub-routine to an end without executing ST98. If “combo” (shortcut) to be described later has been selected, the configuration is such that, if a character has failed in “combo” and “double combo” in mid-course (combo break), the special action values of the character who has failed and a character who should have executed “combo” and “double combo” thereafter are not subtracted. However, the invention is not limited to this configuration. For example, the special action value of only the character who has failed may be subtracted, or, for example, special action values corresponding to all the other characters who should have collaborated with each other in “combo” and “double combo” may be subtracted. Also, in “double” and “double combo”, the configuration is such that, even if a character has failed in “double”, a special action value corresponding to the character is not subtracted. However, the invention is not limited to this configuration.

Command Process

The aforementioned “command process” will be described using FIG. 53.

First, as shown in FIG. 53, it is determined whether or not SP is “0” or less (ST101). If the CPU 21 determines in this process that SP is “0” or less, it executes a character out-of-control process (ST102). In this process, the CPU 21 selects a command for invalidating command selection operation of a character, operation of a judgment ring, and the like to automatically determine an action type (“attack”, “attack magic use”, “recovery magic use”, or the like), and thus determines the result and progress of an action corresponding to the command. In this process, a character runs out of control, and an action unfavorable for the character can thus be selected. If this process ends, this sub-routine is brought to an end. Conversely, if the CPU 21 determines that SP is not “0” or less, it moves the process to ST103.

In ST103, the CPU 21 refers to a character's special action value and the like. In ST104, based on the character's special action value and the like referred to, the CPU 21 executes a command operation invalidation setting process. In this process, the CPU 21 refers to the special action table (see FIG. 11) and will, when a special action value related to a player character whose turn has come for action is smaller than a special action consumption value, exert control to restrict an action corresponding to the special action consumption value. Specifically, when the special action value of a character whose turn has come for action is smaller than 50, the CPU 21 exerts control to restrict the actions of hard hit attack, combo attack, double attack, and double combo attack. Also, when the special action value of a character whose turn has come for action is smaller than 100, the CPU 21 exerts control to restrict the actions of combo attack, double attack, and double combo attack. Besides, when the special action value of a character whose turn has come for action is smaller than 200, the CPU 21 exerts control to restrict the action of double combo attack. Furthermore, by referring to the character data table (see FIG. 4), action table (see FIG. 5), and hit attribute table (see FIG. 13), based on the position (current) of a character targeted for an attack and the hit attribute of the attack action type of the character, if an action is of position and attack in which a hit is not necessarily scored, the CPU 21 exerts control to restrict the action. However, the invention is not limited to this configuration.

An action value which varies according to the exerted action control is thus stored for each plurality of characters, and on condition that the action value has reached a predetermined value, the character action connection mode for bringing a connection to a character action to be performed in a subsequent turn is made selectable. When the character action connection mode has been selected as an action mode of a character, character action control based on the character action connection mode is exerted before the next action mode of the character is selected. Accordingly, without selecting an action mode such as moving a character, the character action connection mode for bringing a connection to a character action to be performed in a subsequent turn is made selectable in response to an action value which varies according to the exerted action control. This enables smooth action progress, and prevents the existence value of the character action connection mode from decreasing. Thus, action mode selection is diversified, a strategic action mode is selected, and so on, thereby making it possible to increase player's interest in the game. If this process ends, the process moves to ST105.

In ST105, the CPU 21 executes a collaboration type command reception process. As described later in detail using FIGS. 54 to 57, the CPU 21 will receive selection of a command relating to an action and execute a command reception process for determining the type of the action. In this process, an invoked sub-routine differs from one collaboration type to another, such as “normal”, “combo”, “double”, and “double combo”. If this process ends, the process moves to ST106.

In ST106, the CPU 21 executes a collaboration type action result determination process. As described later in detail using FIGS. 58 to 62, the CPU 21 will determine a judgment ring and execute an action result determination process, such as a display control process of the judgment ring and an action determination process based on the operation result of the judgment ring. In this process, an invoked sub-routine differs from one collaboration type to another, such as “normal”, “combo (normal)”, “combo (shortcut)”, “double”, and “double combo”. In ST105 and ST106, the CPU 21 thus determines the action mode of a character. If this process ends, the process moves to ST107.

That is, the CPU 21 which executes processes such as ST105 and ST106 will, based on an operational signal from the input device 4 and a plurality of character data (particularly, a determined player character's state to be described later), select the action mode of a character. Also, such a CPU 21 will make “combo”, “double”, or the like selectable on condition that the special action value has reached a predetermined value, and will make “double combo” or the like selectable on condition that the special action value has reached a specified action value greater than the predetermined value. In this embodiment, the CPU 21 which executes such a process corresponds to one example of a character action mode selection module.

In ST107, the CPU 21 executes a character data update process. In this process, based on the action result determined in ST106, the CPU 21 updates character data relating to characters (including a player character and an enemy character), such as updating HP, MP, SP, AGL, LUC, and various statuses. If this process ends, this sub-routine is brought to an end.

Normal Command Reception Process

Out of the aforementioned “collaboration type command reception process”, a “normal command reception process” invoked upon reception of a normal command will be described using FIG. 54.

First, as shown in FIG. 54, the CPU 21 determines whether or not there is an action type selection operation (ST201). In this process, based on an operational signal from the input device 4, the CPU 21 determines whether or not there is an action type selection operation. If it is determined that there is the action type selection operation, then in response to character data relating to a player character whose turn has come for action, the CPU 21 stores in the RAM 23 an action type corresponding to the action type selection operation and thereby executes an action type selection process (ST202), thus moving the process to ST203. The CPU 21 will thereby select the action type of the character based on an operational signal from the input device 4 and a plurality of character data. Also, the CPU 21 will make one action type selectable for one character. The CPU 21 which executes ST202 corresponds to one example of a character action type selection module. Conversely, if it is determined that there is no action type selection operation, the CPU 21 moves the process to ST201 again without moving the process to ST202.

In ST203, the CPU 21 determines whether or not there is an action target selection operation. In this process, based on an operation signal from the input device 4, the CPU 21 determines whether or not there is an action target selection operation to the effect of selecting an action target targeted for the action which is based on the action type selected in ST202. If the CPU 21 determines that there is the action target selection operation, it stores in the RAM 23 an action target corresponding to the action target selection operation and thereby executes an action target selection process (ST204), thus bringing this sub-routine to an end. Conversely, if it is determined that there is no action target selection operation, the CPU 21 moves the process to ST203 again without moving the process to ST204.

Double Command Reception Process

Out of the aforementioned “collaboration type command reception process”, a “double command reception process” invoked upon reception of a double command will be described using FIG. 55. Since a similar process is executed even upon reception of a double combo command, the double command reception process will be described as a representative, thus omitting the description of the double combo command reception process.

First, as shown in FIG. 55, the CPU 21 determines whether or not there is a first action type selection operation (ST211). In this process, based on an operational signal from the input device 4, the CPU 21 determines whether or not there is a first action type selection operation. If it is determined that there is the first action type selection operation, then in response to character data relating to a player character whose turn has come for action, the CPU 21 stores in the RAM 23 a first action type corresponding to the first action type selection operation and thereby executes a first action type selection process (ST212), thus moving the process to ST213. The CPU 21 will thereby select the action type of the character based on an operational signal from the input device 4 and a plurality of character data. Conversely, if it is determined that there is no first action type selection operation, the CPU 21 moves the process to ST211 again without moving the process to ST212.

In ST213, the CPU 21 determines whether or not there is a first action target selection operation. In this process, based on an operation signal from the input device 4, the CPU 21 determines whether or not there is a first action target selection operation to the effect of selecting a first action target targeted for the action which is based on the first action type selected in ST212. If the CPU 21 determines that there is the first action target selection operation, it stores in the RAM 23 a first action target corresponding to the first action target selection operation and thereby executes a first action target selection process (ST214), thus moving the process to ST215. Conversely, if it is determined that there is no first action target selection operation, the CPU 21 moves the process to ST213 again without moving the process to ST214.

In ST215, the CPU 21 determines whether or not there is a second action type selection operation. In this process, based on an operational signal from the input device 4, the CPU 21 determines whether or not there is a second action type selection operation. If it is determined that there is the second action type selection operation, then in response to character data relating to a player character whose turn has come for action, the CPU 21 stores in the RAM 23 a second action type corresponding to the second action type selection operation and thereby executes a second action type selection process (ST216), thus moving the process to ST217. The CPU 21 will thereby select the action type of the character based on an operational signal from the input device 4 and a plurality of character data. Also, the CPU 21 will make a plurality of action types selectable for one character. The CPU 21 which executes such a process corresponds to one example of the character action type selection module. Conversely, if it is determined that there is no second action type selection operation, the CPU 21 moves the process to ST215 again without moving the process to ST216.

In ST217, the CPU 21 determines whether or not there is a second action target selection operation. In this process, based on an operation signal from the input device 4, the CPU 21 determines whether or not there is a second action target selection operation to the effect of selecting a second action target targeted for the action which is based on the second action type selected in ST216. If the CPU 21 determines that there is the second action target selection operation, it stores in the RAM 23 a second action target corresponding to the second action target selection operation and thereby executes a second action target selection process (ST218), thus bringing this sub-routine to an end. Conversely, if it is determined that there is no second action target selection operation, the CPU 21 moves the process to ST217 again without moving the process to ST218.

Combo Command Reception Process

Out of the aforementioned “collaboration type command reception process”, a “combo command reception process” invoked upon reception of a combo command will be described using FIGS. 56 and 57.

First, as shown in FIG. 56, the CPU 21 determines whether or not there is a first action type selection operation (ST221). In this process, based on an operational signal from the input device 4, the CPU 21 determines whether or not there is a first action type selection operation. If it is determined that there is the first action type selection operation, then in response to character data relating to a player character whose turn has come for action, the CPU 21 stores in the RAM 23 a first action type corresponding to the first action type selection operation and thereby executes a first action type selection process (ST222), thus moving the process to ST223. The CPU 21 will thereby select the action type of the character based on an operational signal from the input device 4 and a plurality of character data. Conversely, if it is determined that there is no first action type selection operation, the CPU 21 moves the process to ST221 again without moving the process to ST222.

In ST223, the CPU 21 determines whether or not there is a first action target selection operation. In this process, based on an operation signal from the input device 4, the CPU 21 determines whether or not there is a first action target selection operation to the effect of selecting a first action target targeted for the action which is based on the first action type selected in ST222. If the CPU 21 determines that there is the first action target selection operation, it stores in the RAM 23 a first action target corresponding to the first action target selection operation and thereby executes a first action target selection process (ST224), thus moving the process to ST225. Conversely, if it is determined that there is no first action target selection operation, the CPU 21 moves the process to ST223 again without moving the process to ST224.

In ST225, the CPU 21 determines whether a shortcut operation validation condition has been established or not. If it is determined in this process that the shortcut operation validation condition has been established, the CPU 21 turns on a shortcut flag positioned in the RAM 23 (ST226) and then moves the process to ST228 of FIG. 57. Conversely, if it is determined that the shortcut operation validation condition has not been established, the CPU 21 turns off the shortcut flag position in the RAM 23 (ST227) and then brings this sub-routine to an end. In this embodiment, whether the shortcut operation validation condition has been established or not is determined based on the condition that the special action value of a player character whose turn has come for action is 10 or greater, and based on an operational signal from the input device 4. However, the invention is not limited to this configuration.

If it is determined that the shortcut operation validation condition has not been established, and the shortcut flag is turned off, the CPU 21 will, in the aforementioned ST222, select the action type of a character who has been selected in a to-be-described subsequent action character selection process (see FIG. 61) and whose turn has been determined to come for action order in the aforementioned turn order process (see FIG. 51). The CPU 21 will select the action type of the character based on an operational signal from the input device 4 and a plurality of character data. Also, the CPU 21 will make each action type selectable for each plurality of characters. The CPU 21 which executes such a process corresponds to one example of the character action type selection module.

In ST228 of FIG. 57, the CPU 21 determines whether a subsequent action invalidation condition has been established or not. If the CPU 21 determines in this process that the subsequent action invalidation condition has been established, it brings this sub-routine to an end. Conversely, if the CPU 21 determines that the subsequent action invalidation condition has not been established, it moves the process to ST229. In this embodiment, whether the subsequent action invalidation condition has been established or not is determined based on the condition that there is no subsequent character or that no subsequent character is selected based on an operational signal from the input device 4. However, the invention is not limited to this configuration.

In ST229, the CPU 21 determines whether or not there is a subsequent action character selection operation. In this process, based on an operational signal from the input device 4, the CPU 21 determines whether or not there is a subsequent action character selection operation. If it is determined that there is the subsequent action character selection operation, the CPU 21 stores, in the RAM 23, data indicating the selected subsequent action character and thereby executes the subsequent action character selection process (ST230), thus moving the process to ST231. Conversely, if it is determined that there is no subsequent action character selection operation, the CPU 21 moves the process to ST228 again without moving the process to ST230.

In ST231, the CPU 21 determines whether or not there is a subsequent action type selection operation. In this process, based on an operational signal from the input device 4, the CPU 21 determines whether or not there is a subsequent action type selection operation. If it is determined that there is the subsequent action type selection operation, then in response to character data relating to a player character who has been determined to subsequently perform an action, the CPU 21 stores in the RAM 23 a subsequent action type corresponding to the subsequent action type selection operation and thereby executes a subsequent action type selection process (ST232), thus moving the process to ST233. The CPU 21 will thereby select the action type of the character based on an operational signal from the input device 4 and a plurality of character data. Also, the CPU 21 will make each action type selectable for each plurality of characters. The CPU 21 which executes such a process corresponds to one example of the character action type selection module. Conversely, if it is determined that there is no subsequent action type selection operation, the CPU 21 moves the process to ST231 again without moving the process to ST232.

In ST233, the CPU 21 determines whether or not there is a subsequent action target selection operation. In this process, based on an operation signal from the input device 4, the CPU 21 determines whether or not there is a subsequent action target selection operation to the effect of selecting a subsequent action target targeted for the action which is based on the subsequent action type selected in ST232. If the CPU 21 determines that there is the subsequent action target selection operation, it stores in the RAM 23 a subsequent action target corresponding to the subsequent action target selection operation and thereby executes a subsequent action target selection process (ST234), thus moving the process to ST228 again. Conversely, if it is determined that there is no subsequent action target selection operation, the CPU 21 moves the process to ST233 again without moving the process to ST234. Normal Action Result Determination Process Out of the aforementioned “collaborative type action result determination process”, a “normal action result determination process” invoked upon reception of a normal command will be described using FIG. 58.

First, as shown in FIG. 58, the CPU 21 executes a judgment ring determination process 1 (ST301). As described later in detail using FIG. 63, the CPU 21 determines, as a single mode, the range of each timing area and each 120% region of the judgment ring 100, the rotation mode of the rotary bar 101, and the like. The CPU 21 then supplies the image processing section 24 with data indicating the determined result and thereby executes a judgment ring display control process (ST302). Thereafter, based on the data indicating the determined result, the image processing section 24 exerts control to display the judgment ring 100 on the display 16. That is, the CPU 21, image processing section 24, and the like correspond to one example of a display control section which exerts display control over a judgment ring (action result/progress determination region) for determining an action result and progress, a rotary bar (moving region) displayed in a moving fashion within the judgment ring for a predetermined period, and a timing area (determination region) which is set in the judgment ring based on a selected character action type. If this process ends, the process moves to ST303.

In ST303, the CPU 21 executes a judgment ring determination process. As described later in detail using FIG. 66, at the time an operational signal from the input device 4 has been detected, the CPU 21 stores a position of the rotary bar 101 displayed in a moving fashion on the judgment ring 100, and determines whether the position is a timing area or a 120% region, thus determining damage, a recovery value, and the like. The CPU 21 then executes a correction parameter setting process for correcting an action result and progress, such as damage, a recovery value, and the like (ST304). Specifically, if there is a correction parameter which is used to increase/decrease damage, a recovery value, and the like, the CPU 21 sets the correction parameter on the RAM 23 and will, based on the damage, recovery value, and the like, as well as the correction parameter, execute the character data update process (see FIG. 53). As one specific example, by referring to the character data table (see FIG. 4), the CPU 21 determines whether the position (reference) and position (current) of a character who has suffered an attack (damage) are different from each other and, if it determines that they are different from each other, increases damage by +10%. Also, the CPU 21 reads out a combo flag and, if it determines that “combo” is ongoing, increases 2% damage for each number of hits performed while the “combo” is ongoing. That is, the CPU 21 which executes such a process will, based on an operational signal from the input device 4, determine the result and progress of an action which is based on the action type selected in ST202. In other words, the CPU21 will select an action mode based on an operational signal from the input device 4 and character data. If this process ends, this sub-routine is brought to an end.

Double Action Result Determination Process

Out of the aforementioned “collaborative type action result determination process”, a “double action result determination process” invoked upon reception of a double command will be described using FIG. 59.

First, as shown in FIG. 59, the CPU 21 executes a judgment ring determination process 2 (ST311). As described later in detail using FIG. 64, the CPU 21 determines, as a double mode, the range of each timing area and each 120% region of the judgment ring 100, the rotation mode of the rotary bar 101, and the like. The CPU 21 then supplies the image processing section 24 with data indicating the determined result and thereby executes the judgment ring display control process (ST312). Thereafter, based on the data indicating the determined result, the image processing section 24 exerts control to display the judgment ring 100 on the display 16. That is, the CPU 21, image processing section 24, and the like correspond to one example of a display control section which exerts display control over a judgment ring (action result/progress determination region) for determining an action result and progress, a rotary bar (moving region) displayed in a moving fashion within the judgment ring for a predetermined period, and a timing area (determination region) which is set in the judgment ring based on a selected character action type. If this process ends, the process moves to ST313.

In ST313, the CPU 21 executes a judgment ring determination process. As described later in detail using FIG. 66, in the same manner as in FIG. 58, at the time an operational signal from the input device 4 has been detected, the CPU 21 stores a position of the rotary bar 101 displayed in a moving fashion on the judgment ring 100, and determines whether the position is a timing area or a 120% region, thus determining damage, a recovery value, and the like. The CPU 21 then executes the correction parameter setting process for correcting an action result and progress, such as damage, a recovery value, and the like (ST314). Specifically, the CPU 21 will, if there is a correction parameter which is used to increase/decrease damage, a recovery value, and the like, set the correction parameter on the RAM 23 and will, based on the damage, recovery value, and the like, as well as the correction parameter, execute the character data update process (see FIG. 53). That is, the CPU 21 which executes such a process will, based on an operational signal from the input device 4, determine the result and progress of an action which is based on the action type selected in ST212. In other words, the CPU 21 will select an action mode based on an operational signal from the input device 4 and character data. If this process ends, this sub-routine is brought to an end.

Double Combo Action Result Determination Process

Out of the aforementioned “collaborative type action result determination process”, a “double combo action result determination process” invoked upon reception of a double combo command will be described using FIG. 60.

First, as shown in FIG. 60, the CPU 21 executes the judgment ring determination process 2 (ST321). As described later in detail using FIG. 64, in the same manner as in FIG. 59, the CPU 21 determines, as a double mode, the range of each timing area and each 120% region of the judgment ring 100, the rotation mode of the rotary bar 101, and the like. The CPU 21 then supplies the image processing section 24 with data indicating the determined result and thereby executes the judgment ring display control process (ST322). Thereafter, based on the data indicating the determined result, the image processing section 24 exerts control to display the judgment ring 100 on the display 16. That is, the CPU 21, image processing section 24, and the like correspond to one example of the display control section which exerts display control over a judgment ring (action result/progress determination region) for determining an action result and progress, a rotary bar (moving region) displayed in a moving fashion within the judgment ring for a predetermined period, and a timing area (determination region) which is set in the judgment ring based on a selected character action type. If this process ends, the process moves to ST323.

In ST323, the CPU 21 executes the judgment ring determination process. As described later in detail using FIG. 66, in the same manner as in FIG. 59, at the time an operational signal from the input device 4 has been detected, the CPU 21 stores a position of the rotary bar 101 displayed in a moving fashion on the judgment ring 100, and determines whether the position is a timing area or a 120% region, thus determining damage, a recovery value, and the like. The CPU 21 then executes the correction parameter setting process for correcting an action result and progress, such as damage, a recovery value, and the like (ST324). Specifically, the CPU 21 will, if there is a correction parameter which is used to increase/decrease damage, a recovery value, and the like, set the correction parameter on the RAM 23 and will, based on the damage, recovery value, and the like, as well as the correction parameter, execute the character data update process (see FIG. 53). That is, the CPU 21 which executes such a process will, based on an operational signal from the input device 4, determine the result and progress of an action which is based on the action type selected in ST212. In other words, the CPU 21 will select an action mode based on an operational signal from the input device 4 and character data. If this process ends, the process moves to ST325.

In ST325, the CPU 21 executes a combo establishment determination process. As described later in detail using FIG. 67, according to a combo ring operation result which is based on an operational signal from the input device 4, the CPU 21 determines whether “combo” is established or not. If this process ends, the process moves to ST326.

In ST326, the CPU 21 determines whether “combo” is established or not. In this process, according to whether or not it is determined in ST 325 that “combo” has been established, the CPU 21 determines whether “combo” is established or not. If the CPU 21 determines that “combo” has been established, it moves the process to ST327. Conversely, if the CPU 21 determines that “combo” has not been established, it brings this sub-routine to an end.

In ST327, in the same manner as in ST229 of FIG. 57, the CPU 21 determines whether or not there is a subsequent action character selection operation. In this process, based on an operation signal from the input device 4, the CPU 21 determines whether or not there is a subsequent action character selection operation. If it is determined that there is the subsequent action character selection operation, the CPU 21 stores, in the RAM 23, data indicating the selected subsequent action character and thereby executes the subsequent action character selection process (ST328), thus bringing this sub-routine to an end. Conversely, if it is determined that there is no subsequent action character selection operation, the CPU 21 moves the process to ST327 again without moving the process to ST328.

Combo Action Result Determination Process (Normal)

Out of the aforementioned “collaborative type action result determination process”, a “combo action result determination process (normal)” invoked upon reception of a combo command not using the shortcut function will be described using FIG. 61.

First, as shown in FIG. 61, the CPU 21 executes the judgment ring determination process 1 (ST331). As described later in detail using FIG. 63, in the same manner as in FIG. 58, the CPU 21 determines, as a single mode, the range of each timing area and each 120% region of the judgment ring 100, the rotation mode of the rotary bar 101, and the like. The CPU 21 then supplies the image processing section 24 with data indicating the determined result and thereby executes the judgment ring display control process (ST332). Thereafter, based on the data indicating the determined result, the image processing section 24 exerts control to display the judgment ring 100 on the display 16. That is, the CPU 21, image processing section 24, and the like correspond to one example of the display control section which exerts display control over a judgment ring (action result/progress determination region) for determining an action result and progress, a rotary bar (moving region) displayed in a moving fashion within the judgment ring for a predetermined period, and a timing area (determination region) which is set in the judgment ring based on a selected character action type. If this process ends, the process moves to ST333.

In ST333, the CPU 21 executes the judgment ring determination process. As described later in detail using FIG. 66, in the same manner as in FIG. 58, at the time an operational signal from the input device 4 has been detected, the CPU 21 stores a position of the rotary bar 101 displayed in a moving fashion on the judgment ring 100, and determines whether the position is a timing area or a 120% region, thus determining damage, a recovery value, and the like. The CPU 21 then executes the correction parameter setting process for correcting an action result and progress, such as damage, a recovery value, and the like (ST334). Specifically, the CPU 21 will, if there is a correction parameter which is used to increase/decrease damage, a recovery value, and the like, set the correction parameter on the RAM 23 and will, based on the damage, recovery value, and the like, as well as the correction parameter, execute the character data update process (see FIG. 53). That is, the CPU 21 which executes such a process will, based on an operational signal from the input device 4, determine the result and progress of an action which is based on the action type selected in ST222. In other words, the CPU 21 will select an action mode based on an operational signal from the input device 4 and character data. If this process ends, the process moves to ST335.

In ST335, the CPU 21 executes the combo establishment determination process. As described later in detail using FIG. 67, according to a combo ring operation result which is based on an operational signal from the input device 4, the CPU 21 determines whether “combo” is established or not. If this process ends, the process moves to ST336.

In ST336, the CPU 21 determines whether “combo” is established or not. In this process, in the same manner as in ST326, according to whether or not it is determined in ST 335 that “combo” has been established, the CPU 21 determines whether “combo” is established or not. If the CPU 21 determines that “combo” has been established, it moves the process to ST337. Conversely, if the CPU 21 determines that “combo” has not been established, it brings this sub-routine to an end.

In ST337, the CPU 21 determines whether or not there is a subsequent action character selection operation. In this process, in the same manner as in ST327, based on an operation signal from the input device 4, the CPU 21 determines whether or not there is a subsequent action character selection operation. If it is determined that there is the subsequent action character selection operation, the CPU 21 stores, in the RAM 23, data indicating the selected subsequent action character and thereby executes the subsequent action character selection process (ST338), thus bringing this sub-routine to an end. Conversely, if it is determined that there is no subsequent action character selection operation, the CPU 21 moves the process to ST337 again without moving the process to ST338.

Combo Action Result Determination Process (Shortcut)

Out of the aforementioned “collaborative type action result determination process”, a “combo action result determination process (shortcut)” invoked upon reception of a combo command using the shortcut function will be described using FIG. 62.

First, as shown in FIG. 62, the CPU 21 executes a judgment ring determination process 3 (ST341). As described later in detail using FIG. 65, the CPU 21 determines, as a shortcut mode, the range of each timing area and each 120% region of a judgment ring, the rotation mode of the rotary bar 101, and the like. The CPU 21 then supplies the image processing section 24 with data indicating the determined result and thereby executes the judgment ring display control process (ST342). Thereafter, based on the data indicating the determined result, the image processing section 24 exerts control to display the judgment ring 100 on the display 16. That is, the CPU 21, image processing section 24, and the like correspond to one example of the display control section which exerts display control over a judgment ring (action result/progress determination region) for determining an action result and progress, a rotary bar (moving region) displayed in a moving fashion within the judgment ring for a predetermined period, and a timing area (determination region) which is set in the judgment ring based on a selected character action type. If this process ends, the process moves to ST343.

In ST343, the CPU 21 executes the judgment ring determination process. As described later in detail using FIG. 66, in the same manner as in FIG. 58, at the time an operational signal from the input device 4 has been detected, the CPU 21 stores a position of the rotary bar 101 displayed in a moving fashion on the judgment ring 100, and determines whether the position is a timing area or a 120% region, thus determining damage, a recovery value, and the like. The CPU 21 then executes the correction parameter setting process for correcting an action result and progress, such as damage, a recovery value, and the like (ST344). Specifically, the CPU 21 will, if there is a correction parameter which is used to increase/decrease damage, a recovery value, and the like, set the correction parameter on the RAM 23 and will, based on the damage, recovery value, and the like, as well as the correction parameter, execute the character data update process (see FIG. 53). That is, the CPU 21 which executes such a process will, based on an operational signal from the input device 4, determine the result and progress of an action which is based on the action type selected in ST222, ST232, or the like. In other words, the CPU 21 will select an action mode based on an operational signal from the input device 4 and character data. If this process ends, this sub-routine is brought to an end.

Judgment Ring Determination Process 1

The aforementioned “judgment ring determination process 1” will be described using FIG. 63.

First, as shown in FIG. 63, the CPU 21 refers to any of an “attack table” (see FIG. 15), a “specialty table” (see FIG. 16), and an “item table” (see FIG. 17) which have been set on the RAM 23, and thus determines a timing area range (ST351). Subsequently, in response to (based on) a to-be-described judgment ring correction parameter, the CPU 21 corrects the timing area range determined in the aforementioned ST351, a preset rotation speed and number of revolutions of the rotary bar, and a preset size of the judgment ring (ST352). Herein, the rotation speed of the rotary bar is set to 1.5 seconds per revolution as a basic speed, and the number of revolutions of the rotary bar is set to one revolution as a basic number of revolutions. Thus, the CPU 21 will, in the aforementioned ST302 and ST332, display the judgment ring 100 within the timing area range finally determined in this process, and exert control to rotationally display the rotary bar 101 at the determined rotation speed and number of revolutions of the rotary bar.

The timing area and the judgment ring correction parameter will be described hereafter.

FIG. 15 shows the “attack table”. This is a table which is set when a “fight” command has been selected by the player. As shown in FIG. 15, an attack which can be used according to the type of a player character is set therein, and attack power and the range of each timing area are set in response to the type of the attack (e.g., “soft hit”, “normal hit”, and “hard hit”).

The attack power is used to calculate the amount of damage done to an enemy character (the amount of opponent's damage), and the greater the numeric value of this attack power, the larger the amount of damage done to the enemy character.

As shown in FIG. 15, the timing area range is shown within an angle range enclosed by a “start angle” with a rotation start position 100a of the rotary bar 101 set to 0° and an “end angle”. As shown in FIG. 15, these “start angle” and “end angle” are each set to have a value which differs according to the type of the attack. For example, when the player character is player character A111 with “soft hit”, the range of a first timing area 102 is set to have an angle range of 90° from a start angle of 45° to an end angle of 135°. The range of a second timing area 103 is set to have an angle range of 67° from a start angle of 180° to an end angle of 247°. The range of a third timing area 104 is set to have an angle range of 45° from a start angle of 292° to an end angle of 337°.

Additionally, in the judgment ring 100, in a predetermined range of each timing area is set a “120% region” acting as a special valid region in which the damage amount of the enemy character increases by 20%, i.e., 1.2 times if the “circle” button 12 can be operated successfully before the predetermined area has been passed through. A “120% region” is formed within the range from an angle position, which is obtained by subtracting the angle formed by the “120% region” from the end angle, to the end angle.

FIG. 18 shows a calculating formula used to calculate the amount of damage done to the enemy character.

As shown in this FIG. 18, an “allocated value” is set to “0.2” at a first attack, “0.3” at a second attack, and “0.5” at a third attack.

An “SP residual correction value” keeps “1” until the current SP falls below 25% of maximum SP, i.e., while the current SP fulfills “25−current SP/maximum SP×100≦0”. When the current SP has fallen below 25% of maximum SP, i.e., when the current SP has fulfilled “25−current SP/maximum×100>0”, SP becomes “1.01” which is obtained by adding “0.01” to the aforementioned value. Thereafter, each time SP decreases by one point, “0.01” is added to the “residual SP correction value”. That is, the “residual SP correction value” is set in such a way that the amount of opponent's damage increases by 1% each time SP decreases by one point.

“Character's individual power” indicates STR (physical attack power) shown in the aforementioned FIG. 3, and “attack power” is a value set in response to the type of a player character and an attack which are shown in FIG. 15.

A “judgment ring correction value” is “1.2” when the “circle” button 12 has been operated while the rotary bar 101 is on the 120% region of a timing area, “1” when the “circle” button 12 has been operated while the rotary bar 101 is on a region other than the 120% region of a timing area, and “0” when the “circle” button 12 has not been operated while the rotary bar 101 is on a timing area.

For example, in the case where the “fight” command has been selected, when the “circle” button 12 has been operated successfully on three timing areas, i.e., when the “circle” button 12 has been operated successfully while the rotary bar 101 is on three timing areas, a player character thereafter repeats three attacks against an enemy character, thus causing predetermined damage thereto. For example, when player character A111 performs an attack of “soft hit”, the amount of opponent's damage at the first attack is “0.2×residual SP correction value×STR×6×1 (1.2)”, wherein points equivalent to this amount of opponent's damage are subtracted from HP of the enemy character. Similarly, the amount of opponent's damage at the second attack is “0.3×residual SP correction value×STR×6×1 (1.2)”, and the amount of opponent's damage at the third attack is “0.5×residual SP correction value×STR×6×1 (1.2)”, in each of which points equivalent to the amount of opponent's damage are subtracted from HP of the enemy character.

On the other hand, when the timing of operation of the “circle” button 12 has been upset on one timing area, the subsequent “judgment ring correction value” in the timing area becomes “0”. For example, in the case where player character A111 performs an attack of “soft hit”, when the “circle” button 12 has been operated successfully while the rotary bar 101 is on the first timing area 102, the amount of opponent's damage at a first attack is “0.2×residual SP correction value×STR×6×1 (1.2)”. However, when the timing of operation of the “circle” button 12 has been upset on the second timing area 103, the “judgment ring correction value” at a second attack and a third attack is “0”, and the amount of opponent's damage is also “0”.

At this point, when HP of an enemy character has become “0”, it means that a player character has defeated the enemy character.

FIG. 19 shows a display mode of the judgment ring 100 which is displayed during command determination. Shown herein is a judgment ring 100 during command determination displayed when a player character is player character A111 and “soft hit” has been selected. This judgment ring 100 is formed within the angle range of each timing area which has been set in the “attack table” shown in FIG. 15. When a player character is player character A111 and an attack command has been selected, the start angle of the first timing area 102 is 45° and the end angle thereof is 135°, the start angle of the second timing area 103 is 180° and the end angle thereof is 247°, and the start angle of the third timing area 104 is 292° and the end angle thereof is 337°. Also, as shown in this FIG. 19, in the first timing area 102, the “120% region” is a range 102a from “105°” obtained by subtracting 30° from an end angle of 135° to an end angle of “135°”. In the second timing area 103, the “120% region” is a range 103a from “224°” obtained by subtracting 23° from an end angle of 247° to an end angle of “247”. In the third timing area 104, the “120% region” is a range 104a from “322°”, which is obtained by subtracting 150 from an end angle of 337°, to an end angle of “337°”.

FIG. 20 shows a display mode of the judgment ring 100 after command determination. Shown herein is the condition in which the rotary bar 101 has started rotating and is passing through the first timing area 102.

The aforementioned “120% region” is not limited to the case as described above. For example, as shown in FIG. 21A, the “120% region” may be provided in the range from its start angle to a predetermined position, or as shown in FIG. 21B, two “120% regions” may be provided in two respective places. FIG. 21A shows the case in which a range 102a from a start angle of 45° to an angle of 65° obtained by adding 20° thereto is set as the “120% region”. Also, FIG. 21B shows the case in which a range 102a from a start angle of 45° to an angle of 65° obtained by adding 20° thereto and the other range from an end angle of 135° to an angle of 105° obtained by subtracting 30° from the end angle are set as the “120% regions”.

FIG. 16 shows the “specialty table”. This is a table which is set when a “special” command has been selected by the player. As used herein, the term “special” refers to a command for using special power which is individually set for each character. For example, player character A111 turns into a fusion monster to be described later, and will thus be able to use attack magic which has not been allowed to use in a normal state. As shown in this FIG. 16, special power which can be used according to the type of a player character, and a power value and the range of each timing area are set for each special power.

As shown in this FIG. 16, when a player character is player character A111, attack magic 1 to 3 can be used as special power, and power values set in them are used to calculate the amount of opponent 's damage for damaging an enemy character using the attack magic 1 to 3. In this case, the greater the power value of special power used, the larger the amount of damage done to the enemy character, i.e., the number of points for reducing HP of the enemy character. The attack magic 1 to 3 become usable when player character A111 has turned into the fusion monster to be described later.

On the other hand, when a player character is player character B112, recovery magic 1 to 3 can be used as special power, and power values set in them are used to calculate a recovery value for recovering the player character using the recovery magic 1 to 3. In this case, the greater the power value of special power used, the greater the recovery value of the player character, i.e., the number of points for recovering HP of the player character which has been reduced by the player character's being damaged by the enemy character.

Similar to the aforementioned “attack table” (see FIG. 15), a timing area range is indicated by an angle range enclosed by a “start angle” with a rotation start position 100a of the rotary bar 101 set to 0° and an “end angle”. These “start angle” and “end angle” are each set to have a value which differs according to the type of special power used. In addition thereto, in this “specialty table”, depending on the type of special power used, only the first timing area 102 is set in some cases, and only two, first and second timing areas 102 and 103 are set in other cases. For player character C113, such special power is not prepared, and neither a power value nor a timing area range is set in this “specialty table”.

FIG. 22 shows a calculating formula used to calculate the amount of opponent's damage caused when the attack magic 1 to 3 are used as special power, and a calculating formula used to calculate a recovery value obtained when the recovery magic 1 to 3 are used as special power.

As shown in this FIG. 22, an “allocated value” is set to “0.2” when special power is used for the first time, “0.3” when special power is used for the second time, and “0.5” when special power is used for the third time.

A “character's individual power” used in the calculating formula for calculating the amount of opponent's damage caused when the attack magic 1 to 3 of FIG. 22 indicates INT (magic attack power) shown in the aforementioned FIG. 3. A “power value of special power used” is a power value set in response to the type of the player character and the special power used which are shown in FIG. 16.

A “judgment ring correction value” is “1.2” when the “circle” button 12 has been operated while the rotary bar 101 is on the 120% region of a timing area, “1” when the “circle” button 12 has been operated while the rotary bar 101 is on a region other than the 120% region of a timing area, and “0” when the “circle” button 12 has not been operated while the rotary bar 101 is on a timing area.

For example, in the case where the “special” command has been selected and attack magic has been selected as special power, when the “circle” button 12 has been operated successfully on all timing areas displayed, a player character thereafter uses the attack magic to attack an enemy character, thus causing predetermined damage thereto. For example, to perform an attack using attack magic 1, player character A111 performs only one attack using the attack magic since only one timing area is set. The amount of opponent's damage at this attack is “0.2×INT×99×1 (1.2)” based on FIG. 22, wherein points equivalent to this amount of opponent's damage are subtracted from HP of the enemy character.

Additionally, to compare the timing area ranges of the respective tables by character, in the “attack table” of FIG. 15, the range of timing areas set for player character A111 is generally wider than the range of timing areas set for player character B112. For example, the total range of timing areas with “soft hit” selected is an angle range of (135°−45°)+(247°−180°)+(337°−292°)=202°, and the total range of timing areas with “normal hit” selected is an angle range of (125°−50°)+(205°−157°)+(282°−247°)=158°.

The reason is that a story is set in which player character A111 is a man character and has great physical strength and high physical attack power, so that player character A111 excels at a physical attack. Accordingly, the range of timing areas obtained upon selection of the “attack table” is set wider, and the degree of difficulty in operating the judgment ring 100 is thus lowered.

In the “specialty table” of FIG. 16, by contrast, the range of timing areas set for player character B112 is wider than the range of timing areas set for player character A111.

The reason is that a story is set in which player character B112 is a woman character and a witch, so that the range of timing areas obtained in the case of using recovery magic, i.e., upon selection of the “specialty table” is set wider, and the degree of difficulty in operating the judgment ring 100 is thus lowered.

The characteristic of each character resulting from setting of a story is thus incorporated into judgment ring 100 execution conditions, thereby creating the enjoyment of searching for not merely a technical intervention element but a command suitable to the characteristic of each character, which further increases player's interest in the game.

FIG. 17 shows the “item table”. This is a table which is set when an “item” command has been selected by the player, wherein use item's individual power and the range of each timing area are set according to the type of an item used. As shown in the “item table”, items A to C can be used in common by all characters. These items A to C are items which are used to recover HP of a player character which has been reduced by the player character's being damaged by an enemy character. Accordingly, the use item's individual power of this “item table” is used to calculate a recovery value for recovering the player character using these items A to C.

FIG. 23 shows a “judgment ring correction parameter table”. This “judgment ring correction parameter table” shows a parameter (hereafter called a “judgment ring correction parameter”) for varying a display mode of the judgment ring 100 (a timing area range, the rotation speed and number of revolutions of the rotary bar 101, the size of the judgment ring), and the content of variation of the display mode.

The type of the judgment ring correction parameter shown in the “judgment ring correction parameter table” includes “item”, “enemy magic”, and “event type”.

Ten types of items (item D to item M) are set in the “item” acting as the judgment ring correction parameter shown in the “judgment ring correction parameter table”. These items will be available when a party of player characters has cleared a predetermined condition on each sub-map. When these items are used in a battle scene or a shop, unlike in a normal state, the display mode of the judgment ring 100 displayed is displayed in a state favorable for the player.

The effects obtained when each item is used will be described.

(1) When item D or item E is used, a timing area range increases twice. That is, the “circle” button 12 becomes easier to operate.

(2) When item F or item G is used, the rotation speed of the rotary bar 101 decreases to ½. That is, the “circle” button 12 becomes easier to operate.

(3) When item H is used, a timing area range increases twice, and the rotation speed decreases to ½.

(4) When item I is used, the rotation speed of the rotary bar 101 varies irregularly, sometimes speeding up and sometimes slowing down, but when the “circle” button 12 has been operated successfully, attack power, i.e., the amount of opponent's damage increases three times, thus providing a very favorable state.

(5) When item J is used, the entire range on the judgment ring 100 becomes a timing area. That is, an operation of the “circle” button 12 at any position of the judgment ring 100 will be successful.

(6) When item K is used, the number of revolutions of the rotary bar 101 becomes a maximum of seven instead of one under normal conditions.

(7) When item L is used, the aforementioned item I becomes effective, and the number of revolutions increases, wherein the amount of opponent's damage increases in response to the number of revolutions used when the “circle” button 12 has been operated successfully.

(8) When item M is used, a timing area is not displayed on the judgment ring 100, but the number of player characters attacking at random and attack power are determined in response to the timing of operation of the “circle” button 12.

The blank sections of this “judgment ring correction parameter table”, in which nothing is described, show that the conditions are all the same as at normal times.

In this way, these items D to M acting as part of the judgment ring correction parameter are acquired, thereby enabling the player to highly favorably develop the game, so that these items are set as rare items which are relatively difficult to acquire.

“Enemy magic” set as part of the judgment ring correction parameter refers to specific enemy magic out of magic possessed by an enemy character (which are called “enemy magic”). When a player character has suffered these enemy magic, the display mode of the judgment ring 100 becomes unfavorable for the player. In this “judgment ring correction parameter table”, six types of enemy magic (enemy magic A to enemy magic F) are set in “magic” acting as part of the judgment ring correction parameter.

The effects obtained when a player character has suffered the respective enemy magic will be described.

(1) When the player character has suffered enemy magic A, a timing area range on the judgment ring 100 decreases to ½.

(2) When the player character has suffered enemy magic B, the rotation speed of the rotary bar 101 increases twice.

(3) When the player character has suffered enemy magic C, the size of the judgment ring 100 decreases to ½.

(4) When the player character has suffered enemy magic D, the size of the judgment ring 100 increases twice, but a timing area range on the judgment ring 100 decreases to ½.

(5) When the player character has suffered enemy magic E, the size of the judgment ring 100 increases twice, but the rotation speed of the rotary bar 101 varies irregularly, sometimes speeding up and sometimes slowing down. In this case, even if the “circle” button 12 has been operated successfully, attack power will not increase three times as in the aforementioned item 1, but it is normal attack power.

(6) When the player character has suffered enemy magic F, a timing area range, the rotation speed of the rotary bar 101, and the size of the judgment ring 100 are determined at random in a range of ½ to twice.

An “event type” set as part of the judgment ring correction parameter is an event in which a party of player characters battles against a specific enemy character, wherein, when the event occurs, the display mode of the judgment ring 100 becomes unfavorable for the player. In this “judgment ring correction parameter table”, four kinds of event types (medium bosses A to C and a final boss) are set in the “event type” acting as part of the judgment ring correction parameter.

The effect obtained when the respective event types occur will be described.

(1) An event type “medium boss A” is an event in which a party of player characters encounters and battles against the “medium boss A” which is a kind of enemy boss character. When this event occurs, the rotation speed of the rotary bar 101 increases twice.

(2) An event type “medium boss B” is an event in which a party of player characters encounters and battles against the “medium boss B” which is a kind of enemy boss character. When this event occurs, a timing area range decreases to ½.

(3) An event type “medium boss C” is an event in which a party of player characters encounters and battles against the “medium boss C” which is a kind of enemy boss character. When this event occurs, a timing area range decreases to ½ and, furthermore, the rotation speed of the rotary bar 101 varies irregularly, sometimes speeding up and sometimes slowing down.

(4) An event type “final boss” is an event in which a party of player characters encounters and battles against the “final boss” which is a kind of enemy boss character. When this event occurs, a timing area range decreases to ½.

As used herein, the term boss character refers to an enemy character, the defeat of whom enables acquisition of a very large number of points as compared to the normal enemy characters. Therefore, as described above, the display mode of the judgment ring 100 becomes difficult for the player to operate.

Judgment Ring Determination Process 2

The aforementioned “judgment ring determination process 2” will be described using FIG. 64.

First, as shown in FIG. 64, by referring to any of the “attack table” (see FIG. 15), “specialty table” (see FIG. 16), and “item table” (see FIG. 17″), the CPU 21 determines a timing area range for each total of action types (ST361). Subsequently, in response to (based on) the judgment ring correction parameter to be described later, the CPU 21 corrects the timing area range determined in the aforementioned ST361, a preset rotation speed and number of revolutions of a rotary bar, and a preset size of a judgment ring (ST362). The CPU 21 will thereby determine a plurality of judgment rings corresponding to a plurality of action types which can be executed by a character who performs a double attack and a double combo attack. If this process ends, the process moves to ST363.

In ST363, the CPU 21 then changes the timing area range into a “double” range. Such a change in timing area will hereafter be described using FIG. 24.

As described above, the timing area determined in ST361 is stored in the RAM 23. As used herein, the term timing area refers to a timing area of a judgment ring corresponding to each plurality of action types which can be executed by one character. Such judgment rings include a physical attack such as shown in FIG. 24A, a magic attack such as shown in FIG. 24B, and item use such as shown in FIG. 24C. In “double” and “double combo”, action types of the same kind cannot be selected, but a combination of action types of different kinds can be selected. Consequently, a combination of action types in “double” and “double combo” includes a combination of physical attack and magic attack such as shown in FIG. 24D, a combination of physical attack and item use, a combination of a plurality of types of magic attacks such as shown in FIG. 24E, a combination of magic attack and item use, and the like.

First, judgment ring determination control in the combination of physical attack and magic attack is based on the shape of the physical attack. The CPU 21 reads out the physical attack timing areas and reduces each timing area to 80% for determination. The CPU 21 then allocates the last timing area 121 event of a determination as to whether magic is to be exercised or not. The CPU 21 thereby determines a “double” timing area range such as shown in FIG. 24D. That is, the CPU 21 will use a judgment ring of one revolution to determine an action result (action result and action process) corresponding to a plurality of (e.g., two) action types which are executed by one character. The CPU 21 exerts judgment ring determination control similarly over the combination of physical attack and item use. Also, the CPU 21 allocates the last timing area 121 even to a determination as to the effect of item use.

Judgment ring determination control in a combination of first class magic attack and second class magic attack is based on the shape of a magic attack having a larger number of timing areas. For example, out of the first class magic attack having a judgment ring with two timing areas and the second class magic attack having a judgment ring with one timing area, the determination control is based on the first class magic attack having a larger number of timing areas. The CPU 21 reads out the timing areas of the first class magic attack and reduces each timing area to 80% for determination. The CPU 21 then allocates the last timing area 122 even to a determination as to whether the second class magic attack is to be exercised or not. The CPU 21 thereby determines a “double” timing area range such as shown in FIG. 24E. That is, the CPU 21 will use a judgment ring of one revolution to determine an action result (action result and action progress) corresponding to a plurality of (e.g., two) action types which are executed by one character.

Additionally, judgment ring determination control in the combination of magic attack and item use is based on the shape of a magic attack. Therefore, the CPU 21 reads out magic attack timing areas and reduces each timing area to 80% for determination. The CPU 21 then allocates the last timing area 121 even to a determination as to the effect of item use. The CPU 21 thereby similarly determines a “double” timing area range such as shown in FIG. 24E. That is, the CPU 21 will use a judgment ring of one revolution to determine an action result (action result and action progress) corresponding to a plurality of (e.g., two) action types which are executed by one character.

That is, the CPU 21 sets a timing area (determination region) based on a plurality of action types selected. Particularly, the CPU 21 will determine the result and progress of a plurality of actions which are based on the selected plurality of action types, in a determination mode corresponding to at least any of the plurality of action types, based on a smaller number of times than the number of times the plurality of action types have been selected. The CPU 21 which executes such a process corresponds to one example of a character action result/progress determination module.

In this way, the result and progress of a plurality of actions, which are based on a plurality of action types selected based on an operational signal, is determined, based on the operational signal, by the determination mode of the result and progress of a smaller number of actions than the number of the plurality of actions. Also, a plurality of action controls based on the determined result and progress of the plurality of actions are executed in accordance with the action order of a plurality of characters. Accordingly, the result and progress of the plurality of actions can be determined, by a determination mode corresponding to at least any of the plurality of action types, based on a smaller number of times than the number of times the plurality of action types have been selected. This can simplify an intricate determination mode and furthermore enables smooth execution of action progress, which can prevent player's interest in the game from decreasing.

Additionally, control is exerted over the display of an action result/progress determination region for determining an action result and progress, a moving region which is displayed in a moving fashion within the action result/progress determination region for a predetermined period, and a determination region which is set within the action result/progress determination region based on a selected character action type. Also, a relatively favorable action result and progress is determined when the current position of a moving region stored in response to an operational signal is in the determination region. Accordingly, a chance to perform an operation as the moving region is displayed in a moving fashion is given to the player so as to provide the player with the relatively favorable action result and progress, whereby a game highly filled with action can be provided, thus making it possible to increase player's interest in the game.

Also, the determination region is set based on a plurality of action types. Accordingly, the determination region can be set in response to action types, such as based on the number of action types, and the determination region can be diversified in response to action types, such as providing a determination region which is easy to operate, or a determination region which is difficult to operate, thus making it possible to increase player's interest in the game.

Furthermore, a plurality of action types are made selectable for one character, and the determination region is set based on the plurality of action types, thereby determining the result and progress of a plurality of actions which are based on the plurality of action types for one character. Accordingly, the action of one character can be diversified, thus making it possible to increase player's interest in the game.

Judgment Ring Determination Process 3

The aforementioned “judgment ring determination process 3” will be described using FIG. 65.

First, as shown in FIG. 65, by referring to any of the “attack table” (see FIG. 15), “specialty table” (see FIG. 16), and “item table” (see FIG. 17″), the CPU 21 determines a timing area range for each total of action types (ST371). Subsequently, in response to (based on) the judgment ring correction parameter to be described later, the CPU 21 corrects the timing area range determined in the aforementioned ST371, a preset rotation speed and number of revolutions of a rotary bar, and a preset size of a judgment ring (ST372). The CPU 21 will thereby determine a plurality of judgment rings corresponding to a plurality of action types which can be executed by a character who performs a combo attack (shortcut). If this process ends, the process moves to ST373.

In ST373, the CPU 21 then changes the timing area range into a “combo shortcut” range. Such a change in timing area will hereafter be described using FIG. 25.

As described above, the timing area determined in ST371 is stored in the RAM 23. As used herein, the term timing area refers to a timing area of a judgment ring corresponding to each plurality of action types which can be executed by a plurality of characters. Such judgment rings include one or a plurality of timing areas, as shown in FIG. 25A.

Thereupon, the CPU 21 determines a judgment ring including a plurality of timing areas, such as shown in FIG. 25A, as a judgment ring including one timing area, such as shown in FIG. 25B. The CPU 21 calculates, for example, the average value of the angular widths of a plurality of timing areas, then determines the angular width of a timing area reduced to 80% from this average value, and determines the start angle of a predetermined timing area. The CPU 21 thereby converts a judgment ring including a plurality of timing areas, such as shown in FIG. 25A, into a judgment ring including one timing area, such as shown in FIG. 25B. Also, the CPU 21 converts a judgment ring relating to character B, as well as judgment rings relating to character A such as shown in FIGS. 25A and 25B, into a judgment ring including one timing area such as shown in FIG. 25C. Instead of such a method, any other method is sufficient as long as a judgment ring including a plurality of timing areas can thereby be converted into a judgment ring including one timing area.

The CPU 21 then calculates the angular width of a new timing area using the following formula.
Value A=angular width of previous timing area×[1375−{125×(nth character)−1}]
Angular width of new timing area=angular width of previous timing area×(value A/1000)

The CPU 21 thus calculates the angular width of the new timing area. The angular width of the new timing area is thereby configured such that an angular width corresponding to a second character is narrower than an angular width corresponding to a first character, and an angular width corresponding to a third character is narrower than the angular width corresponding to the second character. Thus, a subsequent character in “combo” is more difficult to hit. That is, a determination region corresponding to the action result and progress of a subsequent character will be set narrower than a determination region corresponding to the action result and progress of the previous character.

In determination control over a combo (shortcut) attack in which a plurality of action types performed by two characters can be selected, the CPU 21 then calculates value B using the following formula.

In determination control over the combo (shortcut) attack in which a plurality of action types performed by two characters can be selected, the CPU 21 then calculates value B using the following formula.
Value B=[{start angle of timing area+(angular width of timing area/2)}×140/360]+80+[{(nth character)−1}×140]

The CPU 21 then calculates the start angle of a new timing area using the expression of value B−(angular width of timing area/2). When the angular width of a timing area is 133 or more, value B and the start angle of the new timing area are calculated with the timing area angular width set to 133. Also, when there is a 120% region, the CPU 21 determines the range of the 120% region based on the ratio of the timing area angular width and the 120% region.

As shown in FIG. 25D, the CPU 21 thus determines a judgment ring which is used to determine the action result of two characters in “combo (shortcut)”. The CPU 21 thereby similarly determines a “combo (shortcut)” timing area range such as shown in FIG. 25D. That is, the CPU 21 will use a judgment ring of one revolution to determine an action result (action result and action progress) corresponding to a plurality of (e.g., two) action types executed by two characters.

Also, in determination control over a combo (shortcut) attack in which a plurality of action types performed by three characters can be selected, the CPU 21 calculates value B using the following formula.
Value B=[{start angle of timing area+(angular width of timing area/2)}×100/360]+60+[{(nth character)−1}×100]

The CPU 21 then calculates the start angle of a new timing area using the expression of value B−(angular width of timing area/2). When the angular width of a timing area is 95 or more, value B and the start angle of the new timing area are calculated with the timing area angular width set to 95. Also, when there is a 120% region, the CPU 21 determines the range of the 120% region based on the ratio of the timing area angular width and the 120% region.

As shown in FIG. 25E, the CPU 21 thus determines a judgment ring which is used to determine the action result of three characters in “combo (shortcut)”. The CPU 21 thereby similarly determines a “combo (shortcut)” timing area range such as shown in FIG. 25E. That is, the CPU 21 will use a judgment ring of one revolution to determine an action result (action result and action progress) corresponding to a plurality of (e.g., three) action types executed by three characters.

Also, in determination control over a combo (shortcut) attack in which a plurality of action types performed by four characters can be selected, the CPU 21 calculates value B using the following formula.
Value B=[{start angle of timing area+(angular width of timing area/2)}×80/360]+40+[{(nth character)−1}×80]

The CPU 21 then calculates the start angle of a new timing area using the expression of value B−(angular width of timing area/2). When the angular width of a timing area is 76 or more, value B and the start angle of the new timing area are calculated with the timing area angular width set to 76. Also, when there is a 120% region, the CPU 21 determines the range of the 120% region based on the ratio of the timing area angular width and the 120% region.

As shown in FIG. 25F, the CPU 21 thus determines a judgment ring which is used to determine the action result of four characters in “combo (shortcut)”. The CPU 21 thereby similarly determines a “combo (shortcut)” timing area range such as shown in FIG. 25F. That is, the CPU 21 will use a judgment ring of one revolution to determine an action result (action result and action progress) corresponding to a plurality of (e.g., four) action types executed by four characters.

That is, the CPU 21 sets a timing area (determination region) based on a plurality of action types selected. Particularly, the CPU 21 will determine the result and progress of a plurality of actions which are based on the selected plurality of action types, in a determination mode corresponding to at least-any of the plurality of action types, based on a smaller number of times than the number of times the plurality of action types have been selected. The CPU 21 which executes such a process corresponds to one example of the character action result/progress determination module.

In this way, the result and progress of a plurality of actions, which are based on a plurality of action types selected based on an operational signal are determined, based on an operational signal, by the determination mode of the result and progress of a smaller number of actions than the number of the plurality of actions. Also, a plurality of action controls based on the determined result and progress of the plurality of actions are executed in accordance with the action order of a plurality of characters. Accordingly, the result and progress of the plurality of actions can be determined, in a determination mode corresponding to at least any of the plurality of action types, based on a smaller number of times than the number of times the plurality of action types have been selected. This can simplify an intricate determination mode and furthermore enables smooth execution of action progress, which can prevent player's interest in the game from decreasing.

Additionally, control is exerted over the display of an action result/progress determination region for determining an action result and progress, a moving region which is displayed in a moving fashion within the action result/progress determination region for a predetermined period, and a determination region which is set within the action result/progress determination region based on a selected character action type. Also, a relatively favorable action result and progress is determined when the current position of a moving region stored in response to an operational signal is in the determination region. Accordingly, to perform an operation as the moving region is displayed in a moving fashion, a chance is given to the player so as to provide the player with the relatively favorable action result and progress, whereby a game highly filled with action can be provided, thus making it possible to increase player's interest in the game.

Also, the determination region is set based on a plurality of action types. Accordingly, the determination region can be set in response to action types, such as based on the number of action types, and the determination region can be diversified in response to action types, such as providing a determination region which is easy to operate, or a determination region which is difficult to operate, thus making it possible to increase player's interest in the game.

Furthermore, action types are made selectable for each plurality of characters, and the determination region is set based on the plurality of action types, thereby determining the result and progress of a plurality of actions which are based on the plurality of action types performed by the plurality of characters. Accordingly, a plurality of actions among a plurality of characters can be diversified, thus making it possible to increase player's interest in the game.

Judgment Ring Determination Process

The aforementioned “judgment ring determination process” will be described using FIG. 66.

First, as shown in FIG. 66, the CPU 21 determines whether a “circle” button operational signal has been input or not (ST380). If the player has operated the “circle” button 12, in this process, the CPU 21 receives the operational input signal from the input device 4, and will determine that the “circle” button operational signal has been input. If the CPU 21 determines that the “circle” button operational signal has been input, it stores in the RAM 23 the position of the rotary bar 101 in the judgment ring 100 (ST381), and then moves the process to ST382. That is, the CPU 21 and the RAM 23 will store the current position of the rotary bar 101 (moving region) in response to an operational signal from the input device 4. Such a CPU 21 and RAM 23 correspond to one example of a moving region storage module. Conversely, if it is not determined that the “circle” button operational signal has been input, the CPU 21 moves the process to ST387.

In ST 382, it is determined whether or not the rotary bar 101 is on a timing area. In this process, if the CPU 21 has received an operational input signal from the input device 4 by the process of ST380, it will, based on the current position of the rotary bar 101 which has been stored in ST381, determines whether or not the display mode is such that the aforementioned rotary bar 101 is displayed on a timing area of the judgment ring 100. That is, the CPU 21 will determine whether the timing at which the player has operated the “circle” button 12 is a specific timing or not. The CPU 21 which executes such a process corresponds to a consistency determination module which determines the consistency between the timing of an operational input from the input device 4, which has been performed while the display mode of a variable display region is varying, and the aforementioned display mode. If the CPU 21 determines that the rotary bar 101 is on the timing area, it moves the process to ST383. Conversely, if it is not determined that the rotary bar 101 is on the timing area, the CPU 21 moves the process to ST387.

In ST383, it is determined whether or not the rotary bar 101 is on a 120% region. In this process, if the CPU 21 has received an operational input signal from the input device 4 by the process of ST380, it will, based on the current position of the rotary bar 101 which has been stored in ST381, determine whether or not the display mode is such that the aforementioned rotary bar 101 is display on a 120% region of the judgment ring 100. That is, the CPU 21 will determine whether the timing at which the player has operated the “circle” button 12 is a specific timing or not.

If the CPU 21 determines that the rotary bar 101 is on the 120% region, it sets “1.2” in a predetermined region of the RAM 23 as the aforementioned judgment ring correction value (ST384), and then moves the process to ST386. Conversely, if it is not determined that the rotary bar 101 is on the 120% region, the CPU 21 sets “1” in the predetermined region of the RAM 23 as the judgment ring correction value (ST385), and then moves the process to ST386.

In ST386, the process of calculating an amount of damage or a recovery value is executed. In this process, based on the command type, character type, and use item which have been selected, the CPU 21 calculates an amount of damage or a recovery value according to a predetermined formula, and sets this calculation result in a predetermined region of the RAM 23. That is, the CPU 21 will, based on an operational signal from the input device 4 and a plurality of characters data, determine the action result and progress which are based on the action type of a character selected, in accordance with a determination mode which, each time an action type is selected, corresponds to the action type. Also, in other words, if the current position of the rotary bar 101 (moving region) is in a timing area (determination region), the CPU 21 will, out of the plurality of action results and progresses, determine a relatively favorable action result and progress. If this process ends, the process moves to ST387.

In ST387, it is determined whether a judgment ring 100 display end condition has been achieved or not. This end condition refers to any of the conditions (1) that a prescribed number of revolutions (normally, one revolution, and in some cases, the number of revolutions increases depending on a judgment ring correction parameter) has been consumed, and (2) that a prescribed number of observation push operations (normally, three operations, and in some cases, it varies depending on various parameters) has been consumed. The CPU 21 will detect and determine whether such an end condition has been established or not. If the CPU 21 determines that this end condition has been fulfilled, it brings this sub-routine to an end. Conversely, if the CPU 21 does not determine that this end condition has been fulfilled, it moves the process again to ST380.

Particularly, in the case of “double” and “double combo”, the CPU 21 will, by setting a timing area (determination region) based on a plurality of action types selected for one character, determine the result and progress of a plurality of actions which are based on the plurality of action types for the one character. Also, in the case of “combo” (shortcut), the CPU 21 will, by setting a timing area (determination region) based on a plurality of action types selected for a plurality of characters, determine the result and progress of a plurality of actions which are based on the plurality of action types for the plurality of characters.

Combo Establishment Determination Process

The aforementioned “combo establishment determination process” will be described using FIG. 67.

First, as shown in FIG. 67, the CPU 21 determines a combo condition (a condition for continuously and collaboratively executing an action, i.e., a continuation condition and a collaboration condition) has been established or not (ST391). In this process, the CPU 21 will, based on the result of the “judgment ring determination process” executed in ST324 and ST334, determine that the combo condition has been established if the rotary bar 101 has been displayed on all timing areas (valid region) in the judgment ring 100 in response to an operational input signal from the input device 4. If the CPU 21 then determines that the combo condition has been established, it moves the process to ST392. Conversely, if it is not determined that the combo condition has been established, the CPU 21 moves the process to ST396.

In ST392, a combo ring setting process is executed. In this process, the CPU 21 sets a combo ring in response to a selected action (so-called “combo”, “double combo”) type. Specifically, in response to the selected action type, the CPU 21 sets a display mode in which the combo ring is displayed, such as a display time at which the combo ring is displayed and a button image displayed in the combo ring.

The CPU 21 then supplies the image processing section 24 with data relating to the set combo ring, and thereby executes a combo ring display control process (ST393). The image processing section 24 thereby displays the combo ring on the display 16 in the display mode of the combo ring set in ST393. If this process ends, the process moves to ST394.

In ST394, it is determined whether a button signal selected within a time limit has been input or not. If the CPU 21 determines in this process that the button signal selected within the time limit has been input, it moves the process to ST395. Conversely, if it is not determined that the button signal selected within the time limit has been input, the CPU 21 moves the process to ST396. That is, the CPU 21 which executes this process determines whether or not an operational input from the input device 4 has been made within a time limit as a predetermined operation input displayed on the display 16. Also, if this CPU 21 determines that the operational input from the input device 4 has been made within the time limit as the predetermined operational input displayed on the display 16, it means that a predetermined collaboration condition has been established. That is, as one example of the predetermined collaboration condition, it will be determined that an operation input from the input device 4 has been made within a time limit as a predetermined operational input displayed on the display 16.

In ST 395, the process of setting a combo establishment flag to ON is executed. In this process, the CPU 21 sets a combo establishment flag, which is stored on a predetermined region of the RAM 23, to ON, and stores this ON combo establishment flag. The CPU 21 which executes this process makes a setting in such a manner that another player character attacks an enemy character. If this process ends, this sub-routine is brought to an end.

In ST396, the process of setting a combo establishment flag to OFF is executed. In this process, the CPU 21 sets a combo establishment flag, which is stored on a predetermined region of the RAM 23, to OFF, and stores this OFF combo establishment flag. If this process ends, this sub-routine is brought to an end.

Energy Drain Process

The aforementioned “energy drain process” will be described using FIG. 68. This “energy drain process” is invoked if an action type “energy drain” has been successful.

First, as shown in FIG. 68, the CPU 21 determines whether or not a player character is in a specific state (ST501). In this process, the CPU 21 will, depending on whether or not data indicates that a state flag in the RAM 23 is in a specific state, determine whether or not a player character is in a specific state. If the CPU 21 determines that the player character is in the specific state, it brings this sub-routine to an end without executing ST502 to ST505. If the player character is in the specific state, the action type itself of “energy drain” cannot be selected, thus resulting in a control such that this process cannot be executed. However, as a precautionary measure, this process is executed, thereby absolutely preventing addition of a calorie from being executed. Conversely, if the CPU 21 determines that the player character is not in the specific state, it moves the process to ST502.

In ST502, the CPU 21, by referring to the character data table (see FIG. 4), extracts a calorie of an enemy character targeted for an attack. Based on the calorie of the enemy character, the CPU 21 then calculates a calorie to be added (ST503). In this process, the CPU 21 reads from the RAM 23 the number of times (the number of enemy characters on which)“energy drain” has been executed since this battle scene has started. The CPU 21 then calculates a numerical value, which is obtained by dividing a calorie itself corresponding to the enemy character by the number of times (the number of enemy characters on which)“energy drain” has been executed, as the calorie to be added. Subsequently, in ST504, the CPU 21, by updating the character table (see FIG. 4), adds the calculated calorie to a calorie corresponding to the player character. The CPU 21 then updates the number of times (the number of enemy characters on which)“energy drain” has been executed. That is, the CPU 21 which executes such a process will, on condition that the action mode of a player character against an enemy character has been selected based on an operational signal from the input device 4, add a calorie (specific data) corresponding to the enemy character to a calorie (player character state data) corresponding to the player character. In this embodiment, the CPU 21 which executes such a process corresponds to one example of a player character state data addition module. If this process ends, the process moves to ST505.

In ST505, based on the calorie of the player character, the CPU 21 determines the state of the player character as being changeable. In this process, the CPU 21 reads out the calorie of the player character which results from the addition in ST504. The CPU 21 then, by referring to the player character state setting table (see FIG. 10), determines the state of the character as being changeable. Also, the CPU 21, if changing the state of the player character based on the calorie of the player character, sets a state flag on data indicative of a state. The state of the player character will thereby be changed after such an action type of “energy drain” ends. Particularly, if the calorie of the player character is +100 or higher or −100 or lower, then in order to change the state of the player character to the state of “super glamour” or “super slim” (specific state), the CPU 21 sets the state flag on data indicative of a specific state. The CPU 21 will thus, for example, based on a calorie (player character state data) out of the player character data stored in the RAM 23 (i.e., based on a predetermined change condition), change the state of the player character which has been previously determined in this process. In other words, the CPU 21 will, based on the result obtained by the addition in ST504, change (determine) the state of a player character. Particularly, the CPU 21 will, for example, on condition that a calorie (player character state data) has reached a predetermined value (e.g., +100 or −100) and so on, change the state of a player character to a relatively favorable specific state. In this embodiment, the CPU 21 which executes such a process corresponds to one example of a player character state determination module and a player character state change module. If this process ends, this sub-routine is brought to an end.

Calorie Initialization Process

The aforementioned “calorie initialization process” will be described using FIG. 69. This “calorie initialization process” is invoked when a player character who can execute “energy drain” takes a turn at performing an action.

First, as shown in FIG. 69, the CPU 21 determines whether or not a player character has turned into a specific state and has performed a predetermined number of (e.g., five) battles (ST511). In this process, the CPU 21 will, depending on whether or not a player character who can execute “energy drain” has encountered a predetermined number of battle scenes after the player character has turned into the specific state, determines whether or not the player character has turned into the specific state and has performed the predetermined number of battles. If the CPU 21 determines that the player character who can execute “energy drain” has turned into the specific state and has performed the predetermined number of battles, it moves the process to ST512. Conversely, if the CPU 21 determines that the player character who can execute “energy drain” has not turned into the specific state but, or has turned into the specific state and has not performed the predetermined number of battles, it brings this sub-routine to an end without executing ST512 or ST513.

In ST512, a player character's calorie is initialized (set to “0”). In this process, the CPU 21 will, on condition that a player character's calorie (player character state data) has reached a predetermined value and the player character has turned into a specific state, change the player character's calorie to the initial value. In this embodiment, the CPU 21 which executes such a process corresponds to one example of an initial value change module. The CPU 21 then, based on the player character's calorie changed to the initial value, determines the player character's state as being changeable (ST513). In this process, based on a calorie corresponding to the player character's calorie changed to the initial value in ST512, the CPU 21 changes the player character's state (e.g., “pink bat” state). Also, the CPU 21 set a state flag as data indicating a player character's state to be changed. The player character's state will thereby be changed after such an action type of “energy drain” ends. Particularly, in the case where the player character's calorie has reached “0” and the player character's state is changed to “pink bat” state (specific state), the CPU 21 sets the state flag to data indicative of the initial state. The CPU 21 will thus, based on a calorie (player character state data) corresponding to the player character stored in the RAM 23, change the player character's state previously determined in this process. In this embodiment, the CPU 21 which executes such a process corresponds to one example of a player character state determination module and the player character state change module. If this process ends, this sub-routine is brought to an end.

In this embodiment, control is exerted such that “energy drain” itself cannot be executed on the same enemy character, but the invention is not limited to this configuration. For example, control may be exerted such that “energy drain” itself can be executed on the same enemy character. Also, in this embodiment, a numerical value obtained by dividing a calorie itself corresponding to an enemy character by the number of times (the number of enemy characters on whom)“energy drain” has been executed is calculated as a calorie to be added. However, the invention is not limited to this configuration. For example, instead of depending on the number of times (the number of enemy characters on whom)“energy drain” has been executed after this battle scene has started, the calorie itself corresponding to the enemy character may be calculated as a calorie to be added.

In this way, on condition that a player character action mode against an enemy character has been selected based on an operational signal from the operating device, specific data corresponding to the enemy character is added to player character state data, and a player character's state is changed based on the addition result. Accordingly, since the condition is such that a player character action mode against an enemy character has been selected based on an operational signal from the operating device, the player can purposefully perform the addition of the player character state data in response to the action mode against the enemy character. Furthermore, since specific data corresponding to an enemy character targeted for an action mode is added, for example, specific data differing according to an enemy character type will be added. Consequently, it is possible to arbitrarily and easily change a player character's state while executing an action corresponding to an enemy character.

Also, on condition that player character state data has reached a predetermined value, the player character state data is changed to the initial value, and a player character's state is changed to a relatively favorable specific state. Accordingly, the player purposefully set changes player character state data to a relatively favorable specific state by setting it to the initial value, and player character state data is changed to the initial value. This can therefore harmonize a change to a specific state with a limitation on a specific state, thus making it possible to provide a strategic game.

Magic Plate Setting Process

The aforementioned “magic plate setting process” will be described using FIG. 70. This “magic plate setting process” is invoked when a magic setting operation has been performed in ST21 and the like.

First, as shown in FIG. 70, the CPU 21 determines whether or not a magic plate is ready to be set (ST600). If the CPU 21 determines in this process that the magic plate is ready to be set, it moves the process to ST601. Conversely, if the CPU 21 determines that the magic plate is not ready to be set, it brings this sub-routine to an end without executing ST601 to ST606. In this embodiment, if a magic plate setting menu has been selected, it will be determined that the magic plate is ready to be set.

In ST601, the CPU 21 refers to the character table, magic plate setting table (see FIG. 8), and magic stone setting table (see FIG. 9). The CPU 21 then executes a magic plate/magic stone display control process (ST602). In this process, based on the reference result, the CPU 21 supplies the image processing section 24 with data which is based on the magic plate setting table (see FIG. 8) and magic stone setting table (see FIG. 9). The image processing section 24 thereby exerts control to display on the display 16 the shape (shape type, size, and the like) of a magic plate related to a character, a shape relating to a magic stone related to the magic plate, and an image relating to additional power and the like. That is, the CPU 21, image processing section 24, and the like will exert control to display the region of a shape, which corresponds to the type of a region (addition power data) of the magic plate, and the shape of at least any of a plurality of types of magic stones (power objects). In this embodiment, the CPU 21, image processing section 24, and the like, which execute such a process, correspond to one example of a region display control section and a power object display control section. If this process ends, the process moves to ST603.

In ST603, the CPU 21 determines whether a magic plate change operation has been performed or not. If, in this process, the CPU 21 determines, in response to an operational signal from the input device 4, that the magic plate change operation has been performed, then it moves the process to ST604. Conversely, if the CPU 21 determines, in response to the operational signal from the input device 4, that the magic plate change operation has not been performed, it brings this sub-routine to an end without executing ST604 to ST606.

In ST604, the CPU 21 executes a character table/magic plate setting table change process. In this process, in response to an operational signal from the input device 4, the CPU 21 changes the type of a magic plate set for each character in the character data table (see FIG. 4) (including a type not set therein) and the type of a magic stone set in each region of the magic plate in the magic plate setting table (see FIG. 8) (including a type not set therein). As described later in detail, in ST606, addition power data corresponding to such settings of a magic plate and a magic stone will be added to character data relating to a character. That is, there are a plurality of types of magic plates (additional power data determination modules) which differ in any of the number, shape size, and shape type of regions, the CPU 21 will set any of the plurality of types of magic plates, relating it to a character.

Also, the CPU 21 will, based on an operational signal from the input device 4, determine additional power data to be added to character data. In other words, the CPU 21 will, on condition that a magic stone (power object) has been set in a region of a magic plate, determine additional power data corresponding to the region as additional power data to be added to character data.

Particularly, in order to change the type of a magic stone set in each region of a magic plate, the CPU 21 compares the shape (shape type, size, and the like) of a region in the magic plate setting table and the shape (shape type, size, and the like) of a-magic stone in the magic stone setting table. If the region and the magic stone are the same in shape type and the magic stone is of a size smaller than or equal to that of the shape of the region, the CPU 21 determines that the magic stone can be set in the region. That is, the CPU 21 will, on condition that a magic stone (power object) smaller than or equal to the size of a region has been set in the region, determine additional power data, which corresponds to the size of a magic stone related to the region, as additional power data to be added to character data.

Also, the CPU 21 will, on condition that a magic stone (power object) corresponding to the shape of a region of the magic plate has been set in the region, determine additional power data, which corresponds to the type of the power object, as additional power data to be added to character data. In this embodiment, the CPU 21 which executes such a process corresponds to one example of a plurality of types of additional power data determination modules and additional power data setting modules.

The CPU 21 then executes a table change display control process (ST605). In this process, the CPU 21 supplies the image processing section 24 with data which indicates the magic plate setting for each character and the magic stone setting for each magic plate which have been changed in ST604. The image processing section 24 then exerts control to display on the display 16 the changed magic plate setting for each character and magic stone for each magic plate. Specifically, the CPU 21 exerts control to display on the display 16 the shape (shape type, size, and the like) of a magic plate related to a character, a shape (shape type, size, and the like) relating to a magic stone related to the magic plate, and an image relating to additional power and the like. That is, the CPU 21, image processing section 24, and the like will exert control to display the region of a shape, which corresponds to the type of a region (addition power data) of the magic plate, and the shape of at least any of a plurality of types of magic stones (power objects). In this embodiment, the CPU 21, image processing section 24, and the like, which execute such a process, correspond to one example of the region display control section and power object display control section. If this process ends, the process moves to ST606.

In ST606, the CPU 21 executes a character's individual power addition process. In this process, by referring to the characters' individual powers (see FIGS. 3A and 3B), character data table (see FIG. 4), magic plate setting table (see FIG. 8), magic stone setting table (see FIG. 9), and the like, the CPU 21 adds additional power data, which relates to the magic stone of a magic plate set on a character set based on the setting of ST604, to character's individual power and character data relating to the set character. The CPU 21 then sets data obtained by the addition in the RAM 23, and thereby adds addition power data to the character. That is, the CPU 21 will, based on the magic stone (additional power data) of the magic plate (additional power data determination module) determined in ST604 and character data relating to the character which has been set by relating it to the magic stone in ST604, determine the power of the character. The CPU 21 which executes such a process corresponds to one example of a character power determination module. If this process ends, this sub-routine is brought to an end.

Magic Plate Editing Process

The aforementioned “magic plate editing process” will be described using FIG. 71. This “magic plate editing process” is invoked if a magic plate editing operation has been performed in ST21 and the like.

First, as shown in FIG. 71, the CPU 21 determines whether or not a magic plate is ready to be edited (ST610). If the CPU 21 determines that the magic plate is ready to be edited, it moves the process to ST601. Conversely, if the CPU 21 determines that the magic plate is not ready to be edited, it brings this sub-routine to an end without executing ST611 to ST615. In this embodiment, if a predetermined amount of money is possessed at a magic plate arranging shop, it will be determined that the magic plate is ready to be edited.

In ST611, similar to ST601, the CPU 21 refers to the character table, magic plate setting table (see FIG. 8), and magic stone setting table (see FIG. 9). The CPU 21 then, as in the case of ST602, executes a magic plate/magic stone display control process (ST612). In this process, based on the reference result, the CPU 21 supplies the image processing section 24 with data which is based on the magic plate setting table (see FIG. 8) and magic stone setting table (see FIG. 9). The image processing section 24 thereby exerts control to display on the display 16 the shape (shape type, size, and the like) of a magic plate related to a character, a shape (shape type, size, and the like) relating to a magic stone related to the magic plate, and an image relating to additional power and the like. That is, the CPU 21, image processing section 24, and the like will exert control to display the region of a shape, which corresponds to the type of a region (addition power data) of the magic plate, and the shape of at least any of a plurality of types of magic stones (power objects). In this embodiment, the CPU 21, image processing section 24, and the like, which execute such a process, correspond to one example of the region display control section and power object display control section. If this process ends, the process moves to ST613.

In ST613, the CPU 21 determines whether a magic plate editing operation has been performed or not. If, in this process, the CPU 21 determines, in response to an operational signal from the input device 4, that the magic plate editing operation has been performed, then it moves the process to ST614. Conversely, if the CPU 21 determines, in response to the operational signal from the input device 4, that the magic plate editing operation has not been performed, it brings this sub-routine to an end without executing ST614 or ST615.

In ST614, the CPU 21 executes a magic plate table editing process. In this process, the CPU 21, in response to an operational signal, changes the shape (shape type, size, and the like) of each region of a magic plate, in the magic plate setting table (see FIG. 8). That is, the CPU 21 will change the shape type and size of a region of a magic plate (additional power data determination module). In this embodiment, the CPU 21 which executes such a process corresponds to one example of a region size change module and a region shape type change module.

The CPU 21 then executes a table editing display control process (ST615). In this process, the CPU 21 supplies the image processing section 24 with data indicating the magic plate shape (shape type, size, and the like) changed in ST614. The image processing section 24 then exerts control to display the changed magic plate shape (shape type, size, and the like) on the display 16. That is, the CPU 21, image processing section 24, and the like will exert control to display the shape (shape type, size, and the like) of a region of a magic plate. In this embodiment, the CPU 21, image processing section 24, and the like which execute such a process correspond to one example of the region display control section. If this process ends, this sub-routine is brought to an end.

In this way, control is exerted to display a region of a shape corresponding to the type of additional power data and the shape of a power object, and on condition that a power object corresponding to the shape of the region has been set in the region, addition power data corresponding to the type of the power object is determined as additional power data to be added to character data. Accordingly, the shape of the region is related to the shape of the power object, thereby determining additional power data corresponding to the power object, so that any player can easily recognize relation and can easily customize a player character, thus making it possible to increase player's interest in the game.

Additionally, additional power data, which corresponds to the size of a power object and becomes relatively favorable for a character pursuant to the size of the power object, is stored, and the size of a region can be changed. Also, additional power data is determined in response to the size of a power object which is smaller than or equal to the size of a region and is related to the region. Accordingly, since additional power data is made relatively favorable for a character pursuant to the size of a power object, a more favorable power object can be set by changing the size of a region, so that a player character can be customized, thus making it possible to increase player's interest in the game. Also, since additional power data is determined in response to the size of a power object corresponding to the region, any player can easily recognize the size of a power object and can easily customize a player character, thus making it possible to increase player's interest in the game.

Furthermore, the shape type of a region can be changed. Accordingly, the type of additional power data can easily be changed, thus making it possible to increase player's interest in the game.

Additionally, there are provided a plurality of types of additional power data which are different in at least any of the number, shape size, and shape type of regions, and any of them are set related to a character. Also, based on character data and additional power data relating to the set character, power of the character is set. Accordingly, the additional power data of the additional power data determination module can be customized for each character, so that additional power data of a character can be diversified, thus making it possible to increase player's interest in the game.

Furthermore, additional power data for changing the increase/decrease ratio of character data to a character action mode is stored, and on condition that the power object of the character has been set in a region, additional power data corresponding to the region is determined as additional power data to be added to the character. Accordingly, additional power data for changing the increase/decrease ratio of character data to a character action mode is set, thereby making it possible to change the increase/decrease ratio of character data to a character action mode. Therefore, character's additional power data can be diversified, thus making it possible to increase player's interest in the game.

Grouping Process

The aforementioned “grouping process” will be described using FIG. 72. This “grouping process” is invoked in a group setting operation which has been performed in ST21 and the like.

First, as shown in FIG. 72, the CPU 21 determines whether a group setting operation has been performed or not (ST701). If the CPU 21 determines that the group setting operation has been performed, then in response to an operational signal from the input device 4, it executes a grouping table (see FIG. 6) change process (ST702). In this process, the CPU 21 will, by updating the grouping table in response to the operational signal from the input device 4, classify a plurality of characters into battle group members (characters in the first group) and standby group members (characters in the second group). Also, the CPU 21 can store the classification into the battle and standby group members as a plurality of types of groups, such as, for example, group A, group B, and group C. If this process ends, this sub-routine is brought to an end. Conversely, if the CPU 21 determines, in response to the operational signal from the input device 4, that no group setting operation has been performed, it brings this sub-routine to an end without executing ST702.

Group Selection Process

The aforementioned “group selection process” will be described using FIG. 73. This “group selection process” is invoked if a group selection operation has been performed in ST21 and the like.

First, as shown in FIG. 73, the CPU 21 determines whether a group selection operation has been performed or not (ST711). If the CPU 21 determines, in response to an operational signal from the input device 4, that the group selection operation has been performed, it executes a group flag change process (ST712). In this process, the CPU 21, in response to an operational signal from the input device 4, set a group flag in the RAM 23 as being changeable. Specifically, in order to change the group flag from group C to group A which are set in the grouping table (see FIG. 6), the CPU 21 changes the group flag from data indicating group C to data indicating group A. The CPU 21 will thereby, based on an operational signal from the input device 4, select any grouping pattern from a plurality of grouping patterns, and based on the selected grouping pattern, classify a plurality of characters into a battle group (first group) and a standby group (second group). That is, the CPU 21 will, based on an operational signal from the input device 4, classify the plurality of characters into the battle group (first group) and the standby group (second group). In this embodiment, the CPU 21 which executes such a process corresponds to one example of a character grouping module and a grouping pattern selection module. If this process ends, this sub-routine is brought to an end. Conversely, if the CPU 21 determines, in the operational signal from the input device 4, that no group selection operation has been performed, it brings this sub-routine to an end without executing ST702.

In this way, a plurality of grouping patterns each including a plurality of characters are stored, and any grouping pattern is selected from the plurality of grouping patterns. Based on the selected grouping pattern, the plurality of characters are classified into the first group and the second group. Accordingly, any grouping pattern can be selected from the plurality of grouping patterns, which enables easy and smooth classification of groups in response to the power and state of a character, the progress of the game, and the like, so that the game can be enjoyed simply and strategically.

Status Display Control Process

The aforementioned “status display control process” will be described using FIG. 74. This “status display control process” is invoked when a status display operation has been performed in ST21 and the like.

First, as shown in FIG. 74, the CPU 21 determines whether a status display operation has been performed or not (ST721). If, in this process, the CPU 21 determines, in response to an operational signal from the input device 4, that the status display operation has been performed, then it moves the process to ST722. Conversely, if the CPU 21 determines, in response to the operational signal from the input device 4, that no status display operation has been performed, it brings this sub-routine to an end without executing ST722 to ST726.

In ST722, the CPU 21 reads a group flag from the RAM 23 and, based on the group flag, selects any group from a plurality of groups. The CPU 21 then, by referring to the grouping table, determines a character belonging to the battle group and a character belonging to the standby group (ST723). Thereafter, the CPU 21, by referring to the display item setting table (see FIG. 7), identifies item data to be extracted by the battle group and item data to be extracted by the standby group, and then extracts the item data of the character belonging to the battle group (ST724) while extracting the item data of the character belonging to the standby group (ST725). In the display item setting table (see FIG. 7), item data to be extracted by the battle group and item data to be extracted by the standby group are different in the type and number of items to be extracted. If this process ends, the process moves to ST726.

In ST726, the CPU 21 supplies various data to the image processing section 24 and thereby executes an item data display control process. The CPU 21 supplies the image processing section 24 with the extracted item data relating to the character of the battle group, the extracted item data relating to the character of the standby group, and the like. The image processing section 24 thereby displays the extracted item data relating to the character of the battle group in the first display region 16a (see FIGS. 43A to 44B) on the display 16, and displays the extracted item data relating to the character of the standby group in the second display region 16b (see FIGS. 43A to 44B) on the display 16.

The CPU 21, image processing section 24, and the like will thus, based on a plurality of item data stored, exert control to display a plurality of item data, for each plurality of characters, in a predetermined display region. Also, in other words, the CPU 21, image processing section 24, and the like exert control to differentiate the number of pieces of item data between the first display region, which displays item data corresponding to a first character classified as the battle group (first group), and the second display region, which displays item data corresponding to a second character classified as the standby group (second group). Particularly, the CPU 21, image processing section 24, and the like will exert control to display item data corresponding to the first character, in the first display region, with a larger number of pieces of item data than in the second display region. In this embodiment, the CPU 21, image processing section 24, and the like which execute such a process correspond to one example of a character data display control section. If this process ends, this sub-routine is brought to an end.

The number of pieces of item data is thus made different between the first display region, which displays item data corresponding to a first character classified as the first group, and the second display region, which displays item data corresponding to a second character classified as the second group. Accordingly, item data to be displayed can be made different according to the type, state, and the like of characters, such as the first character and the second character, so that a plurality of item data can be displayed in a display mode in which a display region has been effectively utilized. Consequently, unnecessary item data which varies depending on the type and state of a character can be omitted, thus enabling display in a more easily viewable display mode.

Also, to exert action control over the first character based on a larger number of pieces of item data than that of the second character, item data corresponding to the first character is displayed in the first display region, with a larger number of pieces of item data than that in the second display region. Accordingly, a larger number of pieces of item data can be displayed for a character over which action control is exerted based on a relatively large number of pieces of item data. Consequently, unnecessary item data which varies depending on the type and state of a character can be omitted, thus enabling display in a still more easily viewable display mode.

Program

Additionally, the aforementioned game program will be described in detail. This game program is used to make a computer function, specifically, as the following modules. In other words, the game program is used to make the computer execute the following modules (processes, steps). Also, the game program is used to make the following processes act as various functions and to make the computer actualize the functions. Furthermore, such a computer includes an operating device capable of being operated by the player, a display device which displays an image relating to the game, and the like.

(A1) A character data storage module (process) which stores a plurality of character data relating to a plurality of characters.

(A2) A character action order determination module (process) which determines the action order of the plurality of characters.

(A3) A character action mode selection module (process) which selects a character action mode based on an operational signal from the operating device and the plurality of character data.

(A4) A character action control section (control process) which exerts control over a character's action based on the character action mode selected by the character action mode selection module.

(A5) A special character action control section (control process) which carries out the character action mode selection by the character action mode selection module and the character action control by the character action control section in accordance with the action order of the plurality of characters which has been determined by the character action order determination module.

(A6) A module (process) which, in the character action mode selection module, makes selectable a character action connection mode for bringing a connection to a character action to be performed in a subsequent turn.

(A7) A module (process) which, in the character data storage module, stores an action value, which varies based on the action control exerted by the character action control section, for each plurality of characters.

(A8) A module (process) which, in the character action mode selection module, makes the character action connection mode selectable on condition that the action value has reached a predetermined value.

(A9) A module (process) which, in the special character action control section, when the character action connection mode has been selected as a character action mode by the character action mode selection module, carries out the character action control, which is based on the character action connection mode, before the next action mode of the character is selected.

(A10) A module (process) which, in the character action mode selection module, makes selectable a character combined action mode, which includes a plurality of action modes combined, on condition that the action value has reached a predetermined value.

(A11) A module (process) which, in the special character action control section, when the character combined action mode has been selected as a character action mode by the character action mode selection module, carries out the character action control, which is based on the character combined action mode, before the next action mode of the character is selected.

(A12) A module (process) which, in the character action mode selection module, makes selectable a character combined action connection mode, which includes a plurality of action modes combined and brings a connection to a character action to be performed in a subsequent turn, on condition that the action value has reached a specific value which is greater than the predetermined value.

(A13) A module (process) which, in the special character action control section, when the character combined action connection mode has been selected as a character action mode by the character action mode selection module, carries out the character action control, which is based on the character combined action connection mode, before the next action mode of the character is selected.

(A14) A module (process) which, in the character data storage module, when the character action connection mode has been selected by the character action mode selection module, stores an action value reduced to a prescribed value.

(A15) A module (process) which, in the character data storage module, when the character combined action mode has been selected by the character action mode selection module, stores an action value reduced to a prescribed value.

(A16) A module (process) which, in the character data storage module, when the character combined action connection mode has been selected by the character action mode selection module, stores an action value, reducing it to a prescribed value.

(A17) A character action type selection module (process) which selects a character's action type based on the operational signal from the operating device and the plurality of character data.

(A18) A character action result/progress determination module (process) which determines the result and progress of an action, which is based on the character action type which has been selected by the character action type selection module based on the operational signal from the operating device and the plurality of character data, by a determination mode corresponding to the action type, each time the action type is selected.

(A19) A character action control section (control process) which exerts character action control based on the action result and progress which have been determined by the character action result/progress determination module.

(A20) A special character action control section (control process) which carries out the action result/progress determination by the character action result/progress determination module and the character action control by the character action control section, in accordance with the action order of a plurality of characters which has been determined by the character action order determination module.

(A21) A module (process) which, in the character action result/progress determination module, determines the result and progress of a plurality of actions, which are based on a plurality of action types which have been selected by the character action type selection module, by a determination mode corresponding to at least any of the plurality of action types, and by a smaller number of times than the number of times the plurality of action types have been selected.

(A22) A display control section (control process) which, in the character action result/progress determination module, exerts control to display an action result/progress determination region for determining an action result and progress, a moving region which is displayed in a moving fashion within the action result/progress determination region for a predetermined period, and a determination region which is set within the action result/progress determination region based on a character action type selected by the character action type selection module.

(A23) A moving region storage module (process) which, in the character action result/progress determination module, stores the current position of the moving region in response to an operational signal from the operating device.

(A24) A module (progress) which, in the character action result/progress determination module, when the current position of the moving region which has been stored in the moving region storage module is in the determination region, determines a relatively favorable action result and progress out of a plurality of action results and progresses.

(A25) A module (process) which, in the character action result/progress determination module, sets the determination region based on a plurality of action types selected by the character action type selection module.

(A26) A module (process) which, in the character action type selection module, makes a plurality of action types selectable for one character.

(A27) A module (process) which, in the character action result/progress determination module, by setting a determination region based on a plurality of action types selected for one character by the character action type selection module, determines the result and progress of a plurality of actions which are based on a plurality of action types for one character.

(A28) A module (process) which, in the character action type selection module, makes an action type selectable for each plurality of characters.

(A29) A module (process) which, in the character action result/progress determination module, by setting a determination region based on a plurality of action types selected for a plurality of characters by the character action type selection module, determines the result and progress of a plurality of actions which are based on a plurality of action types for a plurality of characters.

(A30) A character data storage module (process) which stores a plurality of item data for each plurality of characters.

(A31) A character data display control section (control process) which exerts control to display a plurality of item data in a predetermined display region for each plurality of characters based on the plurality of item data stored by the character data storage module.

(A32) A character grouping module (process) which classifies a plurality of characters into a first group and a second group based on an operational signal from the operating device.

(A33) A module (process) which, in the character data display control section, differentiates the number of pieces of item data between a first display region, which displays item data corresponding to the first character classified as the first group, and a second display region, which displays item data corresponding to the second character classified as the second group.

(A34) A character action control section (control process) which exerts character action control based on the plurality of characters data stored in the character data storage module.

(A35) A first character action control section (control process) which exerts action control of the first character classified as the first group, based on a larger number of pieces of item data than that of the second character classified as the second group.

(A36) A module (process) which, in the character data display control section, exerts control to display item data corresponding to the first character, in the first display region, with a larger number of pieces of item data than that in the second display region.

(A37) A grouping pattern storage module (process) which stores a plurality of grouping patterns each for a plurality of characters.

(A38) A grouping pattern selection module (process) which, in the character grouping module, selects any grouping pattern from the plurality of grouping patterns stored in the grouping pattern storage module, based on an operational signal from the operating device.

(A39) A module (process) which, in the character grouping module, classifies a plurality of characters into a first group and a second group based on the grouping pattern selected by the grouping pattern selection module.

(A40) A character data storage module (process) which stores character data relating to a character.

(A41) An additional power data storage module (process) which stores addition power data to be added to character data.

(A42) An additional power data determination module (process) which determines additional power data to be added to character data, based on an operational signal from the operating device.

(A43) A character power determination module (process) which determines character power based on the character data stored in the character data storage module and the additional power data determined by the additional power data determination module.

(A44) A module (process) which, in the additional power storage module, stores a plurality of types of additional power data classified by a type.

(A45) A module (process) which, in the additional power storage module, stores a plurality of types of power objects which are classified by a shape corresponding to the type and are used to determine character power.

(A46) A region display control section (control process) which exerts control to display a region of a shape corresponding to the type of the additional power data.

(A47) A power object display control section (control process) which exerts control to display the shape of at least any of the plurality of types of power objects.

(A48) A module (process) which, in the additional power data determination module, on condition that a power object corresponding to the shape of the region has been set in the region, determines additional power data, which corresponds to the type of the power object, as additional power data to be added to character data.

(A49) A module (process) which, in the additional power data storage module, stores additional power data which corresponds to the size of a power object and is made relatively favorable for a character pursuant to the size of the power object.

(A50) A region size change module (process) which changes the size of the region.

(A51) A module (process) which, in the additional power data determination module, on condition that a power object of a size corresponding to the size of the region or smaller has been set in the region, determines additional power data, which corresponds to the size of the power object related to the region, as additional power data to be added to character data.

(A52) A region shape type change module (process) which changes the shape of the region.

(A53) A plurality of types of the additional power data determination modules (processes) which are different in at least any of the number, shape size, and shape type of regions.

(A54) An additional power data setting module (process) which sets any of the plurality of types of additional power data determination modules, relating it to a character.

(A55) A module (process) which, in the character power determination module, determines character power based on character data, which relates to characters set related to one another by the additional power data setting module, and additional power data of the additional power data determination module, which has been set related to the characters by the additional power data setting module.

(A56) A player character data storage module (process) which stores player character data relating to a player character.

(A57) An enemy character data storage module (process) which stores enemy character data relating to an enemy character.

(A58) A player character state determination module (process) which determines a player character state based on the player character data stored by the player character data storage module.

(A59) A character action mode selection module (process) which selects a player character action mode based on an operational signal from the operating device and the player character state determined by the player character state determination module.

(A60) A character action control section (control process) which exerts player character action control based on the player character action mode selected by the character action mode selection module.

(A61) A player character state change module (process) which, based on a predetermined change condition, changes the player character state determined by the player character state determination module.

(A62) A module (process) which, in the enemy character data storage module, stores specific data for each enemy character.

(A63) A module (process) which, in the player character data storage module, stores player character state data relating to a player character state.

(A64) A player character state data addition module (process) which, in the character action mode selection module, on condition that a player character action mode against an enemy character has been selected based on an operational signal from the operating device, adds specific data corresponding to the enemy character to player character state data.

(A65) A module (process) which, in the player character state change module, changes a player character state based on the result of the addition by the player character state data addition module.

(A66) An initial value change module (process) which, on condition that the player character state data has reached a predetermined value, changes the player character state data to an initial value.

(A67) A module (process) which, in the player character state change module, on condition that the player character state data has reached a predetermined value, changes a player character state to a relatively favorable specific state.

Recording Medium

Additionally, as a computer-readable recording medium with such a game program recorded therein may store, other than the aforementioned game program, a power parameter and a possessed item parameter for each plurality of characters.

### Other Embodiments

The embodiment has been described above, but the invention is not limited to this embodiment. For example, the input device 4 which the player operates may be integrated with the apparatus body 1.

Additionally, in this embodiment, the configuration is such that, after all the characters appearing in a “battle scene” have executed their actions, a turn order in which the actions of all the characters are to be executed is determined again. However, the invention is not limited to this configuration, and may adopt another configuration. For example, the configuration may be such that, before all the characters execute their actions, a character who has finished executing an action executes the next action.

Furthermore, the invention can similarly be applied to a portable gaming apparatus or a desktop gaming apparatus which integrally includes a player-operable operating device, a display device for displaying an image and a sound, a storage module for storing a game program, and a control section for executing a control process in accordance with the game program.

Still furthermore, the invention can also be applied to a so-called network game in which a game can be performed in such a manner that the game program is stored in a server apparatus linked to a network such as an Internet 56 (see FIG. 75) and is linked to the server apparatus from a personal computer, a cellular telephone, a Personal Digital Assistant (PDA), or the like.

One example will be described using a network gaming system of FIG. 75. In this network gaming system, a cellular telephone 53A, 53B, 53C acting as a terminal on which the game is performed is linked via a base station 52A, 52B to, for example, a PDC network 51 capable of packet communication connection, thus accessing an information center 55 via this PDC network 51 in response to a player's operation and a gaming state. The information center 55, in response to a request from the cellular telephone 53A, 53B, 53C, acquires various information via a network, such as the Internet 56, from a server 57A, 57B having stored therein data and the like, which are necessary for the game, in addition to the game program, and transmits information necessary for the game to the cellular telephone 53A, 53B, 53C. As in the case of a server 58 in FIG. 75, the configuration may be such that a server storing game data and the like are connected to the information center 55 by a specified or dedicated communication line 60 instead of via a network such as the Internet 56.

As a method in which the player executes the game, a game program is pre-downloaded to the cellular telephone 53A, 53B, 53C from the server 57A, 57B, and the game program is executed on the cellular telephones 53A, 53B, 53C body. In addition, various methods can be considered, such as the method of causing the cellular telephone 53A, 53B, 53C to bear a so-called browser-like role in which the game program is executed on the server 57A, 57B in accordance with a command from the cellular telephone 53A, 53B, 53C, while the game contents are browsed on the cellular telephone 53A, 53B, 53C. Also, the configuration may be such that cellular telephones are linked to each other using the PDC network 51, and such that players can thus share this gaming system or take on each other at a game.

In this embodiment, the configuration is such that there are provided the judgment ring 100 including the reference region and the rotary bar 101 acting as the variable region. However, the invention is not limited to this configuration, and may adopt another configuration. For example, the configuration may be such that the judgment ring is used as the variable region and a region such as the rotary bar is used as the reference region. That is, the reference region or the variable region will be formed to include a plurality of valid regions which are relatively favorable for the player and an invalid region which is relatively unfavorable for the player. Also, it is not necessary to use such a judgment ring.

Additionally, in the aforementioned embodiment, when “combo” (character action connection mode) which brings a connection to a character action to be performed in a subsequent turn, “double” (character combined action mode) which includes a plurality of action modes combined, “double combo” (character combined action connection mode) which includes a plurality of action modes combined and brings a connection to a character action to be performed in a subsequent turn, or the like has been selected, then the special action value is stored reduced to the prescribed value. However, the invention is not limited to this configuration. For example, the special action value may be cumulated instead of being reduced to the prescribed value.

Furthermore, in the aforementioned embodiment, “combo” for selecting a plurality of action types (action modes) for each plurality of characters, “double” for selecting a plurality of action types (action modes) for one character, “double combo” for selecting a plurality of action types (action mode) for each plurality of characters and selecting a plurality of action types (action modes) for one character, or the like is made selectable. However, the invention is not limited to this configuration. “Combo” is sufficient if it is the character action connection mode which brings a connection to a character action to be performed in a subsequent turn. For example, the action of a selected character is sufficient if it brings a connection to a character action to be performed in a subsequent turn before the next action mode of the character is selected, and it does not matter whether the action order continues or not. Also, “double” is sufficient if it is the character combined action mode which includes a plurality of action modes combined. For example, when “double” has been selected, the “double” is sufficient if it combines a plurality of action modes before the next action mode of the selected character is selected, and it does not matter whether a plurality of actions based on the plurality of action modes continue or not. Furthermore, “double combo” is sufficient if it is the character combined action connection mode which includes a plurality of action modes combined and brings a connection to a character action to be performed in a subsequent turn. For example, the “double combo” is sufficient if it combines a plurality of action modes and brings a connection to a character action to be performed in a subsequent turn before the next action mode of a selected character is selected. Moreover, “combo”, “double”, “double combo”, and the like need not necessarily be attack actions, and may also be actions other than attack actions.

Besides, it is not necessary that “combo” or the like is made selectable on condition that the special action value has reached the predetermined value. Moreover, it is not necessary that the special action value is stored based on an action mode.

Still furthermore, in the aforementioned embodiment, the configuration is such that “double” is selected, thereby making a plurality of action types selectable for one character, and such that a timing area (determination region) is set based on the plurality of action types selected for the one character, thereby determining the result and progress of a plurality of actions which are based on the plurality of action types for the one character. Also, in the aforementioned embodiment, the configuration is such that “combo (shortcut)” is selected, thereby making action types selectable for each plurality of characters, and such that a timing area (determination region) is set based on the plurality of action types selected for the plurality of characters, thereby determining the result and progress of a plurality of actions which are based on the plurality of action types for the plurality of characters. That is, in the aforementioned embodiment, the configuration is such that a timing area is set based on the selected plurality of action types, but the invention is not limited to this configuration. For example, a timing area may be set regardless of a plurality of action types selected for one character. Also, for example, a timing area may be set regardless of a plurality of action types selected for a plurality of characters. Of course, the configuration may be such that a timing area is set regardless of the selected plurality of action types.

Still furthermore, in the aforementioned embodiment, the configuration is such that control is exerted to display the judgment ring 100 for determining an action result and progress, the rotary bar 101 which is displayed in a moving fashion within the judgment ring 100 for a predetermined period, the timing area 102 which is set within the judgment ring 100 based on the selected character action type, and the like, and such that, when the current position of the rotary bar 101 is in the timing area 102 or the like, then out of a plurality of action results and progresses, a relatively favorable action result and progress is determined in response to an operational signal from the input device 4. However, the invention is not limited to this configuration. For example, the configuration may be such that, without exerting such display control, when the current position of the rotary bar 101 is not in the timing area 102 or the like, a relatively favorable action result and progress are determined in response to an operational signal from the input device 4. Also, the configuration may be such that, without exerting such display control, an action result and progress are determined in response to an operational signal from the input device 4.

Still furthermore, in the aforementioned embodiment, the configuration is such that, with respect to “combo” selected for two characters, “combo” selected for three characters, “combo” selected for four characters, and a plurality of action types (“double”, “double combo”) selected for one character, a plurality of judgment rings are combined into one judgment ring, and such that the result and progress of a plurality of action which are based on a plurality of action types is determined using the one judgment ring. However, the invention is not limited to this configuration. For example, the configuration may be such that, with respect to “combo” selected for three characters and “combo” selected for four characters, a plurality of judgment rings are combined into two judgment rings, and such that the result and progress of a plurality of action which are based on a plurality of action types is determined using the two judgment rings. That is, it is sufficient if the configuration is such that the result and progress of a plurality of actions which are based on the selected plurality of action types is determined by at least any of the plurality of action types, and by a smaller number of times than the number of times the plurality of action types have been selected. Also, the result and progress of a plurality of actions which are based on the selected plurality of action types may be determined by the same number of times.

Still furthermore, based on an operational signal from the input device 4, any grouping pattern is selected from a plurality of grouping patterns, and based on the selected grouping pattern, the plurality of grouping patterns are classified into the first group and the second group. However, the invention is not limited to this configuration. For example, any grouping pattern may be selected from a plurality of grouping patterns at random, instead of based on an operational signal from the input device 4. Also, a plurality of grouping patterns each for a plurality of characters are stored, but the invention is not limited to this configuration. For example, it is not necessary to store a plurality of grouping patterns each for a plurality of characters.

Still furthermore, in the aforementioned embodiment, in a battle scene, an action mode is selected based on only character data relating to a first character classified as the battle group acting as the first group, instead of based on character data relating to a second character classified as the standby group acting as the second group. However, the invention is not limited to this configuration. It is sufficient if, for example, the configuration is such that action control of a first character classified as the first group is exerted based on a larger number of pieces of item data than that of a second character classified as the second group. Also, the action control may be exerted based on character data relating to a second character classified as the standby group acting as the second group. Furthermore, for example, the configuration may be such that the action control of the first character is exerted based on the same number of pieces of item data. Also, the configuration may be such that the action control of the first character is exerted based on a smaller number of pieces of item data than that of the second character. Moreover, it is sufficient if, for example, the number of pieces of item data is differentiated between the first display region and the second display region.

Still furthermore, in the aforementioned embodiment, based on an operational signal from the input device 4, a plurality of characters are classified into the first group and the second group, and control is exerted to differentiate the number of pieces of item data between the first display region, which displays item data corresponding to a first character classified as the first group, and the second display region, which displays item data corresponding to a second character classified as the second group. However, the invention is not limited to this configuration. For example, a plurality of characters may be classified into the first group and the second group without based on an operational signal from the input device 4. Also, for example, the first display region and the second display region may be set to have the same number of pieces of item data.

Still furthermore, in the aforementioned embodiment, on condition that additional power data for changing the increase/decrease ratio of character data to a character action mode, such as additional power data in which the amount of damage done to an enemy character increases by 20%, and addition power data in which MP consumption of a player character decreases to 50%, has been set in a region, the additional power data is added to the character data. However, the invention is not limited to this configuration. For example, the additional power data for changing the increase/decrease ratio of character data to a character action mode may be eliminated.

Still furthermore, in the aforementioned embodiment, any of a plurality of types of magic plates (additional power data determination modules), which are different in at least any of the number, shape size, and shape type of regions, can be set related to a character. However, the invention is not limited to this configuration. For example, a plurality of magic plates need not be different in all the number, shape size, and shape type of regions. That is, the configuration may be such that the same magic plate can be set.

Still furthermore, in the aforementioned embodiment, the shape type, size, attribute, and the like of regions can be changed, but the invention is not limited to this configuration. For example, any of the shape type, size, attribute, and the like of regions may be set so as to be unchangeable. Of course, all of them may be set so as to be unchangeable.

Still furthermore, in the aforementioned embodiment, the configuration is such that, on condition that a power object corresponding to the size of a region of a magic plate or smaller has been set in the region, additional power data corresponding to the size of the power object related to the region is added to character data. However, the invention is not limited to this configuration. For example, the configuration may be such that additional power data is related to the region even though it is not the additional power data corresponding to the size of the power object related to the region, and such that a power object is set to thereby add, to character data, the additional power data related to the region. Also, for example, the configuration may be such that a power object corresponding to the size of a region of a magic plate or smaller cannot be set in the region.

Still furthermore, in the aforementioned embodiment, additional power data, which corresponds to the size of a power object and becomes more relatively favorable for a character as the size of the power object becomes larger, is added to character data. However, the invention is not limited to this configuration. Addition power data, which corresponds to the size of a power object and becomes more relatively favorable for a character as the size of the power object becomes smaller, may be added to character data. That is, it is sufficient if additional power data, which corresponds to the size of a power object and becomes relatively favorable for a character pursuant to the size of the power object, is added to character data. Also, for example, additional power data which becomes relatively favorable for a character, even though not pursuant to the size of the power object, may be added to character data.

Still furthermore, in the aforementioned embodiment, the shape type and size of regions and the shape type and size of magic stones (power objects) are stored, but the invention is not limited to this configuration. For example, the shape type of regions and magic stones may be of one type. Of course, if the shape type of regions and magic stones is of a plurality of types, the size of regions and magic stones may be of one type. That is, it is sufficient if~there are stored a plurality of types of additional power data, which are classified by a type, a plurality of types of power objects, which are classified by a shape corresponding to the type and are used to determine character power, and the like. Furthermore, even when a power object corresponding to the shape of a region has been set in the region, additional power data corresponding to the type of the power object need not necessarily be added. For example, the feasibility of a judgment ring and a predetermined probability may be added.

Additionally, a plurality of types of additional power data, which are classified by a type, a plurality of types of power objects, which are classified by a shape corresponding to the type and are used to determine character power, and the like need not be stored. Furthermore, control need not be exerted to display the region of a shape corresponding to the type of additional power data and the shape of at least any of a plurality of types of power objects. Still furthermore, on condition that a power object corresponding to the shape of a region has been set in the region, additional power data corresponding to the type of the power object need not be added.

Furthermore, in the aforementioned embodiment, on condition that the calorie (player character state data) of player character B has reached a predetermined value, player character state data is changed to the initial value, and the state of the player character is changed to a relatively favorable specific state. However, the invention is not limited to this configuration. For example, on condition that the calorie (player character state data) of player character B has reached the predetermined value, player character state data need not be changed to the initial value. Also, for example, on condition that the calorie (player character state data) of player character B has reached the predetermined value, the state of the player character need not be changed to a relatively favorable specific state.

The embodiments of the invention have been described above, but have merely illustrated specific examples, which will not specifically limit the invention. That is, the invention is mainly a game program which allows a computer including a player-operable operating device to function as: a player character data storage module which stores player character data relating to a player character; an enemy character data storage module which stores enemy character data relating to an enemy character; a player character state determination module which determines a player character's state based on the player character data stored by the player character data storage module; a player character action mode selection module which selects a player character action mode based on an operational signal from the operating device and the player character's state determined by the player character state determination module; a character action control section which exerts player character action control based on the player character action mode selected by the character action mode selection module; and a player character state change module which, based on a predetermined change condition, changes the player character's state determined by the player character state determination module, the game program allowing the computer to function as: a module which, in the enemy character data storage module, stores specific data for each enemy character;

a module which, in the player character data storage module, stores player character state data relating to a player character's state; a player character state data addition module which, on condition that a player character action mode against an enemy character has been selected by the character action mode selection module based on an operational signal from the operating device, adds specific data, which corresponds to the enemy character, to player character state data; and a module which, in the player character state change module, changes a player character's state based on the result of the addition by the player character state data addition module. However, a specific configuration, such as the operating device, player character data storage module, enemy character data storage module, player character state determination module, character action mode selection module, character action control section, player character state change module, player character state data addition module, and initial value change module, can be changed in design as appropriate.

The embodiments of the invention have been described above, but have merely illustrated specific examples, which will not limit the invention. That is, the invention is mainly a game program which allows a computer including a player-operable operating device to function as: a character data storage module which stores a plurality of character data relating to a plurality of characters; a character action order determination module which determines the action order of the plurality of characters; a character action mode selection module which selects a character action mode based on an operational signal from the operating device and the plurality of character data; a character action control section which exerts character action control based on the character action mode selected by the character action mode selection module; a special character action control section which carries out the character action mode selection by the character action mode selection module and the character action control by the character action control section in accordance with the action order of the plurality of characters which has been determined by the character action order determination module; and a module which, in the character action mode selection module, makes selectable a character action connection mode for bringing a connection to a character action to be performed in a subsequent turn, wherein the computer is allowed to function as: a module which, in the character data storage module, stores, for each plurality of characters, an action value which varies based on the action control exerted by the character action control section; a module which, in the character action mode selection module, makes the character action connection mode selectable on condition that the action value has reached a predetermined value; and a module which, in the special character action control section, when the character action connection mode has been selected as an action mode of a character by the character action mode selection module, carries out character action control, which is based on the character action connection mode, before the next action mode of the character is selected. However, a specific configuration, such as the operating device, character data storage module, character action order determination module, character action mode selection module, character action control section, special character action control section, can be changed in design as appropriate.

The effects described in the embodiments of the invention are merely listed as the most preferred effects resulting from the invention, and the effects obtained by the invention are not limited to the ones described in the embodiments of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A game program product for use in a computer including a player-operable operating device comprising:
a player character data storage module which stores player character data relating to a player character;
an enemy character data storage module which stores enemy character data relating to an enemy character;
a player character state determination module which determines a player character's state based on the player character data stored by the player character data storage module;
a player character action mode selection module which selects a player character action mode based on an operational signal from the operating device and the player character's state determined by the player character state determination module;
a character action control section which exerts player character action control based on the player character action mode selected by the character action mode selection module; and
a player character state change module which, based on a predetermined change condition, changes the player character's state determined by the player character state determination module, wherein
the enemy character data storage module stores specific data for each enemy character; and
the game program product comprising:
the player character data storage module stores player character state data relating to a player character's state;
a player character state data addition module which, on condition that a player character action mode against an enemy character has been selected by the character action mode selection module based on an operational signal from the operating device, adds specific data, which corresponds to the enemy character, to player character state data; wherein
the player character state change module, changes a player character's state based on the result of the addition by the player character state data addition module.

2. A game program product according to claim 1, further comprising:
an initial value change module which changes the player character state data to an initial value on condition that the player character state data has reached a predetermined value; wherein
the player character state change module, changes a player character's state to a relatively favorable specific state on condition that the player character state data has reached a predetermined value.

3. A gaming apparatus comprising:
a player-operable operating device;
a player character data storage module which stores player character data relating to a player character;
an enemy character data storage module which stores enemy character data relating to an enemy character;
a player character state determination module which determines a player character's state based on the player character data stored by the player character data storage module;
a player character action mode selection module which selects a player character action mode based on an operational signal from the operating device and the player character's state determined by the player character state determination module;
a character action control section which exerts player character action control based on the player character action mode selected by the character action mode selection module; and
a player character state change module which, based on a predetermined change condition, changes the player character's state determined by the player character state determination module, wherein
the enemy character data storage module stores specific data for each enemy character, and
the player character data storage module stores player character state data relating to a player character's state, the gaming apparatus including
a player character state data addition module which, on condition that a player character action mode against an enemy character has been selected by the character action mode selection module based on an operational signal from the operating device, adds specific data, which corresponds to the enemy character, to player character state data, wherein
the player character state change module changes a player character's state based on the result of the addition by the player character state data addition module.
